(19) United States
(12) Patent Application Publication
(10) Pub. No.: US 2012/0005111 A2
(43) Pub. Date: Jan. 5, 2012

(54) FINANCING OF TENANT IMPROVEMENTS

(76) Inventors: Douglas Lowenstein, New York, NY (US); Dean Britton, New York, NY (US)

(21) Appl. No.: 12/399,764

(22) Filed: Mar. 6, 2009

Related U.S. Application Data
(60) Provisional application No. 61/034,477, filed on Mar. 6, 2009.
(60) Provisional application No. , filed on Mar. 6, 2008.

(51) Int. Cl. G06Q 50/00

(52) U.S. Cl. 705/313

(57) ABSTRACT

Methods for lease financing of tenant improvements. Improvements to a lease space are leased from a special purpose entity to a tenant under an improvements lease distinct from the space lease. The special purpose entity may be a legal entity owned under tax accounting rules by a landlord of the space. Financial statements of the special purpose entity may be consolidated with financial statements of the landlord. The special purpose entity may be capitalized by: (a) an equity investment by the landlord of at least three percent of the value of the tenant improvements and (b) debt issued by the special purpose entity of at least about eighty percent of the value of the tenant improvements, the debt being non-recourse against the special purpose entity, the landlord and the improvements and being secured by an absolute obligation of the tenant. The special purpose entity owns the improvements lease. Development of the tenant improvements may be financed by the special purpose entity. Rent payments under the improvements lease may have a present value at least equal to a value of the improvements at a time of commencement of the improvements lease. The improvements lease may be structured together with the space lease to support an accounting conclusion that the space lease and improvements lease are to be considered together as a single lease and classified as an operating lease. Rent payments under the improvements lease may be fully tax deductible to the tenant.

This is a non-provisional of U.S. Provisional App. Ser. No. 61/034,477, filed Mar. 6, 2008, which is incorporated by reference.

### BACKGROUND

The invention relates to financing of tenant improvements.

Tenant improvements include improvements and fixtures made by or on behalf of a tenant who leases space. Examples of tenant improvements include heating, ventilation, air conditioning, wiring, ceilings, walls, doors, partitions, floor coverings and other items permanently affixed to or appurtenant to the building's core and shell.

Two methods for financing tenant improvements are known. A tenant may finance its tenant improvements by spending its own cash or borrowing from a bank or other debt facility. Alternatively, and more commonly, the landlord pays for the tenant improvement build-out of the leased space and is paid back by tenant 102 during the lease term as part of the rent. The two methods may also be combined, with the tenant improvements (and the installation labor) partly financed by tenant 102, and partly by the landlord. (In this document, in some contexts, the term “landlord” may include a tenant who subleases to the ultimate tenant in possession.)

SFAS 13 (Financial Accounting Standards Board, Statement of Financial Accounting Standard No. 13) defines the difference between an “operating lease” and a “capital lease.” A lease is a capital lease if it meets any one of the following conditions: (a) ownership transfers to the lessee at the end of the lease term, (b) the lessee has a “bargain purchase” option at the end of the lease, (c) the lease extends for at least 75% of the asset's life, or (d) the present value of the contractual lease payments equals or exceeds 90% of the fair value of the asset at the beginning of the lease. Under an operating lease, a leased asset is carried on the books of the lessor. Under a capital lease, an asset is carried on the books of the lessee. The entity carrying the asset takes a tax deduction for depreciation of the asset, and depreciation charges against earnings. SFAS 13 and the text Clyde P. Stickney and Roman L. Weil, Financial Accounting, Dryden Press, are incorporated by reference.

### SUMMARY

In general, in a first aspect, the invention features a method. A space is leased from a landlord to a tenant under a space lease. Improvements to the space are leased to the tenant under an improvements lease distinct from the space lease. The improvements lease is structured together with the space lease to support an accounting conclusion that the space lease and improvements lease are to be considered together as a single lease and classified as an operating lease.

In general, in a second aspect, the invention features a method. A space is leased to a tenant. Improvements to the space are leased from a special purpose entity to the tenant. A landlord of the space is the owner of, or lessor of the tenant improvements to, the special purpose entity under tax accounting rules. Financial statements of the special purpose entity are consolidated with financial statements of the landlord. Rent payments under the improvements lease are tax deductible to the tenant.

In general, in a third aspect, the invention features a method. An interest in real estate is leased from a special purpose entity to a tenant, the special purpose entity being a legal entity owned by a landlord of the real estate that includes the leased interest. The special purpose entity owns the lease of the leased interest. Development of an asset underlying the leased interest is financed by debt issued by the special purpose entity. The debt is non-recourse against the special purpose entity, the landlord and the asset.

In general, in a fourth aspect, the invention features a method. A longer-hlied asset and a shorter-lived asset are leased to a lessee under two separate leases. Rent payments under the lease of the shorter-lived asset have a present value at least equal to a cost of the shorter-lived asset at a time of commencement of the lease of the shorter-lived asset. The lease to the shorter-lived asset is structured together with the lease to the longer-lived asset to support an accounting conclusion that the two leases are to be considered together as a single lease, and classified as an operating lease.

In general, in a fifth aspect, the invention features a method. Tenant improvements within a space are leased from a special purpose entity to a tenant. The special purpose entity is a legal entity owned by a landlord of the space, and is capitalized by participations comprising: (a) an equity investment by the landlord of at least three percent of the value of the tenant improvements and (b) debt issued by the special purpose entity for at least about eighty percent of the value of the tenant improvements.

In general, in a sixth aspect, the invention features a method. An interest in a space is leased from a special purpose entity to a tenant. The special purpose entity is a legal entity owned by a landlord of the building including the space. The building is divided for lease to multiple tenants. A least about 80% of the capitalization of the special purpose entity is a loan to the special purpose entity secured by an absolute obligation of the tenant.

Embodiments of the invention may incorporate one or more of the following features. At least 3% of capitalization for the special purpose entity may be a loan participation by the landlord. At least 10% of capitalization for the special purpose entity may be contributed by the landlord. A majority of the loan to the special purpose entity may be supplied by a party other than the landlord, and the landlord may own a participation in the loan made to the special purpose entity. A building in which the space is located may be encumbered by a mortgage. The lender to the special purpose entity and a mortgagee of the mortgage may enter into an inter-creditor agreement, each waiving any interest in the other's collateral. The improvements may have been previously constructed and be owned by the landlord, the tenant or jointly by landlord and tenant. The improvements may be conveyed or leased to the special purpose entity before or concurrently with entry into the improvements lease. Equity and/or debt investments may be made by the landlord in a plurality of special purpose entities owned by the landlord, each special purpose entity owning improvements for lease to a corresponding tenant, and these investments may be cross-collateralized, or not cross-collateralized. The improvements may be financed by debt issued by the special purpose entity, the debt being secured at least in part by a lien on the improvements. There may be no lien on the improvements. The special purpose entity may be a limited liability company, grantor trust, business trust, corporation, limited partnership, or other business association. The special purpose entity may have no ownership interest in any real property that includes the space. The improvements may be off-balance-sheet for the tenant. Financing for the improvements may be related to the cost of funds of the tenant. Financing for the improvements is provided by an entity other than the landlord and tenant. The tenant may enter into an obligation to construct the improvements and to assume costs associated with the construction. Rent payments under the improvements lease may be secured, in full or in part, by a personal or corporate guaranty or by a letter of credit of the tenant. The tenant may be the only tenant in a building in which the space is located. The space may be one of a plurality of spaces of a building divided for lease to a plurality of tenants, and the tenant may be one of the plurality of tenants. Upon an event of default under the improvements lease, the tenant may be obligated to purchase the improvements from the special purpose entity for a stipulated amount.

The above advantages and features are of representative embodiments only, and are presented only to assist in understanding the invention. Additional features and advantages of the invention will become apparent in the following description, from the drawings, and from the claims.

### DESCRIPTION OF THE DRAWING

FIG. 1 (pages 1-4) is a term sheet of a contract.

FIGS. 2a and 2b are fund flow diagrams.

FIG. 2c is a block diagram of a computer system.

FIGS. 3a-3e, 4a-4c and 5a-5e are shots of computer screens.

FIGS. 6 through 17 are spreadsheets.

FIGS. 18A, 18B and 18C are entity-cashflow diagrams.

FIG. 19A shows entities and relationships to one or more computer systems.

FIG. 19B shows a computer.

### DESCRIPTION

### I. Overview

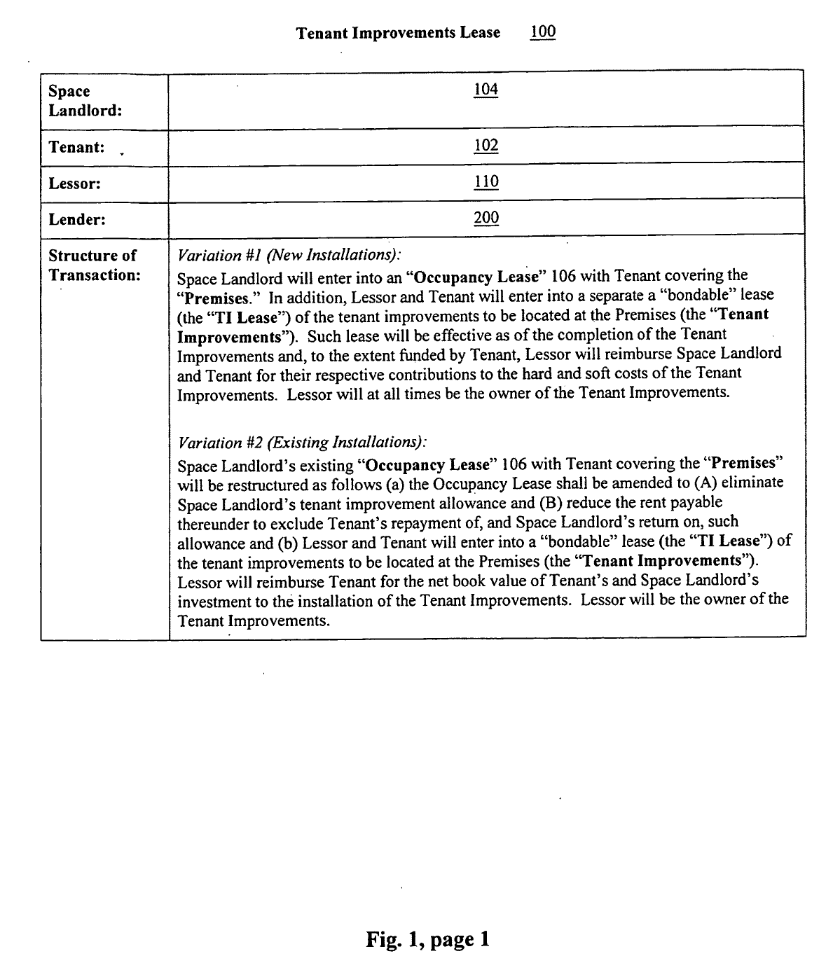

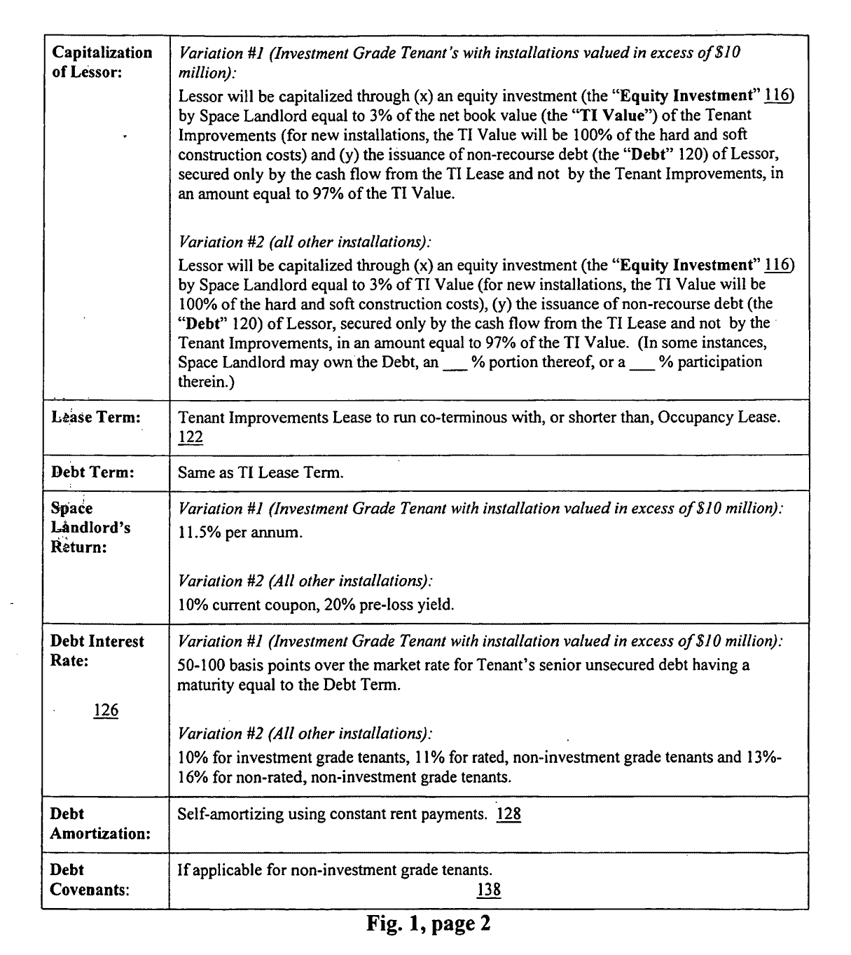

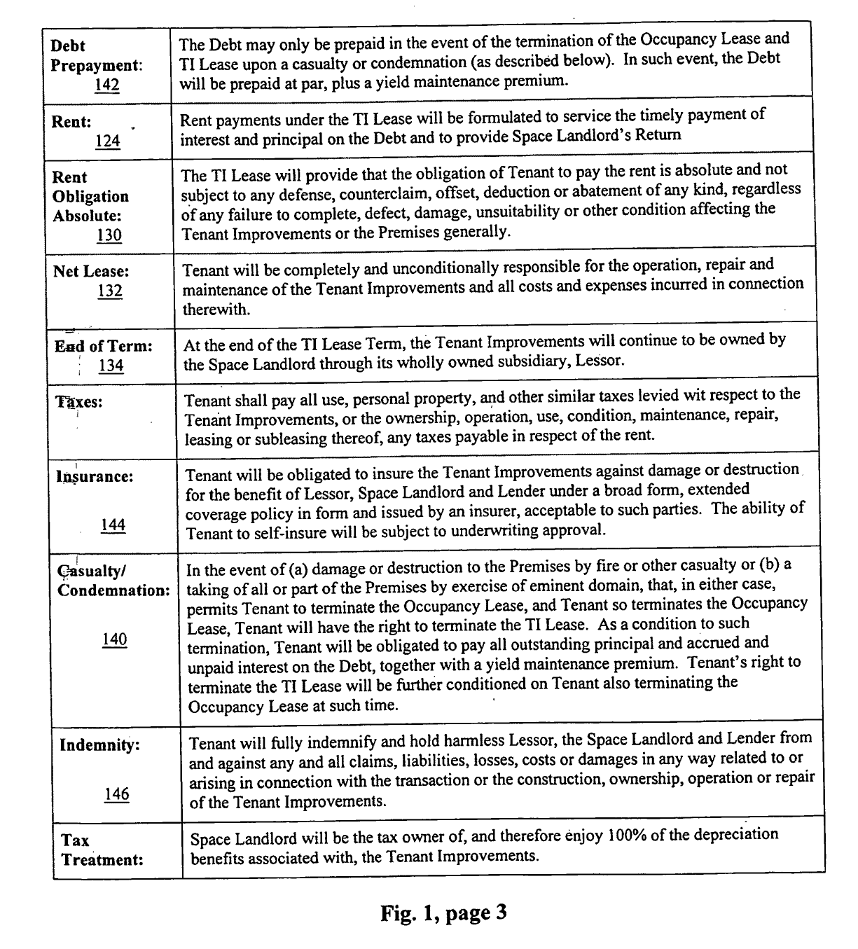

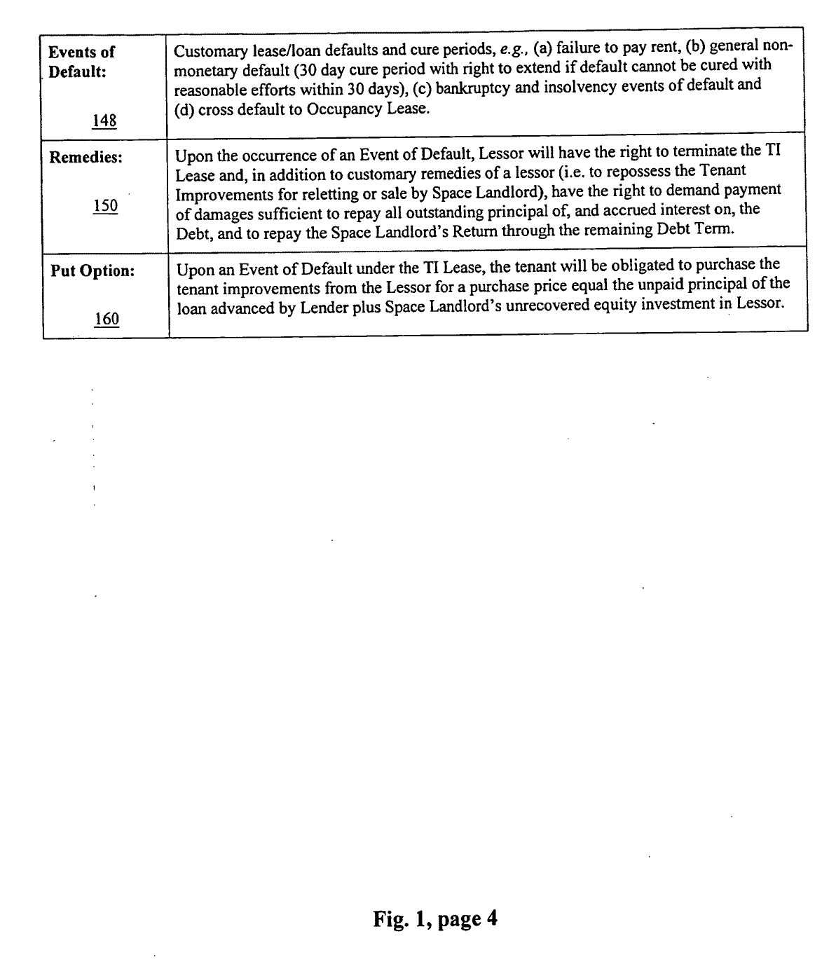

Referring to FIG. 1, a lease for tenant improvements may be structured so that tenant 102 may obtain operating lease treatment for the tenant improvements. The tenant improvements may be carried off the balance sheet of tenant 102, carried on the books of special purpose entity 110, which in turn may be owned by landlord 104. Financing for the tenant improvements may be drawn from the capital markets at or near the tenant's cost of funds. The lease payments may be tax deductible to tenant 102. Lender 200 may be given 100% recourse against the cash flows payable under lease 100 by tenant 102, rather than against the tenant improvements themselves. Payments under lease 100 may be sufficient, on a present value basis, to cover 100% of the cost of tenant improvements. Lease 100 on the tenant improvements may be aggregated with lease 106 on the underlying space, so that the two leases 100, 106 may be treated on a combined basis in determining whether the lease is an operating lease or a capital lease under SFAS 13. Because the lease payments on the two leases 100, 106 together total, on a present value basis, to less than 900% of the fair value of the space as improved by the tenant improvements, the two leases 100, 106 taken together may receive operating lease treatment under SFAS 13.

The parties to lease 100 may include tenant 102, space landlord 104, a special purpose entity 110, one or more lenders 200, with lease 100 itself being between tenant 102 and special purpose entity 110. Special purpose entity 110 will be the legal owner of the tenant improvements. Special purpose entity 110 may borrow whatever amount of capital is required to purchase and install the tenant improvements from a variety of sources including lender 200 and/or space landlord 104. Lender 200 may assume a number of forms, as discussed below in section IV. (Within this document, references to “lease 100” may include other transaction documents, including, e.g., a loan/credit agreement(s), a note, a security agreement, organizational documents of special purpose entity 110, participation agreements, shareholder agreements, etc. Examples of some of these agreements may be found in the appendix.)

Special purpose entity 110 owns the tenant improvements, and leases them to tenant 102. The improvements more likely to be held by special purpose entity 110 are those affixed to the core and shell of the building, and those depreciable over thirty-nine years under the Internal Revenue Code. Special purpose entity 110 would be unlikely to own furniture, equipment, computers, telephones, or other readily moveable personalty.

### II. Special Purpose Entity 110

Special purpose entity 110 may be wholly-owned by landlord 104. The tenant improvements may be conveyed to, or leased from, landlord 104 by special purpose entity 110. In this manner, the tenant improvements will ultimately be under the control of landlord 104 upon the expiration or earlier termination of lease 100 and may, through an assignment of the landlord's interests in special purpose entity 110, be made subject to any mortgage landlord 104 has granted on the building in which the tenant improvements are located. In addition, the assets and liabilities of special purpose entity 110 will generally be consolidated back to landlord 104, which may enable the tax and accounting treatments described herein for the tenant improvements and for lease 100.

Special purpose entity 110 may be established such that in the event of a bankruptcy of landlord 104, the assets of special purpose entity 110 will not be consolidated into the bankruptcy estate of landlord 104. In this manner, rating agencies and investors in special purpose entity 110 will be able to assume that the cash flow received by special purpose entity 110, namely from lease 100, cannot be interrupted by claims from creditors of landlord 104.

Special purpose entity 110 may be established such that cumulative distributions on its equity over the term of lease 100 will be limited to no more than special purpose entity's 110 cumulative income (which may be calculated in accordance with generally accepted accounting principles or other consistent means) to the date of distribution.

Special purpose entity 110 may be constituted as a limited liability company, grantor trust, business trust, corporation, limited partnership, or other business association, owned by landlord 104. Special purpose entity 110 may erect “corporate veil” barriers to allocate and limit risks and liabilities of the parties to lease 100. Although landlord 104 may be owned by a larger corporation or large real estate investment trust, landlord 104 is generally a single purpose limited partnership or limited liability company that has no credit outside equity in the building that is the subject of lease 106. Landlords' equity may be hard to determine, and subject to rapid disintegration as markets change. Under lease 100, lender 200 may be insulated from real estate risk with respect to the tenant improvements, the building and landlord 104, but may still have full recourse against the credit of tenant 102 (in some embodiments, the debt may be full recourse against all assets of tenant 102). Under lease 100, lender 200 may have recourse solely to the a triple-net “hell-or-high-water” payment obligation of tenant 102. Because special purpose equity 110 may insulate lender 200 from credit risk of landlord 104, lease 100 may be valued by lender 200 analogously to a corporate bond obligation of tenant.

Special purpose entity 110 may be initially capitalized by a combination of an equity investment 116 from landlord 104, debt 120 issued by special purpose entity 110 to lender 200. Landlord may own all or a portion of debt 120 or a debt participation 118 in debt 120. Equity investment 116 from space landlord 104 may be at least 3% of the value of the tenant improvements, and may be equity in legal form. Tenant 102 repays equity investment 116, debt participation 118 and debt 120 through rent payments 124 under lease 100.

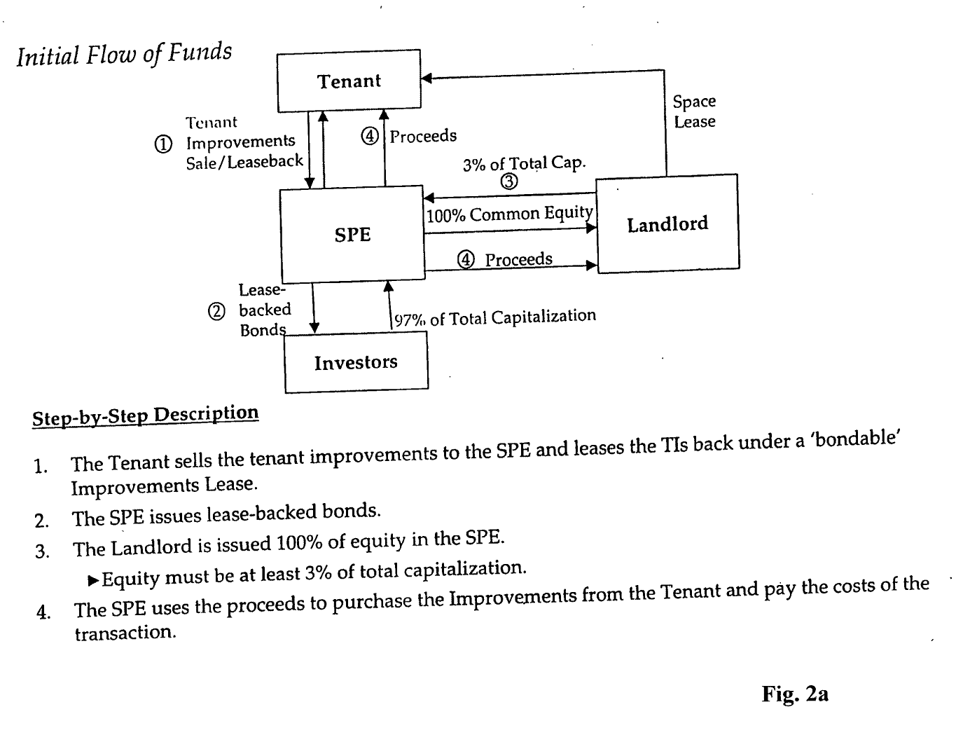

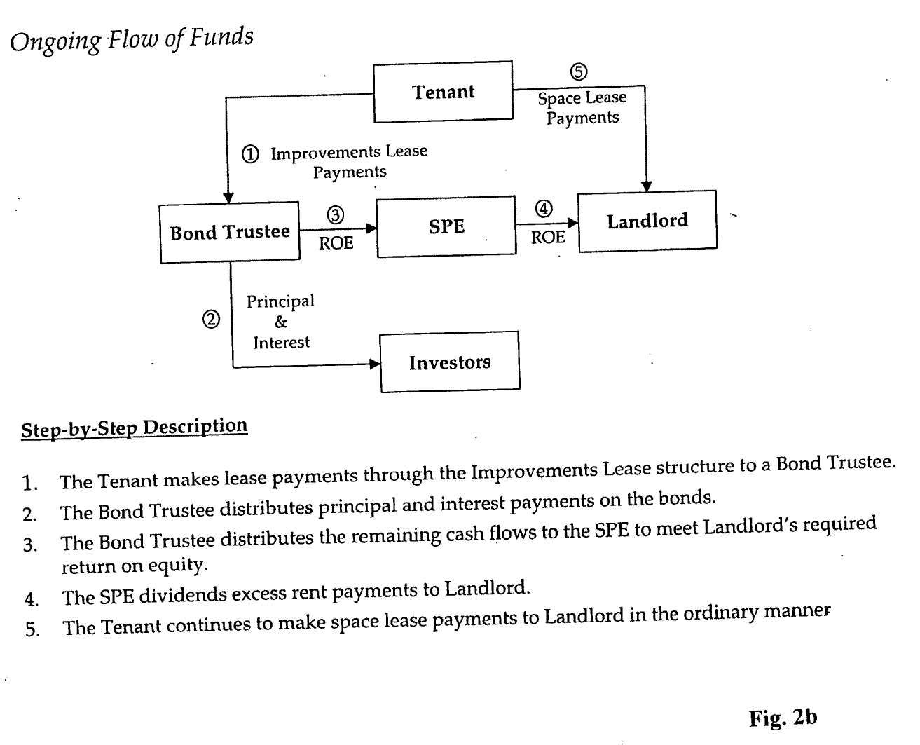

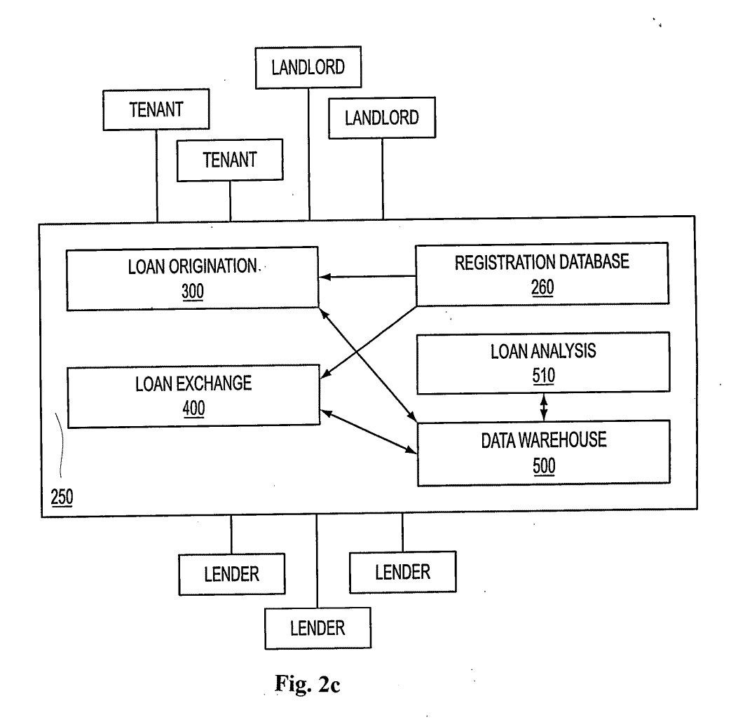

Referring to FIG. 1 and FIG. 2a, landlord's investment 116, 118 may include 3% of the special purpose entity's cost in constructing the tenant improvements, including any related fees, plus 3% of the special purpose entity's deferred debt issuance costs, and 100% of the special purpose entity's organizational costs. Landlord's equity investment 116 may remain permanently invested in special purpose entity 110, at least to the extent of maintaining it at least 3% of the special purpose entity's assets.

The exposure of landlord 104 with respect to the tenant improvements may be limited to the amount of the landlord's equity investment 116 and landlord's debt participation 118. Loan documentation may provide that landlord's debt participation 118 may be participation of anything from 0-100% of the total cost of the tenant improvements. Under accounting standard EITF 90-15 (Emerging Issues Task Force 90-15), a 3% investment by the landlord establishes that the landlord has a genuine economic risk in the lease, which may prevent the tenant improvements from being consolidated back to tenant 102. Generally, tenant 102 will have no ownership interest in special purpose entity 110. The sum of landlord's participation 116, 118 may be between 10-15%. Such a larger investment puts landlord 104 at an increased risk with respect to the credit of tenant 102, which reduces the risk of lender 200. Landlord's investments 116, 118 may be in the first loss position, that is, landlord's investments 116, 118 may be subordinate to lender's interest in debt 120. This first loss position may motivate and enable landlord 104 to seek remedies, e.g., exercise of the cross-default provision of leases 100, 106 and eviction under occupancy lease 106, before tenant's arrearage becomes too large, and/or to seek maximum recovery in a bankruptcy proceeding with respect to tenant 102. This, in turn, may increase tenant's motivation to perform timely under lease 100. Landlord's investments 116, 118 may each be cross-collateralized with other investments 116, 118 made by landlord in other special purpose entities 110. Landlord's debt participation 118 may be cross collateralized with respect to each debt issuance 120 made by a special purpose entity 110.

The major component of the funding for special purpose entity 110 may be debt 120 issued by special purpose entity 110 to lender 200. Debt 120 may be non-recourse against special purpose entity 110, landlord 104 or the tenant improvements themselves. As stated above, landlord 104 may own a participation in debt 120.

Special purpose entity 110 may be a wholly-owned subsidiary of space landlord 104. Accordingly, space landlord 104 may be the tax owner of, and therefore enjoy 100% of the depreciation benefits associated with, the tenant improvements. At the end of lease term 122, the tenant improvements will continue to be owned by special purpose entity 110, and thus, indirectly, 100% by landlord 104.

Special purpose entity 110 may fund the cost of constructing the tenant improvements, its own organizational costs, and paying up-front transaction fees.

### III. Terms and Conditions of Lease 100

Referring to FIG. 2a, in summary, a tenant improvement lease 100 may operate with the following flow of funds. Consider first the flow of funds that occurs when the parties initially enter lease 100. In the case of existing tenant improvements to a space that the tenant holds under an existing lease, tenant 102 sells (arrow ● ●) the tenant improvements to special purpose entity 110. In the case of a new tenancy, special purpose entity 110 makes the funds available to tenant 102 for the tenant to build tenant improvements. In either case, the funds for special purpose entity 110 may be drawn from investors in the capital markets. Tenant 102 leases (arrow ● ●) the tenant improvements back from special purpose entity 110 under a “bondable” lease 100. Special purpose-entity 110 may issue (arrow ● ●) lease-backed bonds. Landlord 104 may hold 100% of the equity in special purpose entity 110 (arrow ● ●), which equity may be at least 3% of the total capitalization for the tenant improvements. Special purpose entity 110 may use the proceeds to purchase (arrow ● ●) the tenant improvements from tenant 102 and to pay the costs of the transaction.

The lease may generate a flow of funds on an ongoing basis as shown in FIG. 2b. Tenant 102 may make lease payments (arrow ● ●) through lease 100 to a bond trustee. The bond trustee may distribute principal and interest payments on the bonds to investors (arrow ● ●). The bond trustee may distribute (arrow ● ●) the remaining cash flows to the special purpose entity to meet the landlord's requirements for a return on equity on the landlord's contribution to special purpose entity 110. Special purpose entity 110 may dividend (arrow ● ●) any excess rent payments to landlord 104. Tenant 102 may continue to make space lease payments (arrow ● ●) to landlord 104 in the ordinary manner.

Occupancy lease 106 may be a new lease entered by the parties contemporaneously with tenant improvements lease 100, or may be a pre-existing lease that is amended to accommodate lease 100 and its related transactions (see the discussion of sale-leaseback transactions below). Generally, the space leased under occupancy lease 106 will be a portion of a building used by tenant 102 in its trade or business. The rent on occupancy lease 106 may be at fair market value on a stand-alone basis, before considering tenant improvements lease 100. The term of occupancy lease 106 may be less than 75% of the estimated economic useful life of the space. Occupancy lease 106 will generally neither provide tenant 102 with an option to purchase the space nor transfer title of the space to tenant 102.

Tenant 102 accounts for occupancy lease 106 as an operating lease.

Referring to FIG. 1 and FIG. 2b, in addition to the rent due on the space under occupancy lease 106, lease 100 obligates tenant 102 to pay rent 124 on the tenant improvements. The present value of rent payments 124 may equal the cost to special purpose entity 110 of the cost of constructing the tenant improvements, organizational costs, and transaction fees. This present value may be computed using a discount rate equal to the sum of the coupon of loan 120 to special purpose entity 110, and the desired dividend rate on entity investment 116 in special purpose entity 110. Rent payments 124 under lease 100 may be formulated to amortize the cost of the tenant improvements over the life of the lease.

Landlord's debt participation 118 may be structured such that the annual return is less than, equal to, or greater than the interest rate paid by special purpose entity 110 on debt 120. In addition, the cash flow payable to landlord 104 with respect to landlord's debt participation 118 may be structured such that landlord's effective yield, based on varying assumed levels of tenant defaults under lease 100, will be equal to, less than, or greater than the annual return paid to landlord on debt participation 118. This arrangement may be set forth in a master participation agreement between landlord 104 and lender 200. Under such master participation agreement, landlord 104 may be in the “first loss” position with respect to defaults experienced by any failure of tenant 102 to make timely payments of rent 124. This “first loss” piece with an increased yield may be referred to as the “B piece” or “residual tranche.” In cases where landlord 104 assumes a “first loss” position, landlord 104 will be effectively purchasing the risk position that, since the capital markets interruption in October 1998, has severely damaged the business prospects of many originators of different forms of mortgage and/or asset backed securities who have historically retained such position.

Lease 100 may obligate tenant 102 to pay rent 124 directly to the account of lender 200, bypassing special purpose entity 110. Rent 124 may be calculated to satisfy special purpose entity's 110 debt service obligations with respect to debt 120 and to repay landlord's equity investment 116 together with a market return thereon. Rent 124 may be structured such that debt 120, interest thereon, landlord's equity investment 116 and a market return thereon are paid on a constant payment, self-amortizing basis. Subject to §467 of the Internal Revenue Code and the rules and regulations promulgated in connection therewith (which may, in certain instances, impute a loan from landlord 104 to tenant 102 or from tenant 102 to landlord 104), the parties may agree to an alternative rent structure or amortization schedule 128, altering the timing of the repayment of components 116, 120 (e.g., rent payments that are initially larger than the constant payment amount and fall later in term 122, or payments that are initially smaller (so that the principal increases) and larger later in term 122) to improve the after-tax economics to tenant 102, landlord 104 and/or lender 200.

Under a separate security agreement between the parties, special purpose entity 110 may pledge all rents 124 payable under lease 100 to lender 200. Lender 200 may agree that its sole remedy will be to look to rent 124 received by special purpose entity 110. Landlord 104 may covenant not to modify or accept a surrender of lease 100, modify certain terms of lease 106 or accept a surrender of lease 106, without the consent of lender 200. Lease 100 may constitute “chattel paper” within the meaning of the Uniform Commercial Code, and represent that special purpose entity 110 is the holder of such paper and that lender 200 is the collateral assignee of such paper.

Tenant improvements lease 100 may have a term 122 that is co-terminous with to the underlying occupancy lease 106. Similarly, debt 120 may have a maturity that corresponds with the expiration of lease 100, and lease 100 may provide for amortization of landlord's equity investment 116 out of the rent 124 paid to special purpose entity 110. These common termination dates may ease the aggregation of the two leases 100, 106 in determining accounting classification of such leases.

In some embodiments, the tenant improvements lease may have a shorter term 122 to conform to the more common actual use lifetime of the tenant improvements (though walls, utilities, etc. generally have a lifetime that is longer than the current occupancy lease 106, other tenant improvements such as carpets, are replaced more frequently), and reduce the debt term, which in turn will generally reduce the imputed interest rate of tenant improvement lease 100.

Generally, if tenant 102 exercises an option to extend occupancy lease 106 beyond its original term (and beyond the term 122 of tenant improvements lease), tenant improvements lease 100 may be renewed to the extent of providing tenant 102 with possessory rights to the tenant improvements, but not to require rent 124.

Lease 100 may provide 130 that the obligation of tenant 102 to pay rent 124 is a triple-net, “bondable” and absolute obligation (commonly referred to as “hell or high water”) and not subject to any defense, counterclaim, offset, deduction, diminution or abatement. Rent 124 will generally not be excused for failure to complete construction or improvements, any inconvenience or interruption, cessation, defect, damage, casualty, eminent domain taking, priorities, rationing, war, civil commotion, strikes or riots, unsuitability or other condition affecting the tenant improvements or the leased space, or any loss of business caused directly or indirectly by any of the above. Lease 100 may provide that there are no offset rights with respect to any failure, act or omission by landlord 104. Lease 100 may provide that rent 124 will not be excused for any termination, expiration, surrender, cancellation, amendment, modification, restatement, extension or supplement to occupancy lease 106.

Lease 100 may provide 132 that tenant 102 will be completely and unconditionally responsible for the operation, repair and maintenance of the tenant improvements and all costs and expenses incurred in connection therewith. Lease 100 may impose limitations on the use of the tenant improvements, for instance, to comply with laws, certificates of occupancy of the building, condominium agreements within the building, etc.

Lease 100 may provide 134 that at the end of lease term 122, the tenant improvements will continue to be owned by the space landlord through its wholly owned subsidiary, special purpose entity 110. As a practical matter, the space and tenant improvements will usually be “functionally interdependent,” in that the tenant improvements are usually affixed to the core and shell of the building, and cannot be removed from, and used independently of, the space without incurring material costs.

Rent payments 124 may be secured, in whole or in part, by a letter of credit posted by tenant 102. In addition, lease 100 may require tenant 102 to comply with certain financial covenants 138. For instance, certain assets of the tenant 102 may be pledged as security, or tenant 102 may covenant not to take certain risks or leverage. In addition, failure to satisfy certain performance standards may trigger a default under lease 100.

Lease 100 may include provisions 140 for casualty or condemnation. In the event of (a) damage or destruction to the premises by fire or other casualty or (b) a taking of all or part of the Premises by exercise of eminent domain, that, in either case, permits tenant 102 to terminate the occupancy lease 106, tenant 102 may have the right to terminate tenant improvements lease 100. As a condition to such termination, tenant 102 may be obligated to pay all outstanding principal and accrued and unpaid interest on debt 120, and may be required to pay a prepayment penalty. Any right of tenant 102 to terminate tenant improvement lease 100 in such instances will be further conditioned on tenant 102 also terminating occupancy lease 106 at such time.

Lease 100 may permit tenant 102 to assign lease 100 or sublet all or a portion of the tenant improvements in conjunction with an assignment of space lease 106 or a subletting of all or a portion of the space devised thereunder, with tenant 102 remaining the primary obligator under lease 100.

Lease 100 may obligate tenant 102 to pay all use, personal property, and other similar taxes levied on the tenant improvements, or the ownership, operation, use, condition, maintenance, repair, leasing or subleasing the tenant improvements, and any taxes payable in respect of the rent. Lease 100 may obligate tenant 102 to pay any sublease or license income derived from the tenant improvements over to special purpose entity 110.

Lease 100 may provide 144 that tenant 102 will be obligated to insure the tenant improvements against damage or destruction for the benefit of special purpose entity 110, space landlord 104, and lender 200 under a broad form, extended coverage policy, for replacement value. With underwriting approval, tenant 102 may be allowed to self-insure. Tenant 102 may be required to insure the amount of lease 100 against casualty and condemnation, and general commercial liability.

Tenant 102 may indemnify 146 special purpose entity 110, space landlord 104 and lender 200 against claims, liabilities, losses, costs or damages in any way related to or arising in connection with the transaction or the construction, ownership, operation or repair of the tenant improvements.

Lease 100 may define events of default 148, e.g., (a) failure to pay rent, (b) general non-monetary default (30 day cure period with right to extend if default cannot be cured with reasonable efforts within 30 days), (c) bankruptcy and insolvency events of default, and (d) cross-default with occupancy lease 106 (under which a default under tenant improvement lease 100 is a default under occupancy lease 100, and vice versa, enabling landlord 104 to exercise whatever remedies are available for breach of either lease). Lease 100 may also define cure periods for default.

Lease 100 may define remedies 150 for events of default 148. For instance, upon the occurrence of an event of default, special purpose entity 110 may have the right to terminate lease 100, and in addition to customary remedies of a lessor (i.e. to repossess the tenant improvements for reletting or sale by space landlord 104), special purpose entity 110 may have the right to accelerate all future rent 124, to demand payment of damages sufficient to repay all outstanding principal of, and accrued interest on, debt 120, and to repay the space landlord's equity investment and contract return thereon through the remaining lease term 122. Lease 100 may provide that additional rent or a late payment charge is due whenever a payment of rent 124 is late.

Lease 100 may include an “offer to purchase” clause, providing that in the event that lease 100 ceases to be in effect (other than as a result of expiration or exercise of any remedies by special purpose entity 110) while occupancy lease 106 continues to be in effect, such circumstances shall automatically constitute an offer by tenant 102 to purchase the tenant improvements from landlord 104 for a stipulated purchase price.

As an additional mechanism for ensuring that lender 200 will be treated as a senior unsecured creditor of tenant 102 for the full amount of any portion of the debt 120 that has yet to be repaid in the event of bankruptcy of tenant 102, lease 100 (or a separate instrument executed by tenant 102) may contain a “put” clause 160, providing that upon an event of default 148, tenant 102 will be obligated to purchase the tenant improvements from special purpose entity 110 for a stipulated purchase price. For either “put” clause 160 or the “offer to purchase” clause of the previous paragraph, the stipulated purchase price may be scheduled to equal the unpaid principal of the loan 120 advanced by lender 200 to special purpose entity 110 plus the landlord's equity investment and contract return thereon, or may be a sum certain. Put clause 160 may be drafted so that it stands as a separate covenant that is not an executory contract or unexpired lease, thereby entitling put clause 160 to a full claim for such purchase price upon a tenant bankruptcy, without the potential of a claim limitation of §502(b)(6) of the Bankruptcy Code.

The organic documents for special purpose entity 110 may provide that in the event that tenant 102 files for bankruptcy protection, and rejects lease 100 as part of its reorganization and attempts to remain in possession of the premises by assuming its space lease 106, landlord 104 will undertake to deprive tenant 102 of the use and enjoyment of the tenant improvements. The organic documents for special purpose entity 110 may provide that in the event the landlord 104 fails to do so, special members (or trustees) of special purpose entity 110 may do so pursuant to a power-of-attorney.

Lease 100 (or a separate agreement between lender 200 and any mortgagee) may contain a clause that ensures separation between the security interests of the parties 102, 104, 110, 200 under tenant improvement lease 100, occupancy lease 106, and any mortgage on the property in which the tenant improvements are located. In the case where there is an existing mortgage, lease 100 (or the separate agreement) may stipulate that lender 200 has no interest in the property or rents due under occupancy lease 106, that the property mortgagee has no interest in the rents due under the tenant improvements lease and that lender 200 has no security in interest in the tenant improvements.

Tenant improvement lease 100 may be structured to exclude any option for tenant 102 to purchase the tenant improvements from special purpose entity 110 at the end of the lease, and may exclude any transfer of title to the tenant improvements to tenant 102.

SFAS 13 allows an operating lease to have a lessee purchase option at the end of the lease, as long as the option is not a “bargain option,” that is, as long as the option price is no less than the projected fair market value of the property. It may be desirable that a sale-leaseback transaction (a “sale-leaseback” is a transaction in which an asset, currently owned by its possessory user, is sold to another entity, and the entity leases the asset back to the original possessory user) further comply with SFAS 66, which applies to sale-leaseback of real property. SFAS 66 disallows any sale option of a sale-leaseback transaction, regardless of the option's strike price, if the lease is to be considered an operating lease. The extent to which tenant improvements are considered real property is an open issue in the accounting community; nonetheless, it may be safer and “cleaner” to simply avoid the issue, and not have a purchase option in a sale-leaseback.

The fair market value of the space, as improved by the tenant improvements, may or may not be objectively determinable when occupancy lease 106 and tenant improvements lease 100 begin. If the fair market value of the space, as improved, is objectively determinable, the present value of the combined rest under occupancy lease 16 and tenant improvements lease 100 may be less than 90% of the fair market value of the space as improved. The present value is computed using a discount rate equal to the lower of (a) the tenant's incremental borrowing rate, or (b) the landlord's implicit rate (as defined by SFAS 13) of the combined occupancy and tenant improvements leases 100, 106, if it is possible for tenant 102 to learn that rate. The fair market value of the land component of occupancy lease 106 may be less than 25% of the fair market value of the space as improved.

A credit insurance policy may be included in the terms of lease 100, analogous to mortgage insurance for a housing loan. The credit insurance may cover the amortized cost of the tenant improvements. In addition or alternatively, credit insurance may cover the rent stream due under lease 100 in the event of a casualty. This insurance may lessen the prepayment risk associated with a casualty with respect to the tenant improvements.

Tenant 102 may covenant not to create or permit any lien or other encumbrance on the tenant improvements. Tenant 102 may covenant not to make any alternations except those permitted by the terms of lease 100, occupancy lease 106, or as permitted by landlord 104. Tenant 102 may covenant that any alternations will be of a quality standard of the original tenant improvements.

### IV. Lender 200 and the Capital Markets

Lender 200 may be a bank, insurance company, specialty finance company or other investor in corporate debt obligations, who, in each case, holds debt 120 on its balance sheet.

Because debt 120 may be suitable for private or public placements in the capital markets. Special purpose entity 110 may issue debt 120 directly to the capital markets.

Component 120 of the financing of special purpose entity 110 by lender 200 may be suitable for pooling as an asset-backed securitization product. For instance, several leases 100 may be initially financed by an originator, who may aggregate debt components 120 under the leases and sell securities backed by the cash flows from such debt components to the capital markets in a securitization.

Lender 200 may act as a placement agent or broker, negotiating lease 100 between tenant 102, landlord 104, and a supplier of capital, and charge a fee for such service.

In certain embodiments, lender 200 may make a profit on the arbitrage spread between an interest component of rent 124 paid by tenant 102 to special purpose entity 110 under lease 100 and the cost to lender 200 in borrowing from the capital markets using the tenant's credit. This profit may either be realized in monthly payments of rent, or lender 200 may sell debt 120 to the capital markets as a premium bond by making all rent payments 124 available as debt service. Lender 200 may also keep a fee for negotiating lease 100.

Lender 200 may also receive a fee from landlords and/or tenants for use of tenant improvement financial management systems.

In other embodiments, lender 200 may borrow money from one or more sources, use such money to act as principal lender in an aggregation of diverse leases 100, and/or continue to own debt 120 during their respective terms 122. By aggregating multiple tenants 102 into a bundle, risk is diversified, and the credit of the aggregate may well be better than the credit of any individual tenant 102 within the bundle, which may lower the lender's cost of funds. This aggregation may also allow the lender 200 to lend to lower-credit tenants 102. The landlord's ownership of debt participation 116 may also enhance the lender's ability to finance debt 120.

### V. Use of the Lease Structure

Tenant improvements for office space have traditionally been financed by landlord 104, tenant 104 or through a contribution by each party.

Under one traditional arrangement, in which landlord 104 provides a “workletter” or contributes cash for tenant improvements, landlord 104 is acting as a specialty finance company for the benefit of such tenant, even thorough it is not properly capitalized to do so. This phenomenon may be seen in today's capital-constrained market for real estate investment trusts where these owners have been forced to sell their core assets (buildings and land) in order to raise equity. Landlords 104 fund tenant improvements in an effort to consummate the transaction embodied in space lease 106, but in doing so, divert funds from investment in real estate core assets, and the higher overall returns available. This viewpoint best exemplified in today's increasingly “landlord favorable” commercial real estate market in which the amounts offered by landlords to prospective tenants as tenant improvement allowances have decreased significantly.

In contrast, under lease 100, when tenant 102 has a high credit rating and low cost of funds, lease 100 may be structured to allow tenant 102 to finance the tenant improvements at its own cost of funds (rather than the cost of funds of landlord 104) because lender 200 looks to the tenant's credit for recourse. Similarly, when tenant 102 has a low credit rating and high cost of funds, lease 100 may be structured to that the landlord 104 can avoid a subsidy to tenant 102.

Under internal Revenue Code of 1986, as amended, tenant improvements are taxed as real property, subjecting them to a thirty-nine year amortization schedule even though their practical useable lifetime may be much shorter, and even though occupancy lease 106 may also be much (e.g., space lease 106 is often for only for five, ten or fifteen years). Thus, where a tenant uses traditional arrangements to finance his own tenant improvements, expenditures for tenant improvements are deductible over thirty-nine years, which may be much slower than true economic depreciation. In contrast, lease 100 may be structured so that the lease of tenant improvements from special purpose entity 110 to tenant 102 meets Internal Revenue Code standards for a tax lease; this will render the rent 124 paid from tenant 102 to special purpose entity 110 deductible as an ordinary business expense. This may convert the deduction schedule from thirty-nine years to depreciate the tenant improvements (when tenant 102 is the tax owner of the tenant improvements) into a shorter schedule based on the term 122 of lease 100

Under financial accounting considerations tenant improvements are an undesirable asset to be carried on a balance sheet. Tenant improvements seldom generate revenues or earnings, seldom appreciate in value, and seldom have residual value. Even within the tenant's own occupancy of the space, the tenant improvements may need to be refurbished, imposing the costs of removing the tenant improvements, and the material and labor costs of replacing them. Thus, tenants are often reluctant to carry tenant improvements on their books.

Lease 100 may be structured so that tenant improvements lease 100 from special purpose entity 110 to tenant 102 meets accounting standards for an operating lease. Under lease 100, the tenant improvements are not carried as a depreciable asset on the tenant's books for financial accounting purposes. Landlord 104 may be the 100% owner of the tenant improvements (through the landlord's ownership of special purpose entity 110), and thus the tenant improvements depreciate on the landlord's balance sheet, over thirty-nine years, as opposed to the tenant's.

In a traditional occupancy lease, a non-investment grade tenant is often asked to post a letter of credit in favor of the landlord as security for some or all of the landlord's investment in the tenant improvements for some or all of the term of lease 106. In contrast, because lender 200 may aggregate the debt 120 issued by special purpose entities 110 backed by a diverse pool of tenant credits, such letter of credit, or other security may be unnecessary.

Features of lease 100 may be applied to new installations. Lender 200 may negotiate a deal 100 with tenant 102 and landlord 104 as a new building is being constructed, or as a tenant 102 and landlord 104 negotiate a new lease for space in a previously constructed building. Special purpose entity 110 may be created at such time and may be funded 116, 118, 120 by landlord 104 and lender 200 so that special purpose entity 110 may in turn fund the tenant improvements. A special purpose entity 110 previously created for such building or for another building in the landlord's portfolio may also be used.

Tenant 102, on behalf of special purpose entity 110, may improve the space pursuant to a construction agency agreement between tenant 102 and special purpose entity 110, which may require tenant 102 to complete the tenant improvements on a specific timetable and be responsible for any cost or time over runs.

Features of lease 100 may also be applied to sale-and-leaseback transactions of existing tenant improvements. “Existing” improvements may be those that have been installed in the immediate past—the construction phase has just been completed and tenant 102 is ready to take occupancy and begin paying rent under leases 100, 106. Other “existing” improvements may be those that have been in place for some years, typically financed by one of the traditional methods discussed in the Background. The sale-leaseback transaction may include a transfer of ownership, or lease, of the tenant improvements to special purpose entity 110 for a cash payment equal to the tenant's or landlord's carrying value (i.e., original cost less cumulative depreciation) of the tenant improvements, and the entry into lease 100 of the tenant improvements to tenant 102, typically for the remaining term of occupancy lease 106. Special purpose entity 110 may acquire the funds for such payments from a landlord equity investment 116 and a debt issuance 120 in which landlord 102 may own a participation 118. Special purpose entity 110 may assign the rent due it under lease 100 to lender 200 as security for debt 120.

At the time of the sale-leaseback transaction, occupancy lease 106 may be amended, to reduce the rent payable there. Any reduction in rent under the amended occupancy lease 106 may reflect the fair market value of the tenant improvements no longer covered by to the occupancy lease 106. The amendments to occupancy lease 106 generally will not provide tenant 102 with an option to purchase the space, nor transfer title of the space to tenant 102. Amended occupancy lease 106 may allow tenant 102 to renew the occupancy lease 106 at its scheduled expiration date, at a specified rent. The term (including any bargain renewal option) of the amended occupancy lease 106 will generally be less than 75% of the estimated economic useful life of the space.

### VI. Additional Features and Alternative Embodiments

In some embodiments, features of lease 100 may be used in conjunction with leveraged leasing terms, also known as credit tenant leasing. In these embodiments, a single tenant assumes the risk of real estate ownership (environmental, upkeep of the property, taxes, liability for guest injuries, security, fire alarms, etc.), in addition to making sufficient rent payments to satisfy the landlord's debt and equity servicing requirements. These arrangements are typically found in a lease of a large headquarters building for a large company with a strong credit rating or for “big box” retail installations for national retail or movie operators. Lease 100 may provide that tenant 102 takes on all real estate risk of the tenant improvements for the benefit of landlord 104 and lender 200 who have a security interest in that real estate.

In certain embodiments, a single building may be leased to a number of individual tenants and a separate lease 100 entered into with each tenant with respect to the tenant improvements to be used by such tenant. Generally, landlord 104 will hold any real estate risk associated with the building and land in and at which such tenant improvements are located. Lease 100 and special purpose entity 110 may allow creditors 200 to look past any real estate risk in the structure. Tenant improvements generally create only small real estate related incidental risks. Further, special purpose entity 110 may insulate both lender 200 and landlord 104 from the risks of ownership of the tenant improvements by imposing a corporate-form limited liability shell around the lease, and placing full liability with respect to debt 120 on tenant 102. In some embodiments for a multi-tenant building, all tenant improvements for a building may be owned by a single special purpose entity 110, and leased to the respective tenants 102. In other embodiments, a separate special purpose entity 110 may be created to hold and lease the tenant improvements for each tenant in the building. In either case, the credit default of a single tenant would not affect the recourse of lender 200 to other tenants in the building that have entered into a lease 100.

In an alternative embodiment, lease 100 may be structured as a synthetic lease. A “synthetic lease” is a lease that is an operating lease under financial accounting rules, and a capital lease under tax accounting rules. (Sections I, II, and III were primarily directed to leases that receive operating lease classification under both financial accounting and tax accounting rules.) This may be an appealing structure in cases where tenant 102 desires to retain the residual value of, and control over, the tenant improvements. This may be accomplished by including a purchase option in lease 100 in favor of tenant 102 for the tenant improvements upon the expiration of lease term 122.

In some embodiments, lender 200 may have a lien against the tenant improvements owned by special purpose entity 110. Because the tenant improvements may be collateral that is physically difficult to realize upon and are likely to have more value to landlord 104 (and its mortgagee, if any, on the applicable building) than to third party lenders 200, other terms of lease 100 may create rights in lender 200 that may improve the practical ability of lender 200 to realize value from such lien.

In some embodiments, special purpose entity 110 will share ownership of the tenant improvements with tenant 102. In such instances, special purpose entity will be capitalized only to the extent of such ownership. As in traditional financings of tenant improvements, tenant 102 and special purpose entity 110 will be deemed to be the tax owners of the tenant improvements to the extent of their respective investments therein. In addition, in some embodiments tenant 102, or one of its affiliates, may act as lender 200 and own some or all of debt 120 or a participation therein.

### VII. Computer Implementation

Referring to FIG. 2c, computer software 250 for originating, managing and analyzing tenant improvement leases 100 may be provided, for instance, by lender 200 and businesses affiliated with lender 200. Such software may improve market efficiencies or capture surpluses in market inefficiencies. The software may further provide electronically integrated loan origination primary and secondary loan transactions, information management, and related services, data storage, risk management, allowing tenants 102 and landlords 104 to consolidate and centralize activities for financing tenant improvements. The software may enable tenants and landlords, or their representative brokers and leasing agents, to (a) model a lease structure for financing tenant improvements in comparison to traditional financing alternatives, (b) apply directly to a lender's credit underwriting department for a loan based upon input provided, (c) receive electronic notification of credit determination, and (d) receive coordination support throughout the closing process. Access to the software may be provided over the internet on a thin client basis, from a central server array, or through other computer access networks.

The web site may offer memberships and rights to participate to real estate owners, tenants, brokers and financiers, and offer participation in a market for tenant improvement leases 100 and loans 120. The web site may intermediate a series of vertical and horizontal corollaries in the commercial office and real estate finance markets, including tenant improvement construction loans, real estate and leasing information management, and coordination with other real estate finance markets.

Loans may be originated through loan origination module 300 or loan exchange module 400. Data about loans is captured in Data Warehouse 500. Data may be analyzed in Loan Analysis module 510. Each of these components will be discussed further, below.

VII.A. Loan Origination

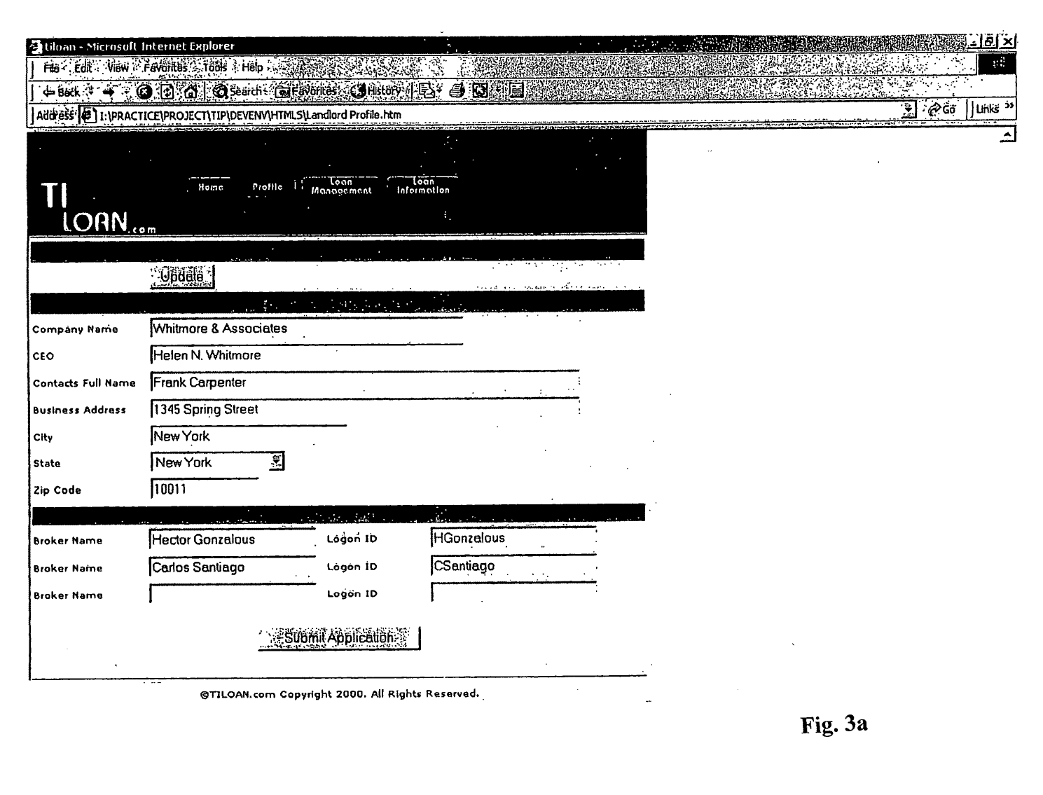

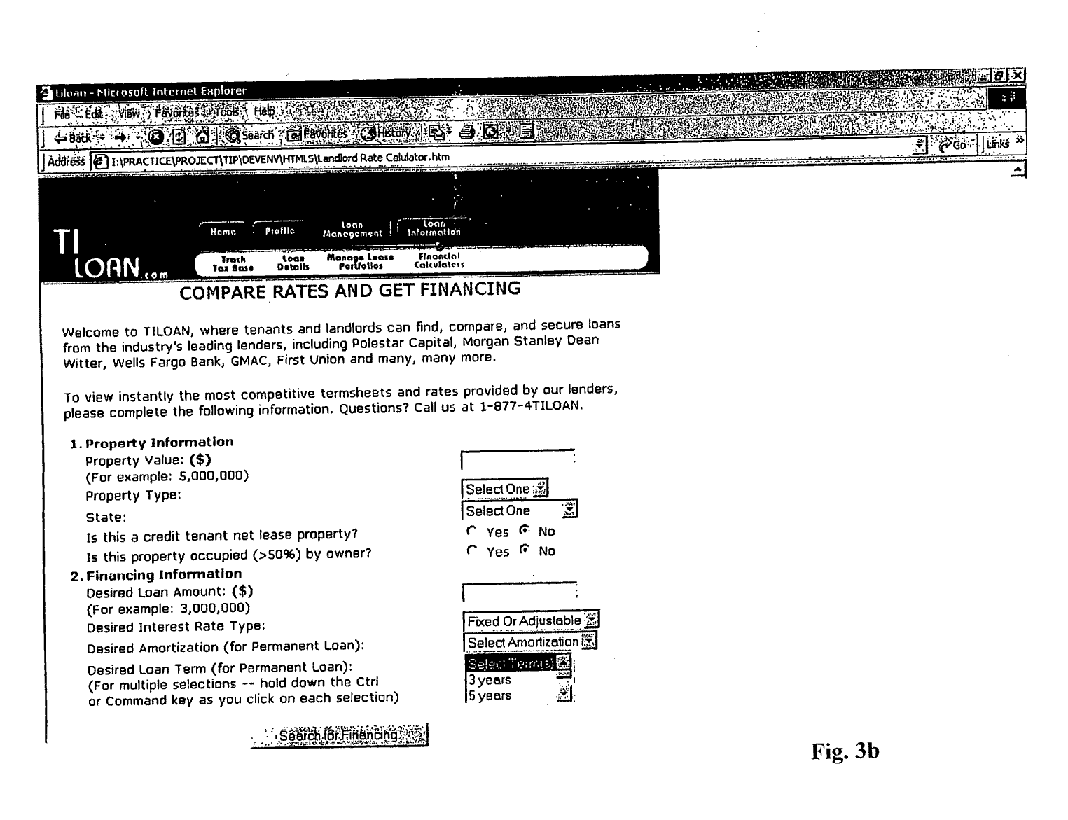

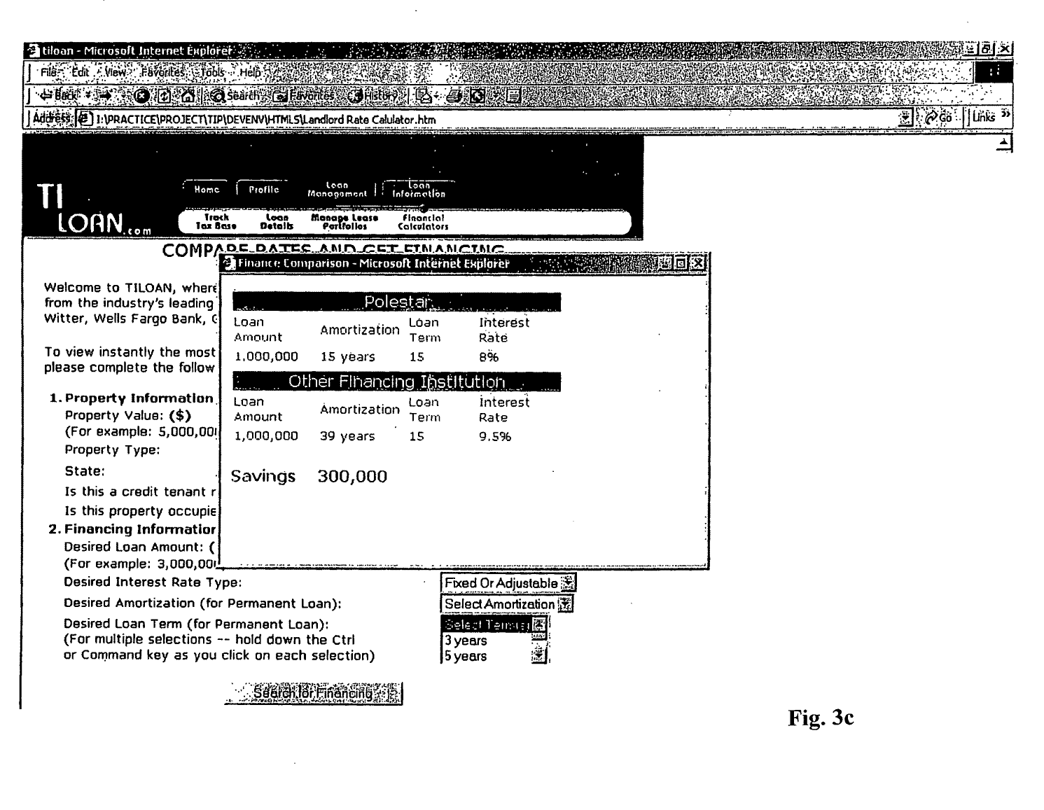

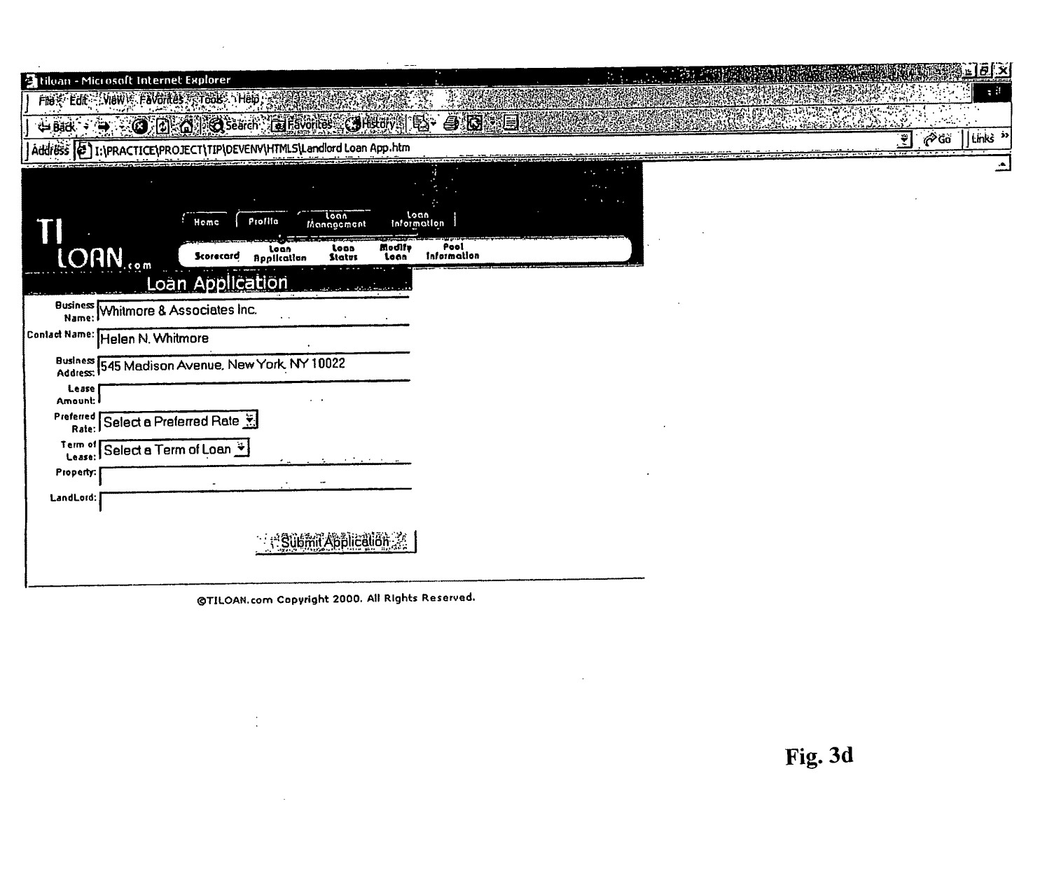

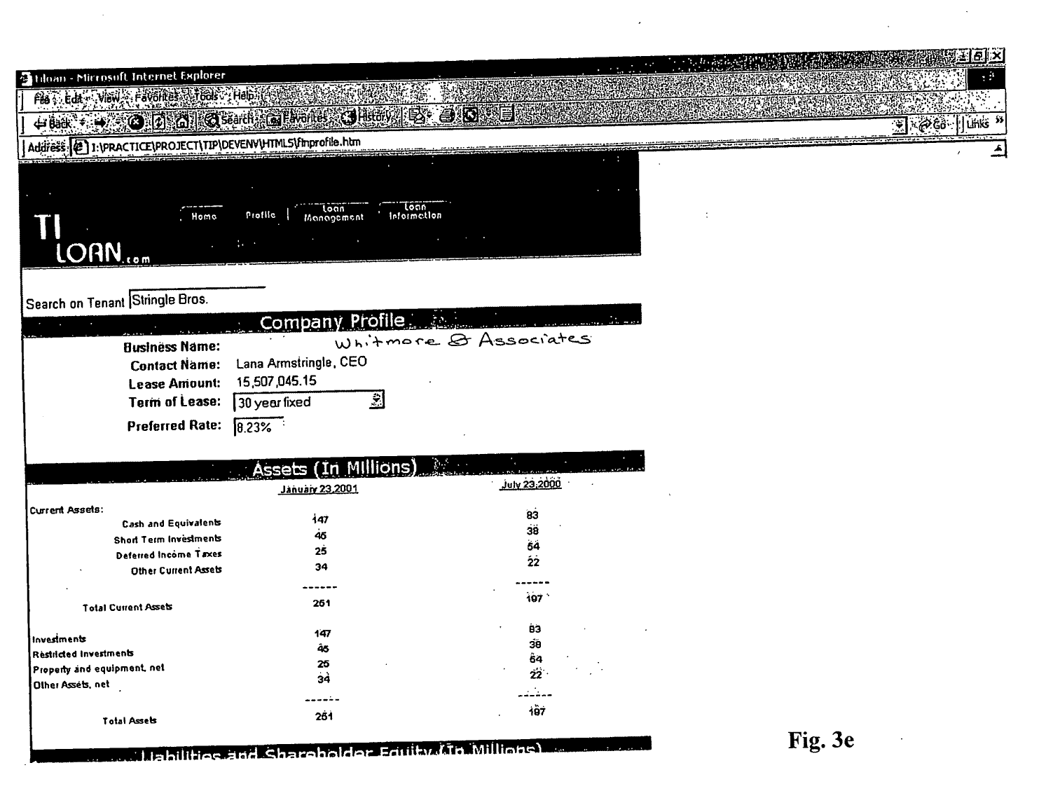

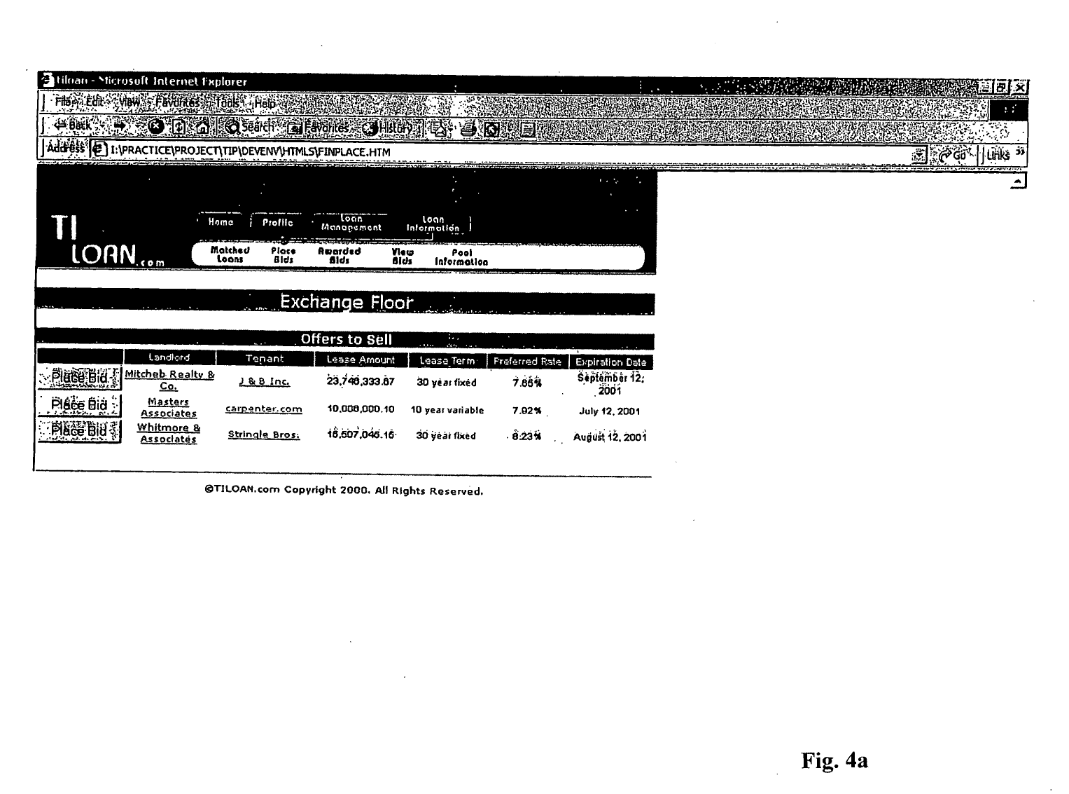

Referring to FIG. 3a, a user may be required to register before accessing the primary features of the application. Registration may allow the software to tailor screens and routines to the user's perspective, whether as tenant, landlord, or representative broker/leasing agent. Sample registration inputs may include company name, address, contact names, and contact numbers, and an indication of whether user is a tenant, landlord, broker, or leasing agent. During the registration process, standard input filtering and editing routines may be used to assure registration data integrity. The information may be stored in a registration database 260. Upon successful registration input, the user may be invited to enter a screen name and select a password.

Referring to FIG. 3b, a registered user may access the software to generate financial comparisons between the lease structure 100 for tenant improvement financing and traditional methods including current borrowing costs and landlord provided financing. Sample modeling inputs may include an estimated base building property value, property type (selected from a pop-up menu), the state in which the property is located (e.g., selected from a pop-up menu), and other qualifying criteria questions. The user may indicate a baseline scenario, for instance, whether financing is to be drawn at the tenant's internal cost of funds, funds borrowed from the capital markets, or other terms for the landlord's proposed financing. The user may indicate a desired loan amount, desired loan term, and current financing scheme. When the input has been received, the software may present a summary screen to the user for validation and editing.

Referring to FIG. 3c, when the inputs have been validated, the user can submit the case scenario to the system for processing. The system may generate a report that illustrates the cost/benefit, or possible cost increment, associated with a tenant improvement lease 100 in comparison to the baseline alternative. The comparison may generate results on a before and after tax basis, as well as an estimated present value of discounted cash flow. The user may save the case model for future study, and/or generate hardcopy reports.

Referring to FIGS. 3d and 3e, a registered user may immediately segue from a modeling case to apply for a loan. Many of the required input fields may be carried forward from data entered during modeling analysis. Alternatively, certain users may elect to go directly to the loan application screen, bypassing the modeling step; in this case, the loan application form may be partially completed using the information 260 provided at registration. The loan application software enables an applicant to submit loan requirements and credit information for evaluation by the lender's underwriting department. An applicant may specify a loan type (e.g., construction take-out, sale/leaseback, or refinancing of existing improvements), attributes of the building (location, gross leaseable space, current occupancy percent, owner/landlord information—lender 200 may provide an electronic look-up of pre-approved landlords), a profile of space lease 106 (square footage of space lease, rent schedule, expiration date of initial term, lease commencement/tenant occupancy date, options to extend), a profile of the tenant (company name, address, contacts, SIC code, state and year of incorporation, stock symbol, tenant credit ratings from Moody's Investors Service, Standard & Poor's, and Fitch/Duff & Phelps and any indicated rating trends), and, if tenant 102 is not rated by one of the rating services, audited tenant financial statistics from most recent financial statement, including, e.g., EBIT interest coverage (times), EBITDA interest coverage (times), Pretax return on capital (%), Operating income/sales (%), Free operating cash flow/total debt (%), Funds from operations/total debt (%), Total debt/capital (%), Annual sales (million), Total equity (million), Total assets (%). The applicant may also specify loan requirements, including principal amount requested, date funding required, and term of loan.

Upon completion of input, software 300 may present a summary screen to the applicant, from which the applicant may review all inputs. The applicant may be given the opportunity to edit the input. The applicant may submit the application and may receive a hardcopy report of the application.

Loan origination software 300 may apply criteria supplied by lender 200 to make an approval decision, or software 300 may merely serve as a conduit, collecting information to be provided to a human underwriter. The underwriting department may electronically notify the applicant of receipt of the application, present a timetable for response, and inform the applicant of a point of contact. In addition, the applicant may be notified if additional information is required, who in turn may determine whether to approve the loan, and as appropriate, the pricing, terms, and conditions associated with a loan commitment.

If the application is ultimately approved, a loan offering notice will be sent to the applicant, together with a proposed closing timetable, documentation requirements, and terms and conditions precedent to closing.

For approved loans, software 300 may feature a form of electronic tickler and scheduling file that will coordinate the performance of all participating parties involved with the loan closing process, e.g., tenant legal counsel, landlord legal counsel, trustee of special purpose entity 110, appraiser etc. Most of the information for this tickler function may have been developed during the application process, however selected additional inputs may be obtained for tenant and landlord legal counsel and contact information, and details for legal documentation, including designated parties for notices, funding instructions, loan payment instructions, etc.

Software 300 may produce paper hardcopies of standardized document forms tailored to the specific loan transaction, and may distribute them to the required parties for their initial review. If the landlord or tenant have previously negotiated and closed a transaction using software 300, their preferences may be consulted and reused for this transaction. The system may provide an on-line status report for registered users to query during the loan closing process to monitor progress.

VII.B. Loan Exchange

Software may be provided to implement a Loan Exchange 400, to coordinate communication between borrowers (or “sellers” of the cash flows represented by tenant improvement leases 100 that constitute the collateral assets for loans 120, usually tenants and landlords) and lenders (or “buyers” of these cash flows, usually investors, lenders or qualified intermediaries).

Loan Exchange 400 may oversee, support and manage reverse auction transactions, in which sellers post requests for tenant improvement financing—according to standard terms and conditions—and buyers compete on price to supply capital for those financings. Loan Exchange 400 may provide a central market for buyers, sellers and qualified intermediaries to meet, match and transact. Loan Exchange 400 may act as arbiter, transaction manager and clearing agent for loan sales/purchases that will close and be cleared on a timely basis.

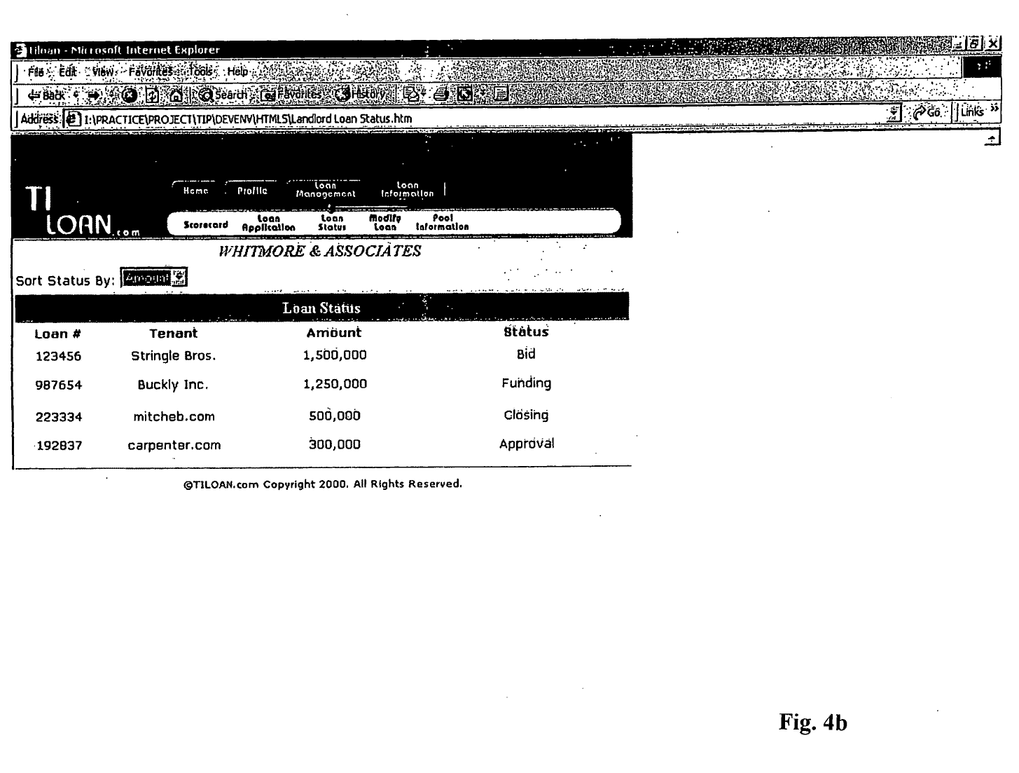

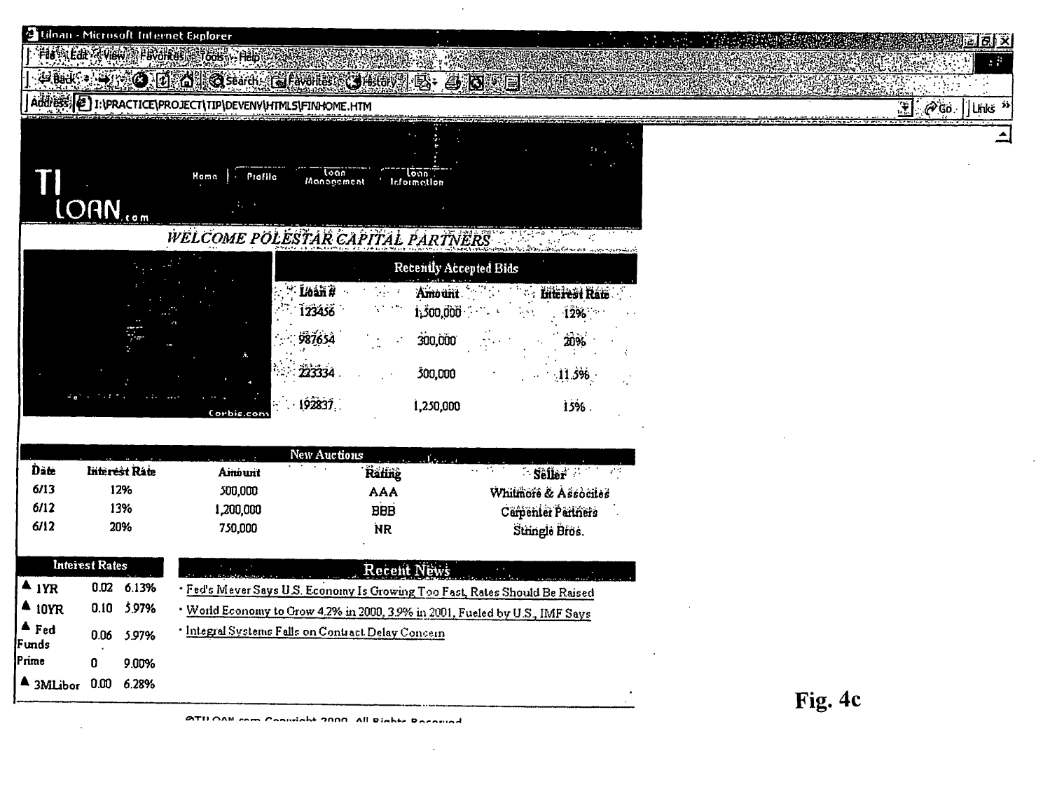

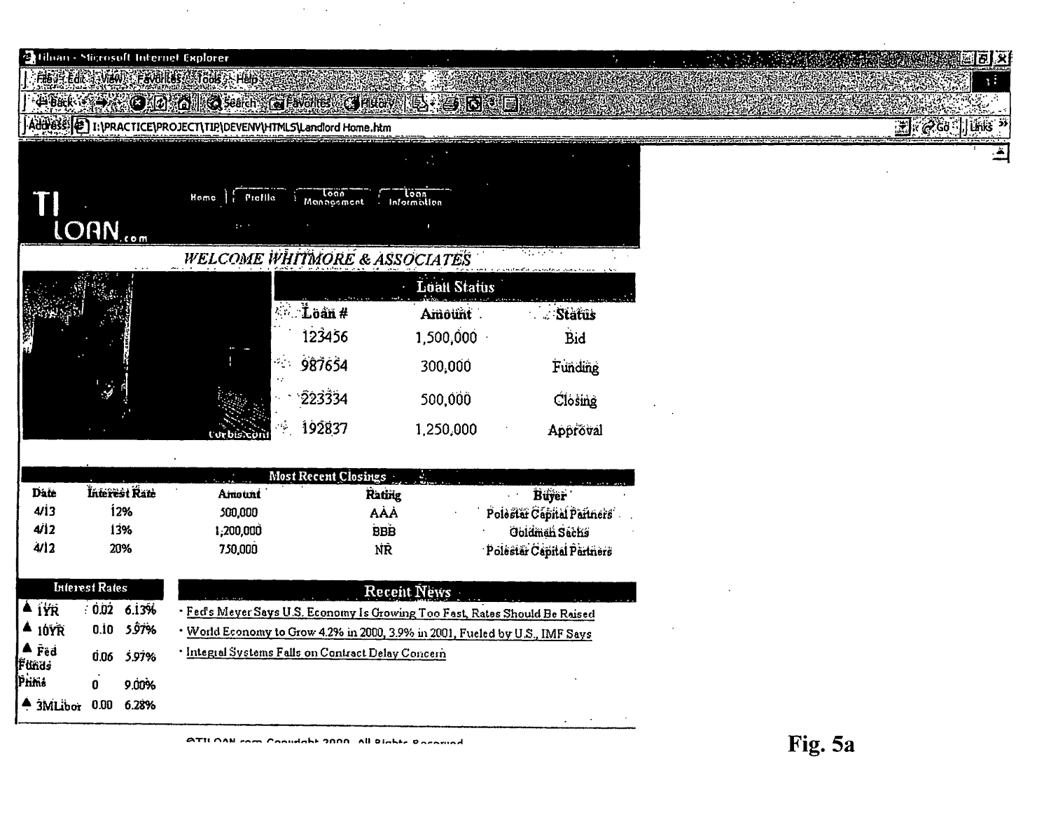

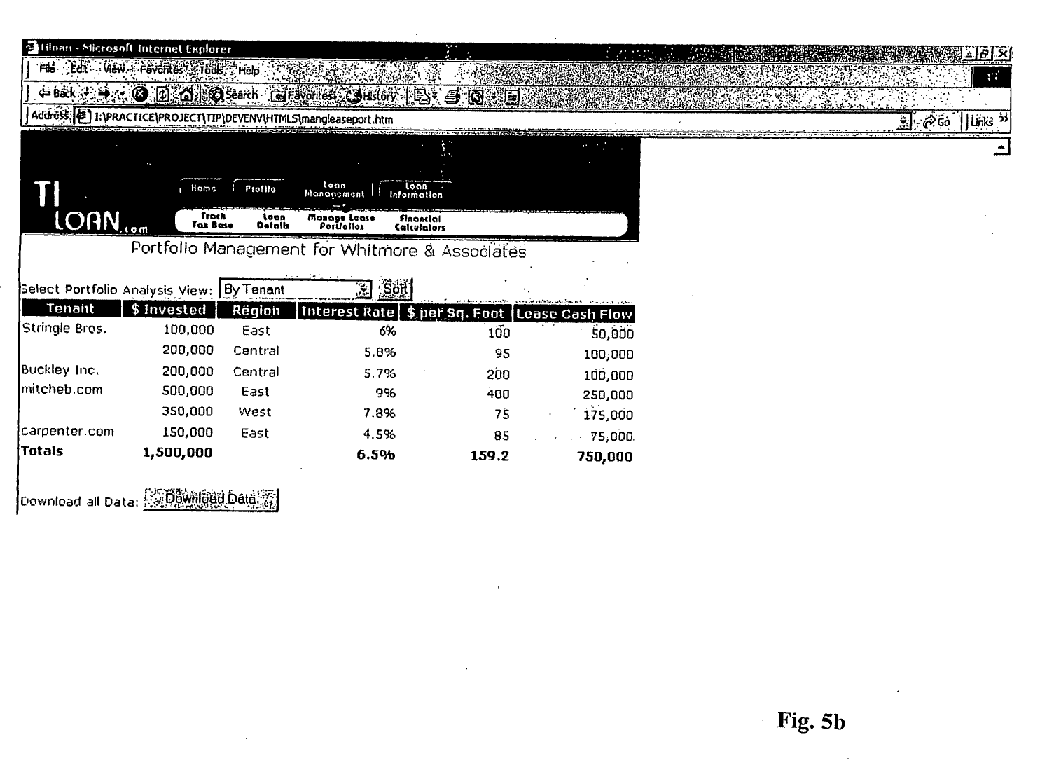

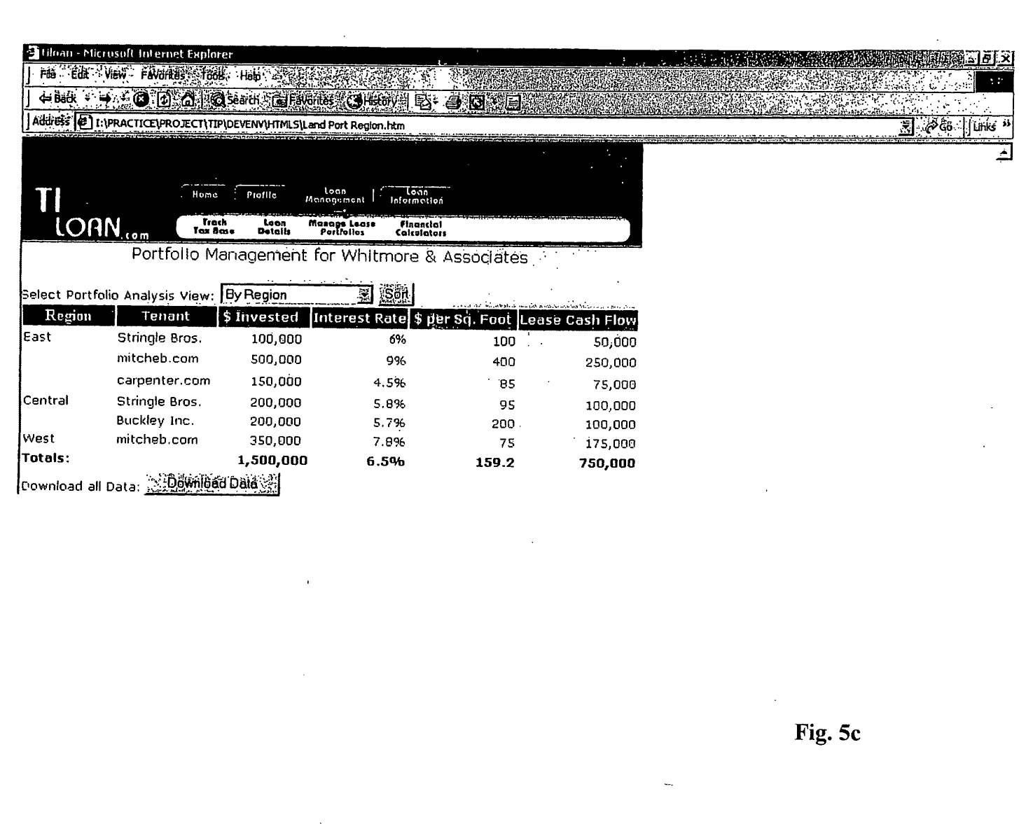

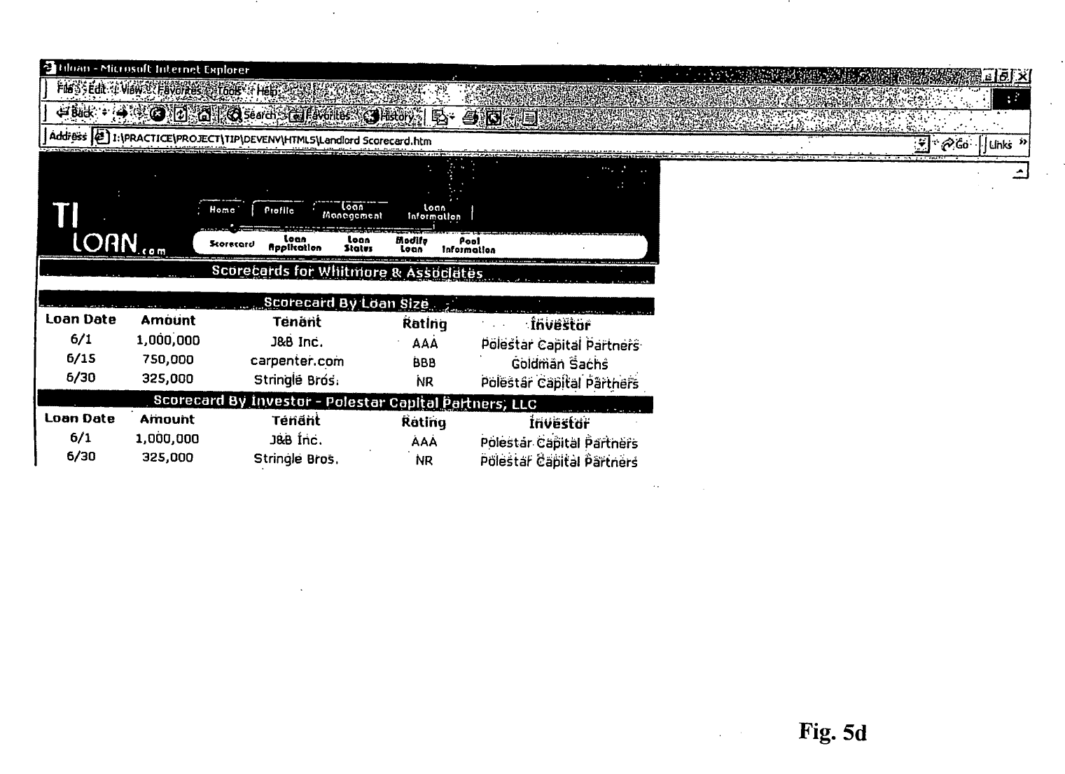

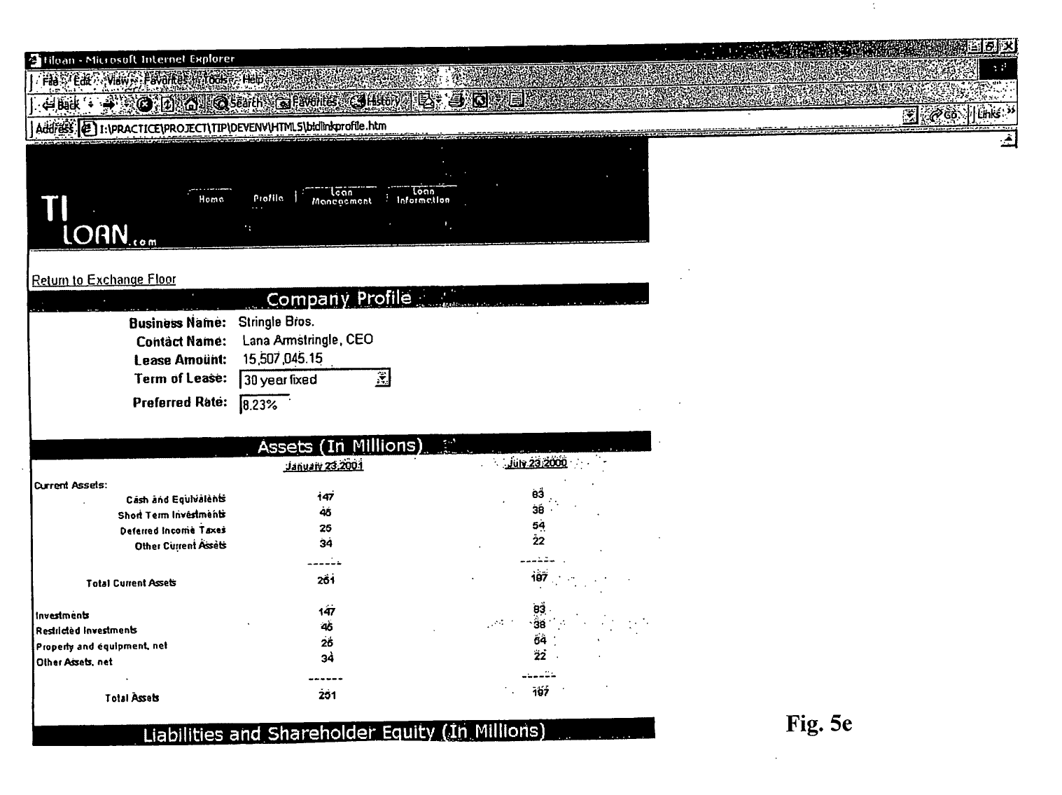

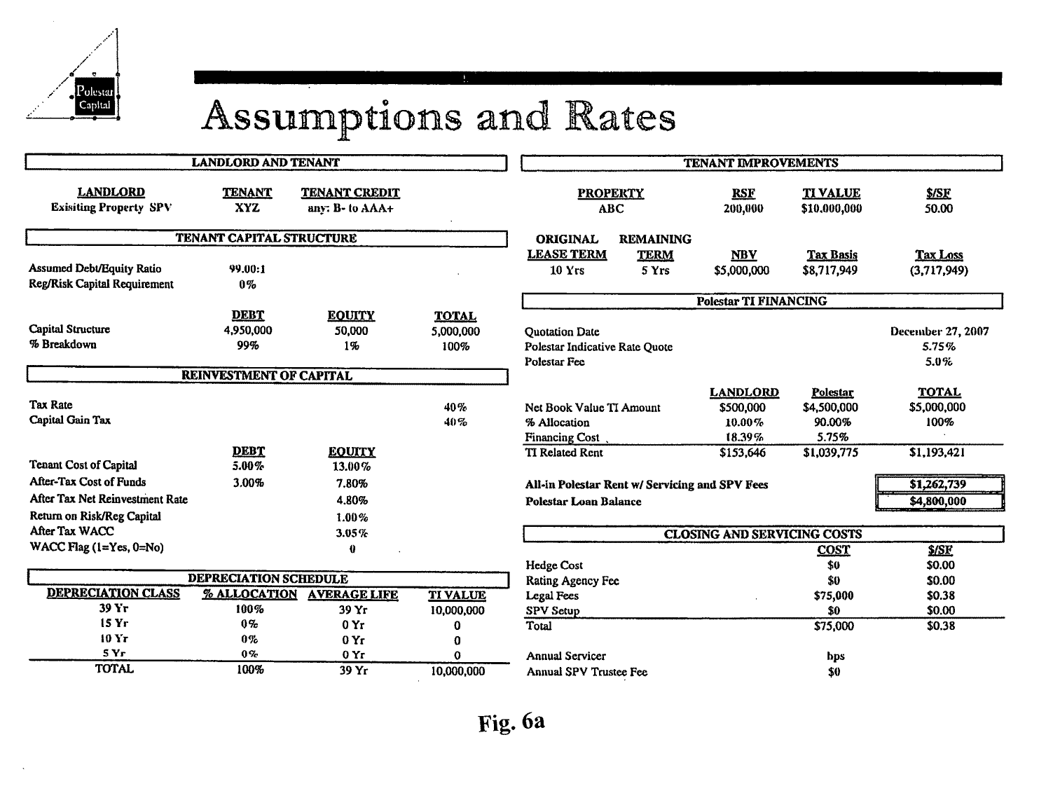

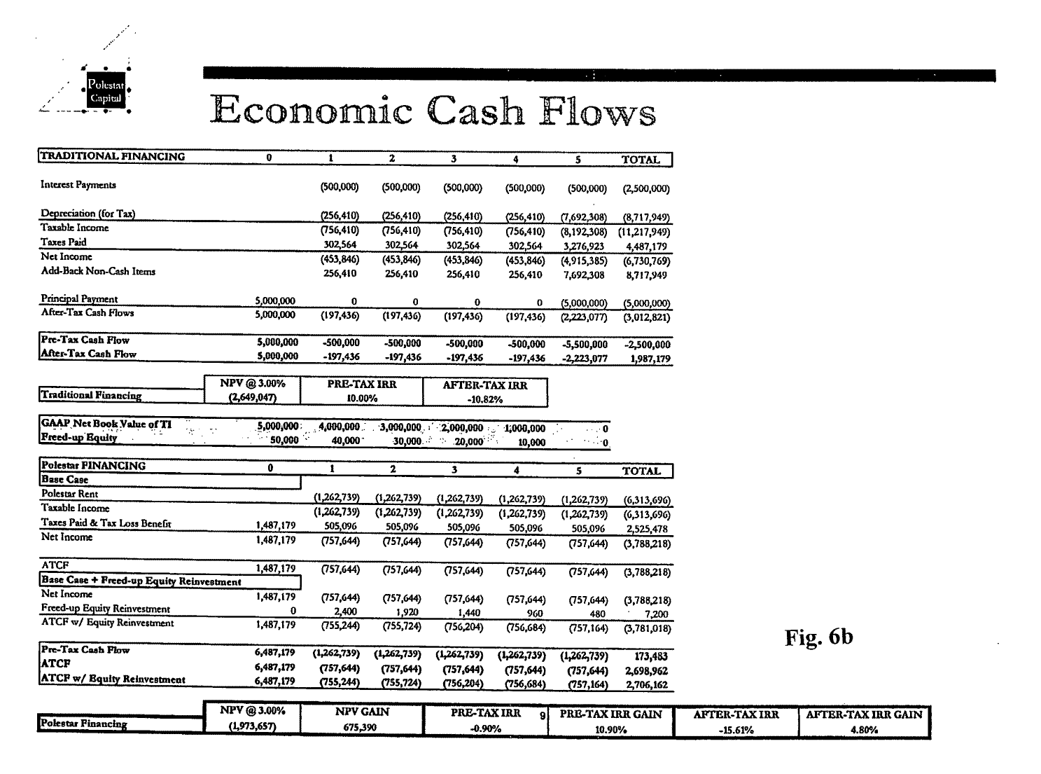

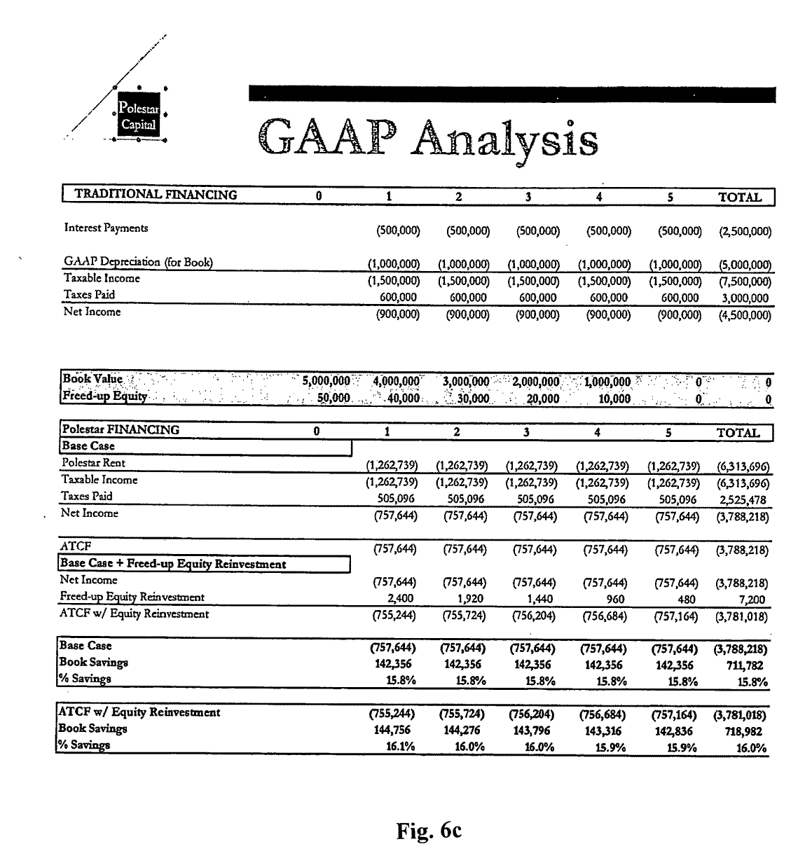

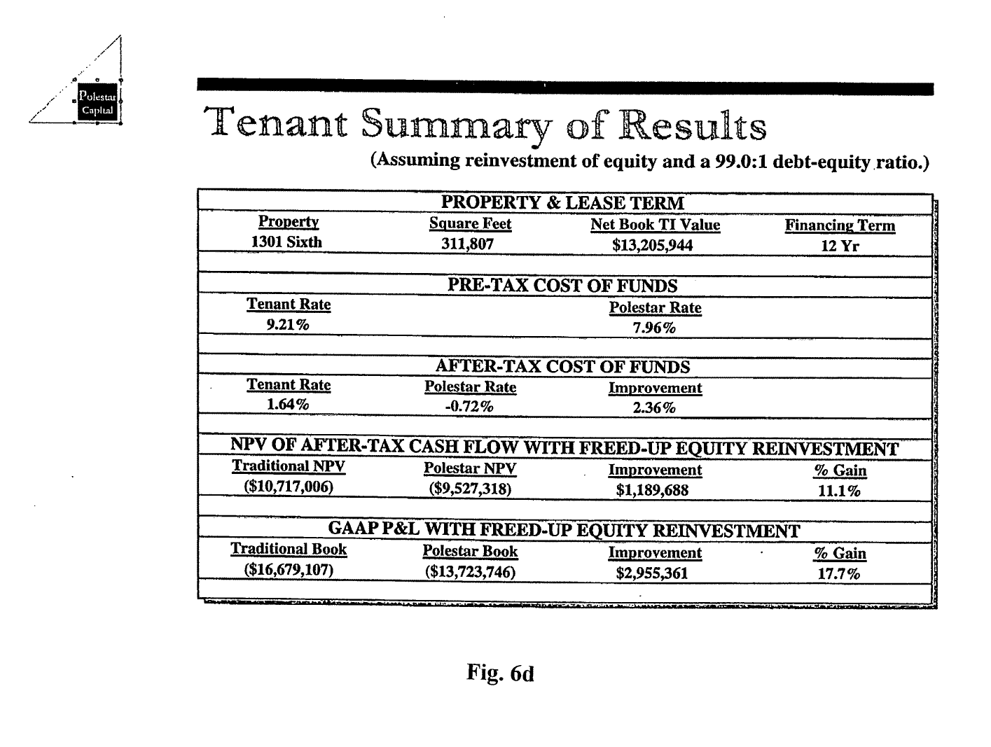

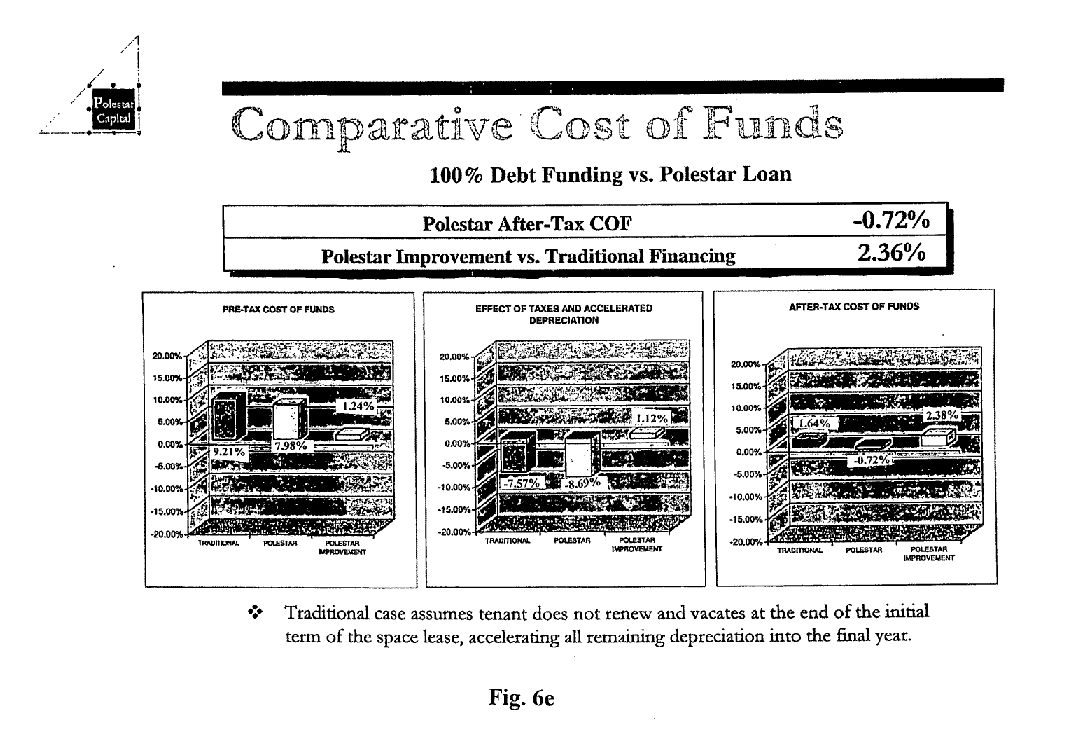

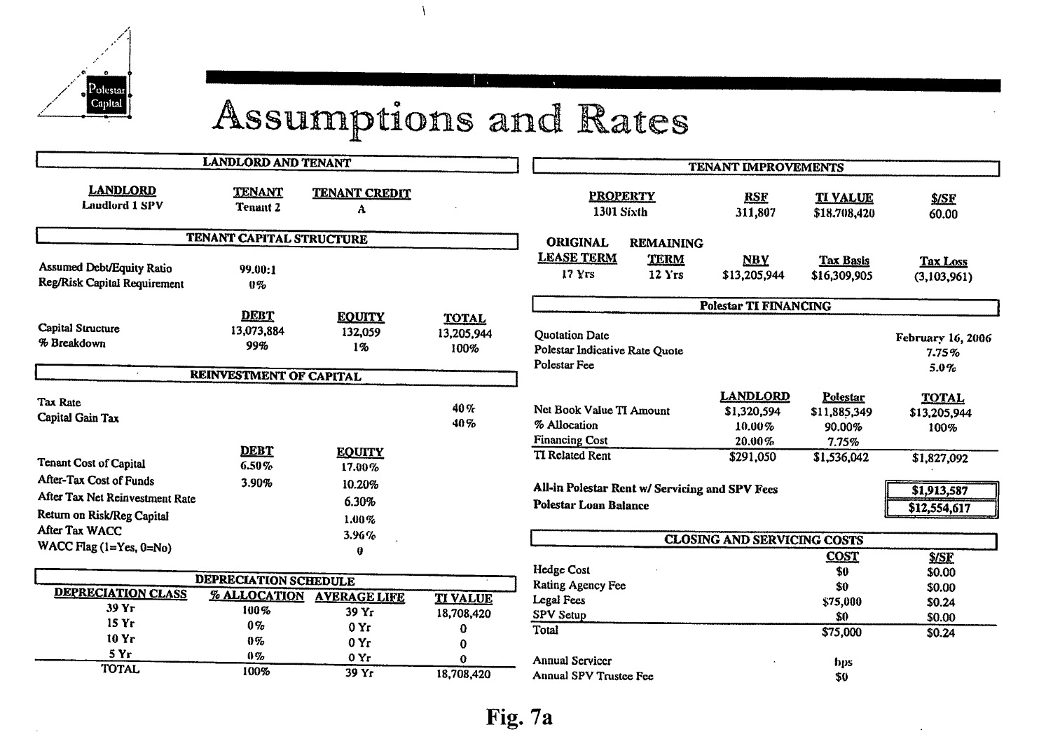

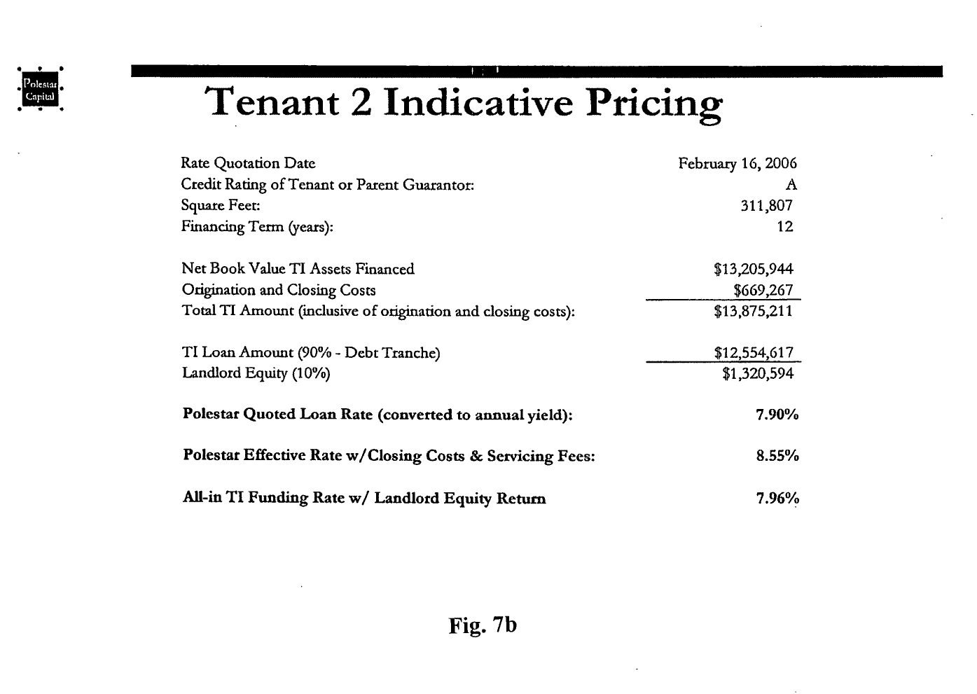

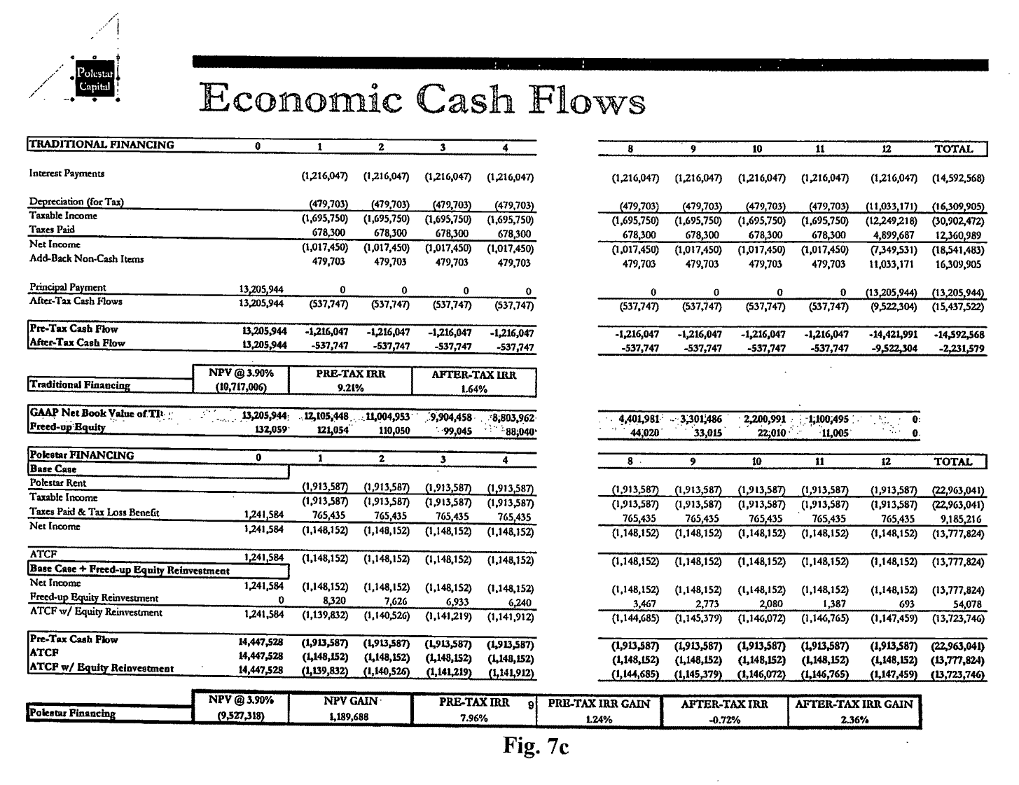

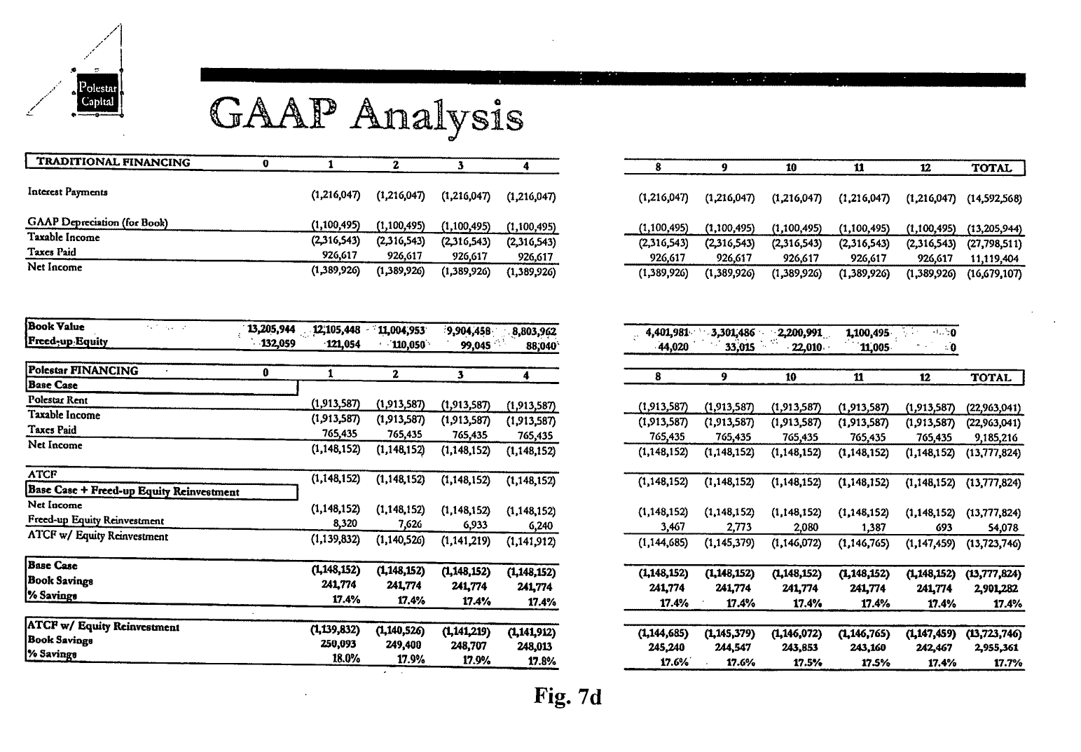

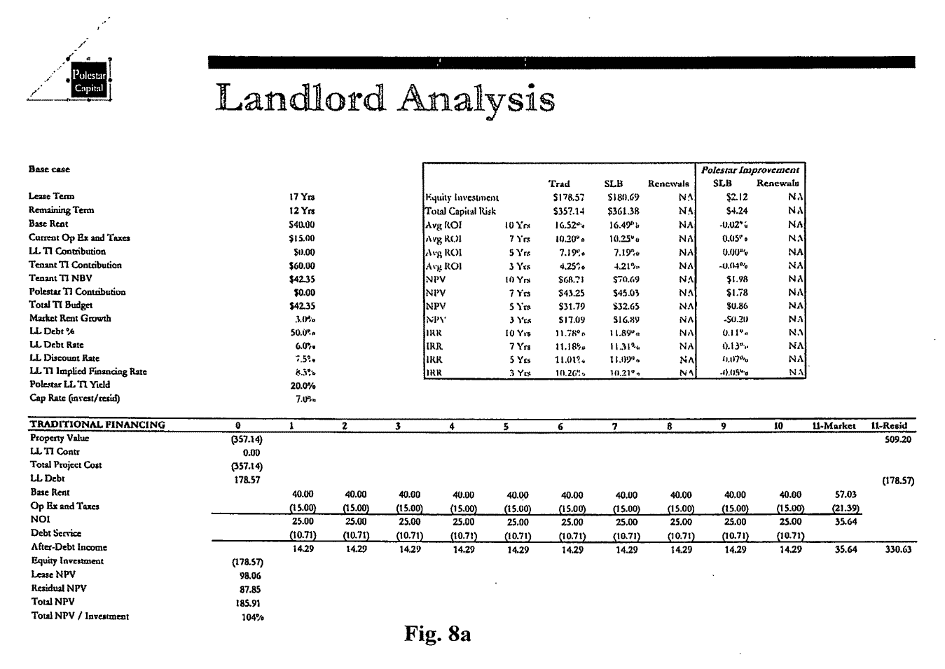

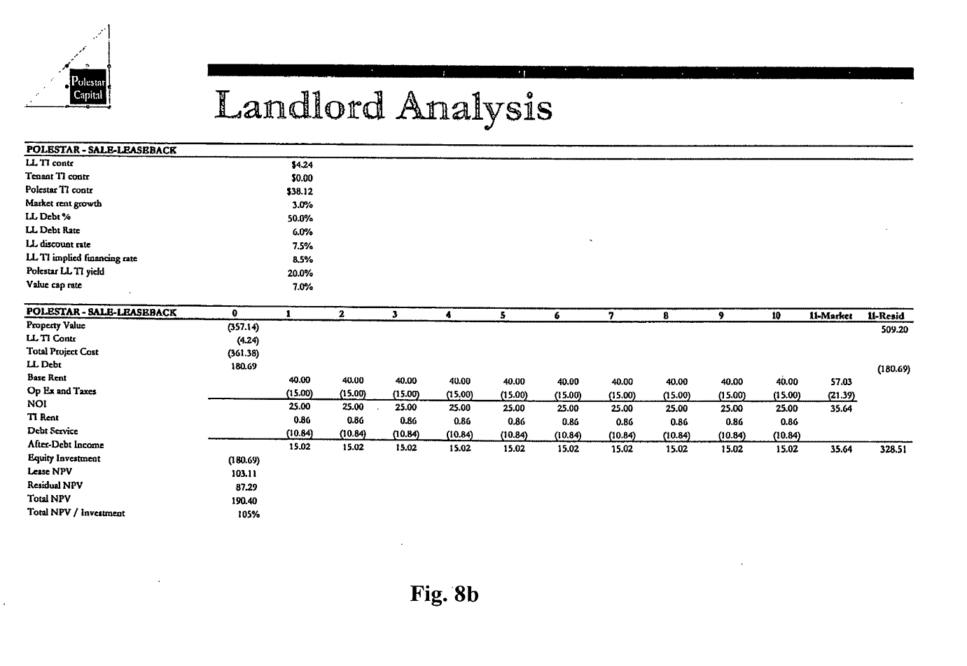

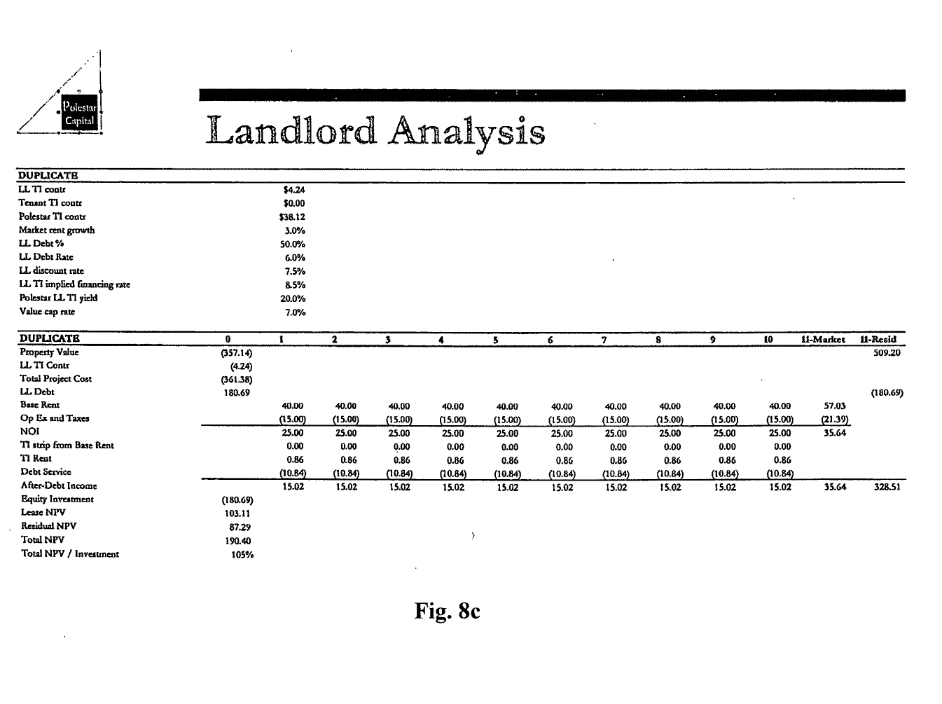

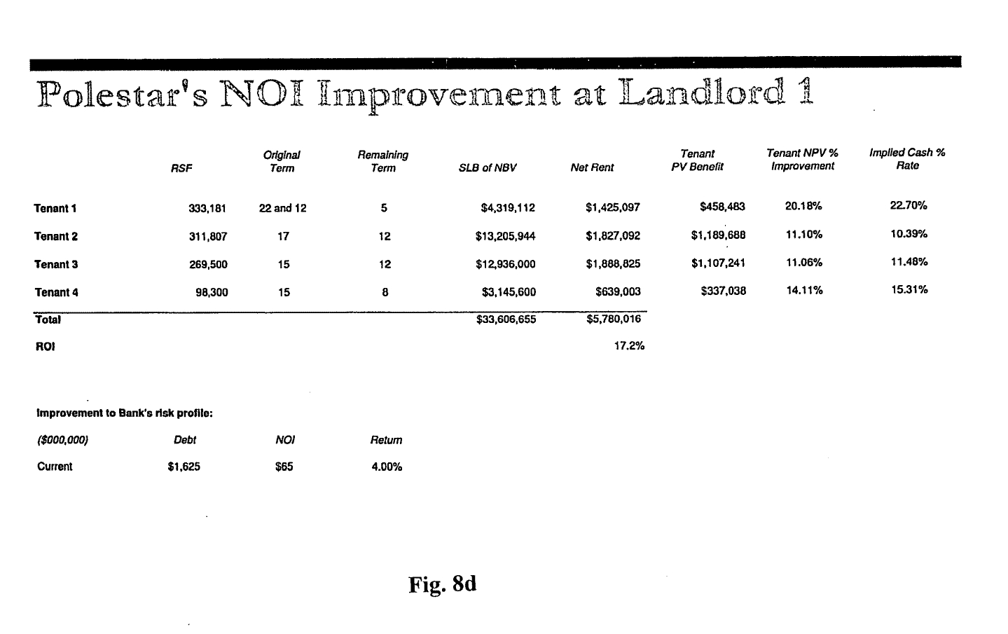

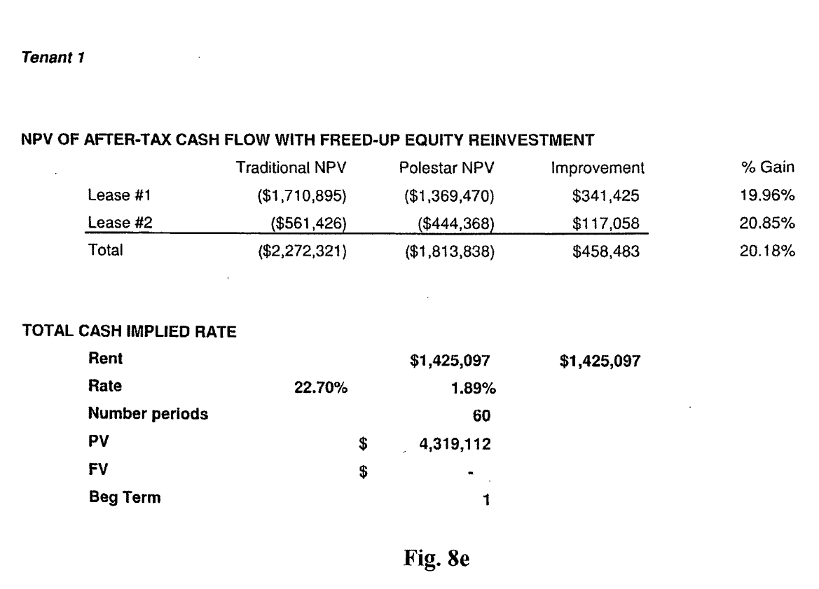

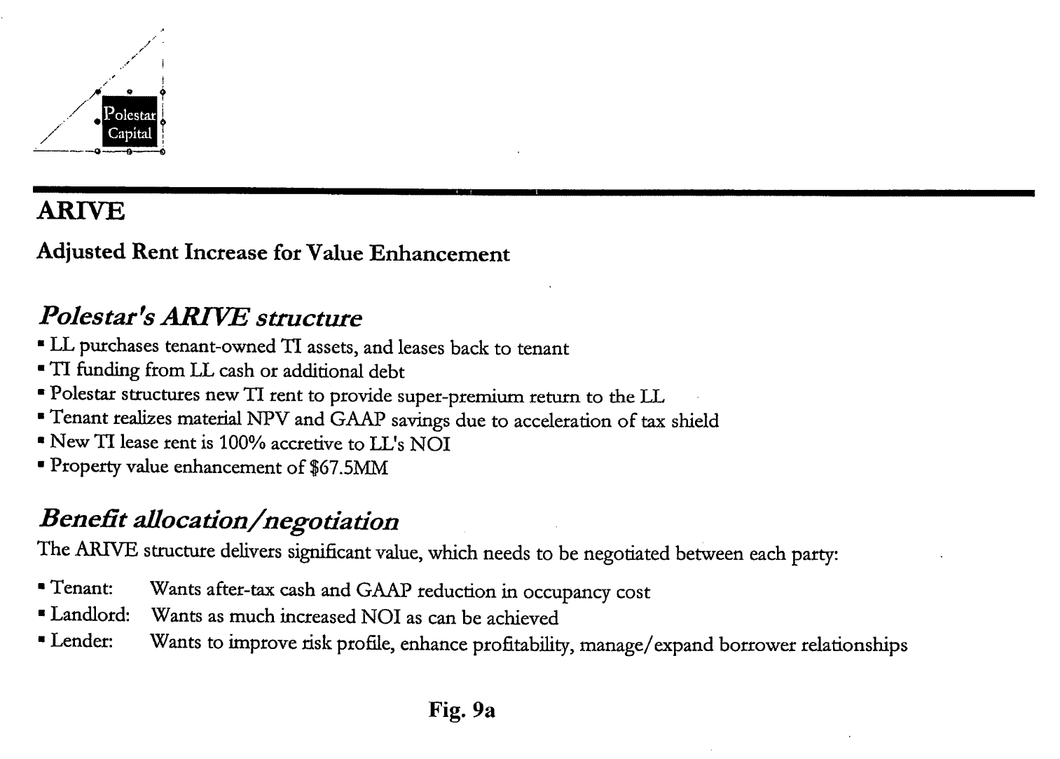

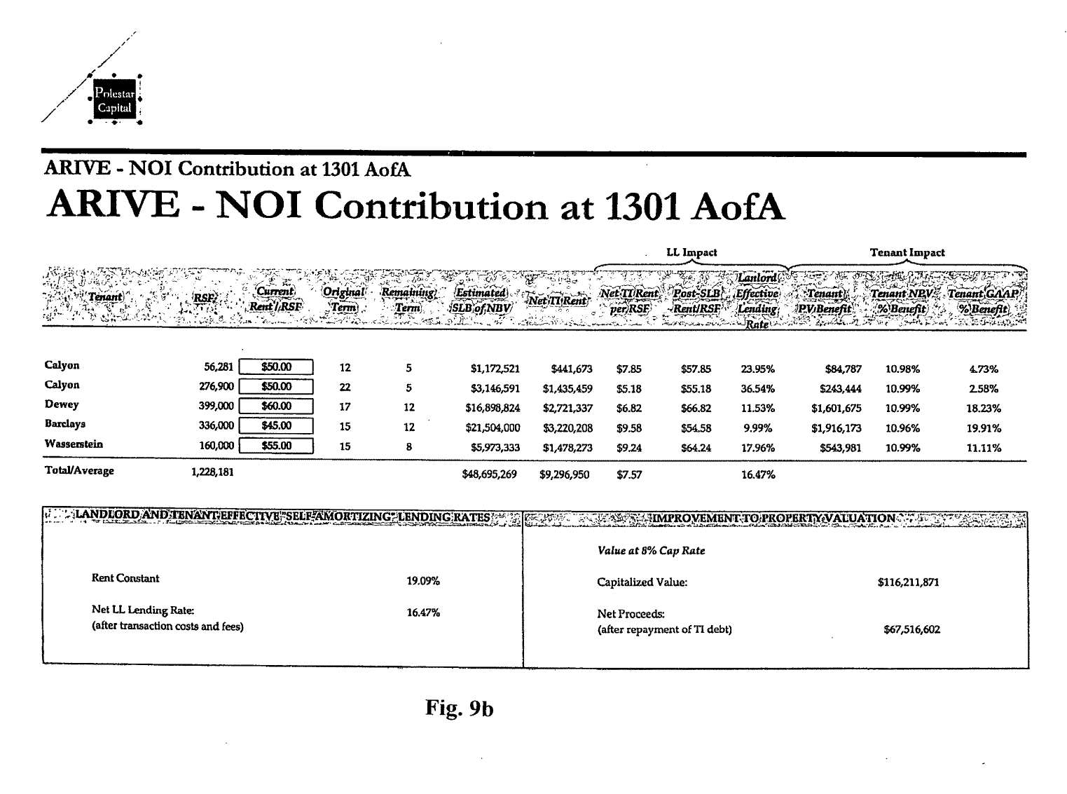

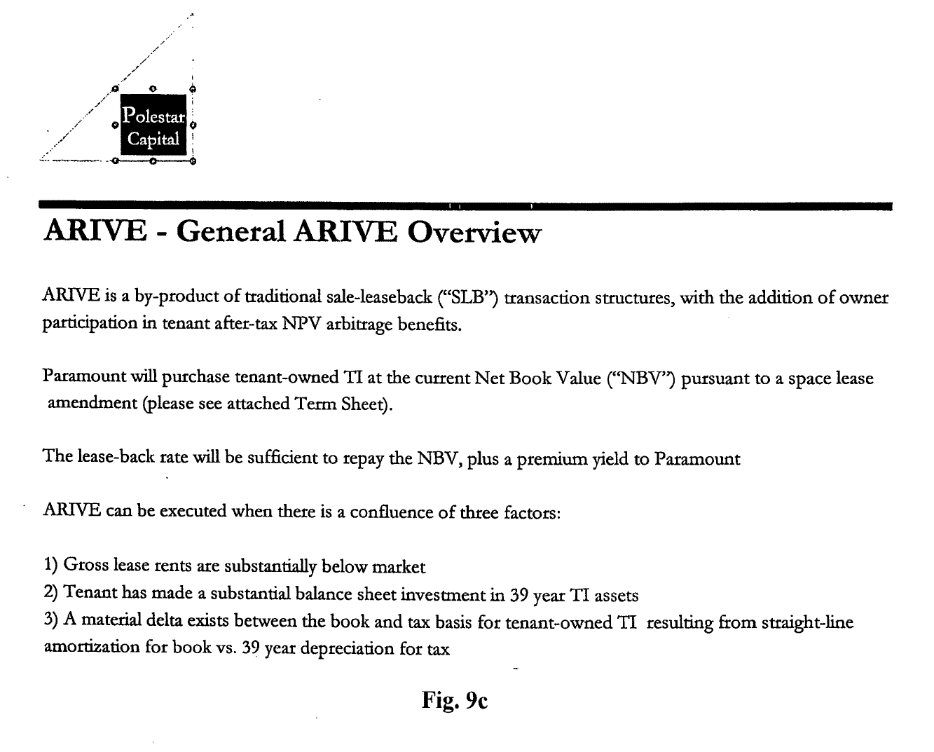

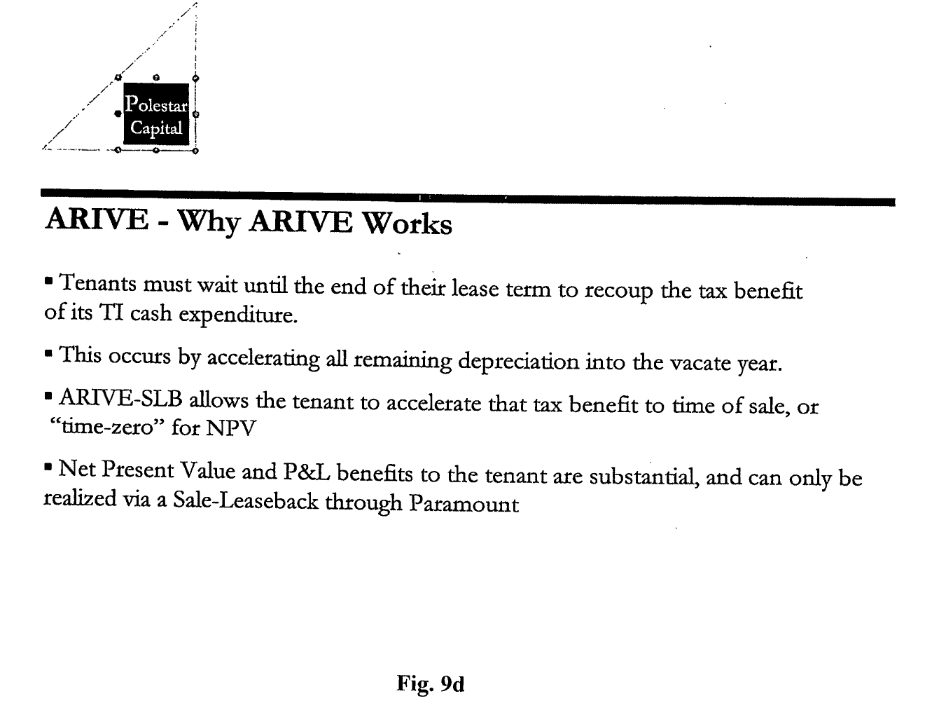

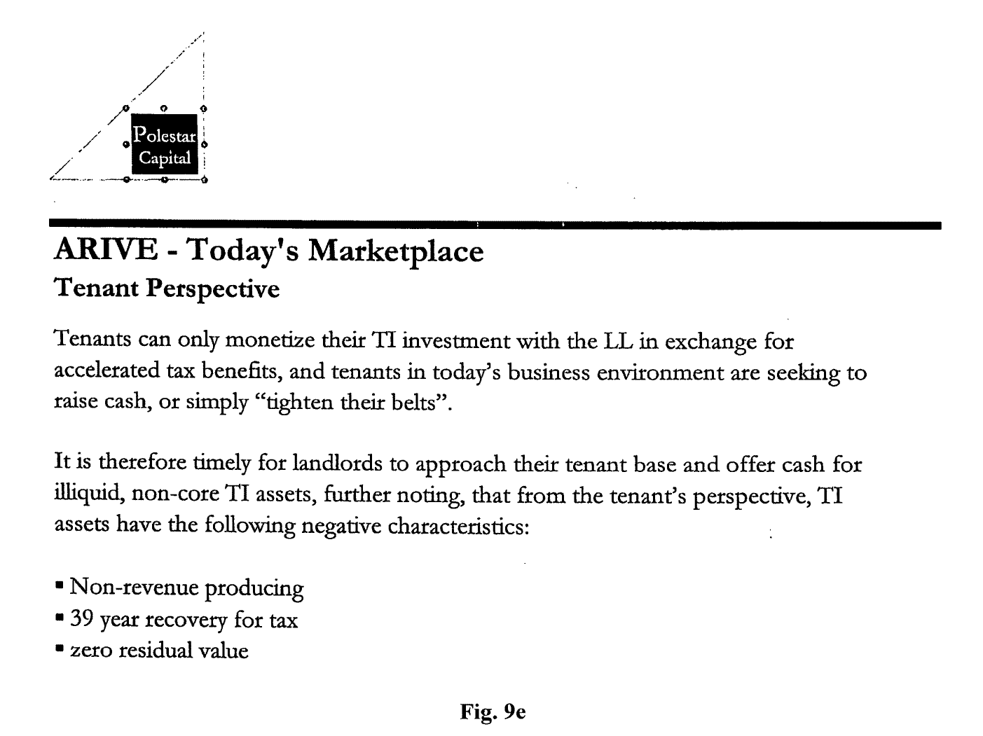

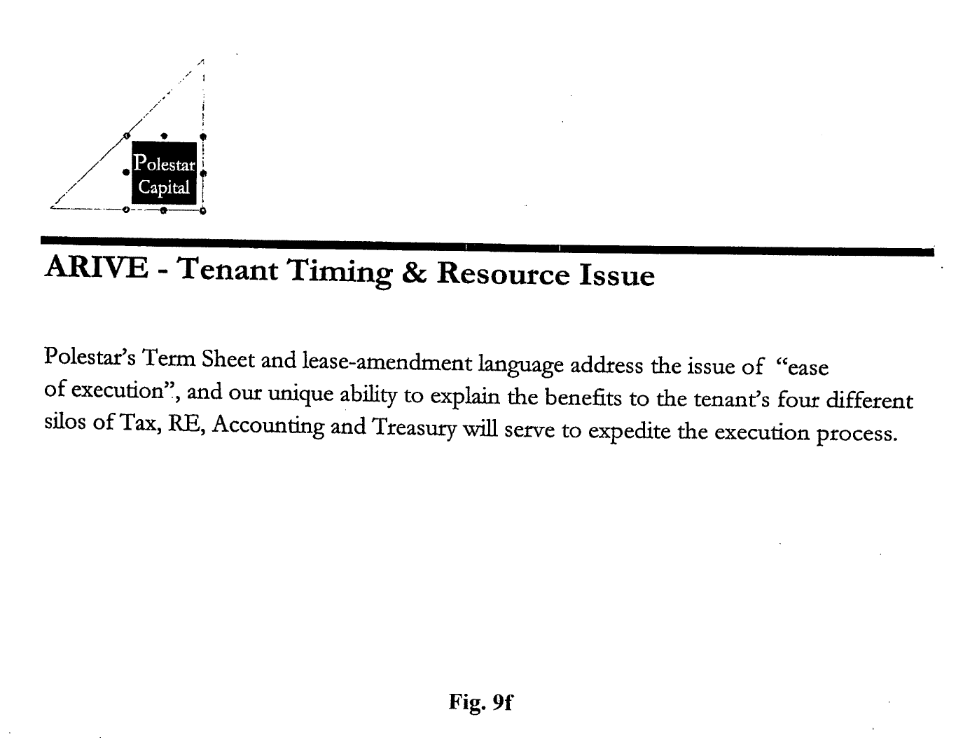

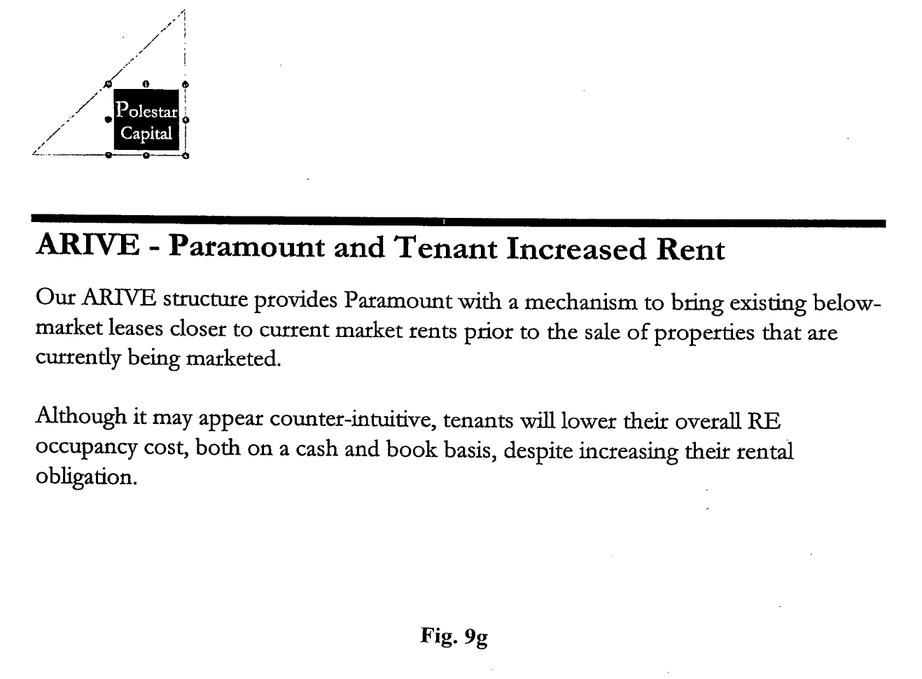

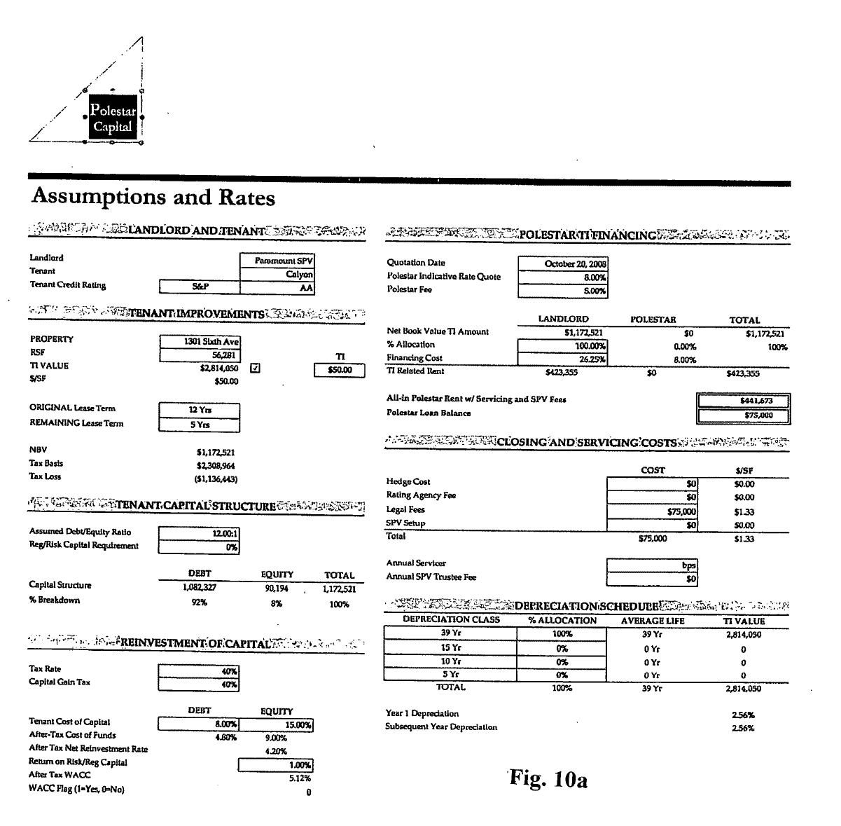

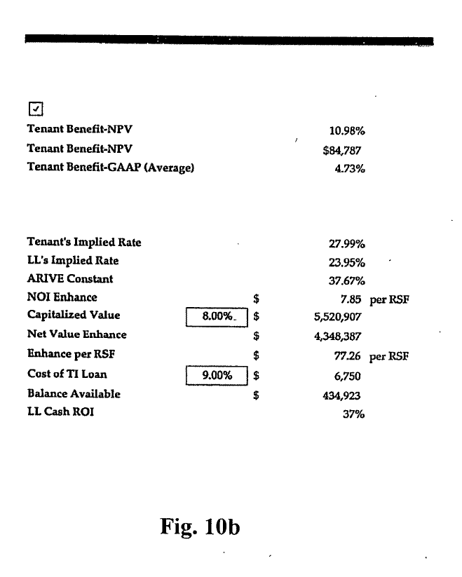

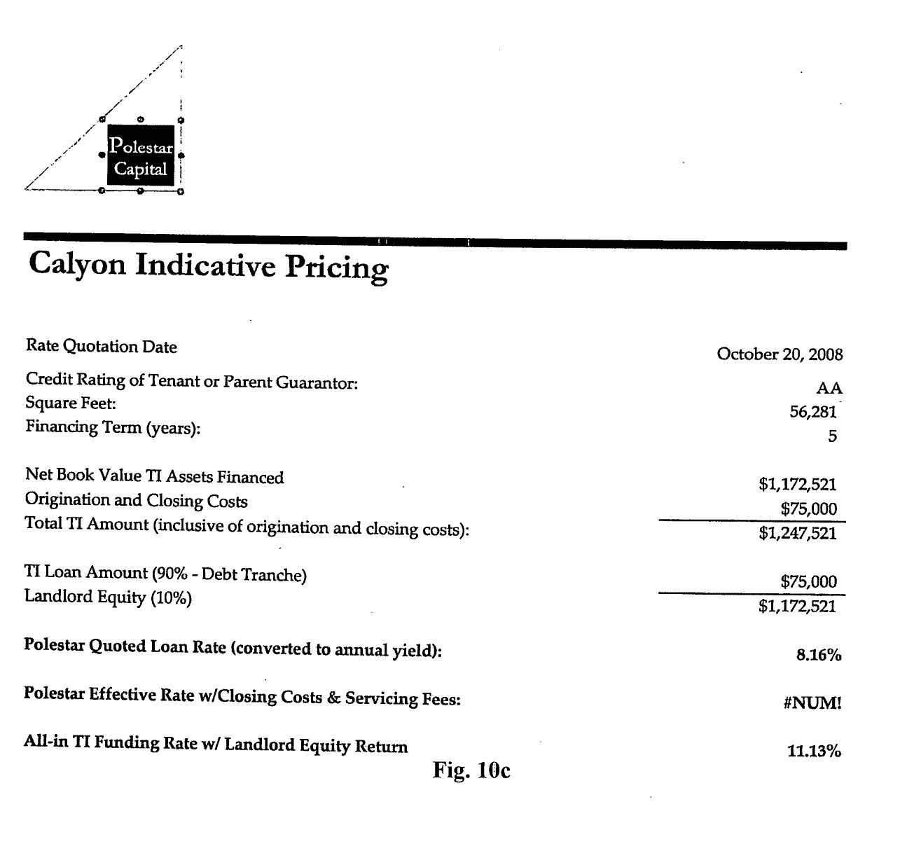

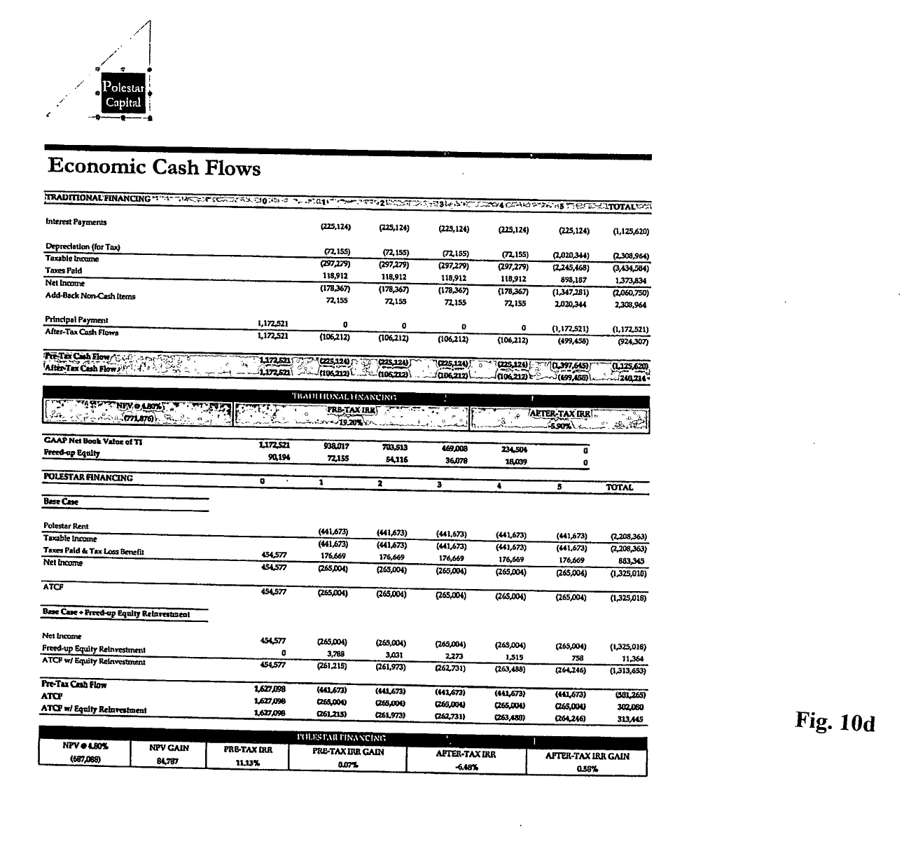

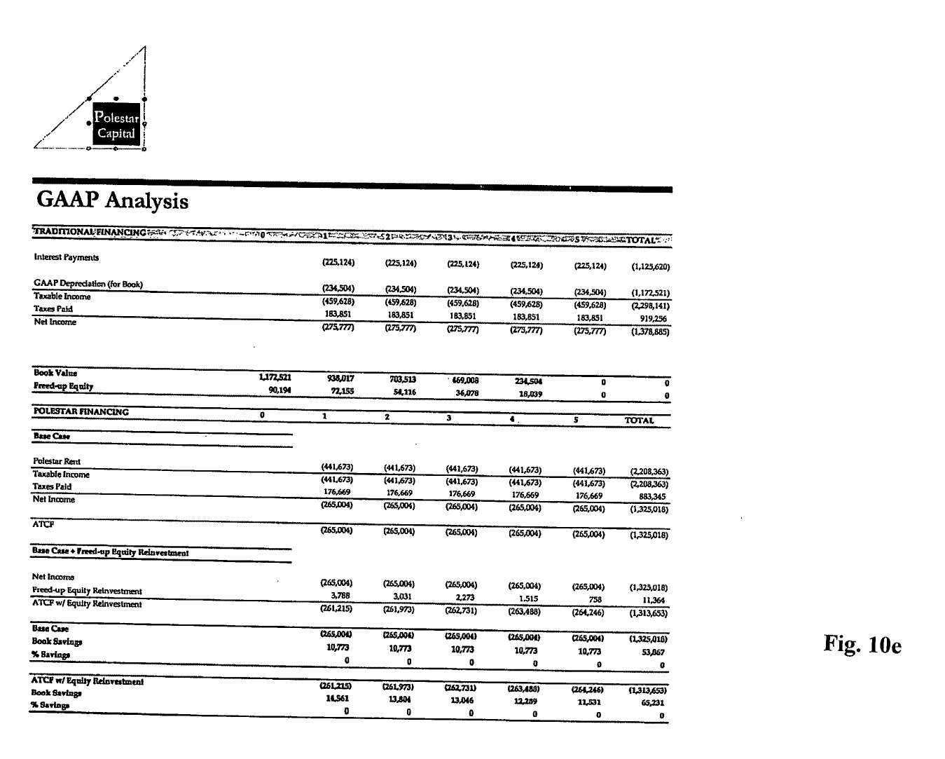

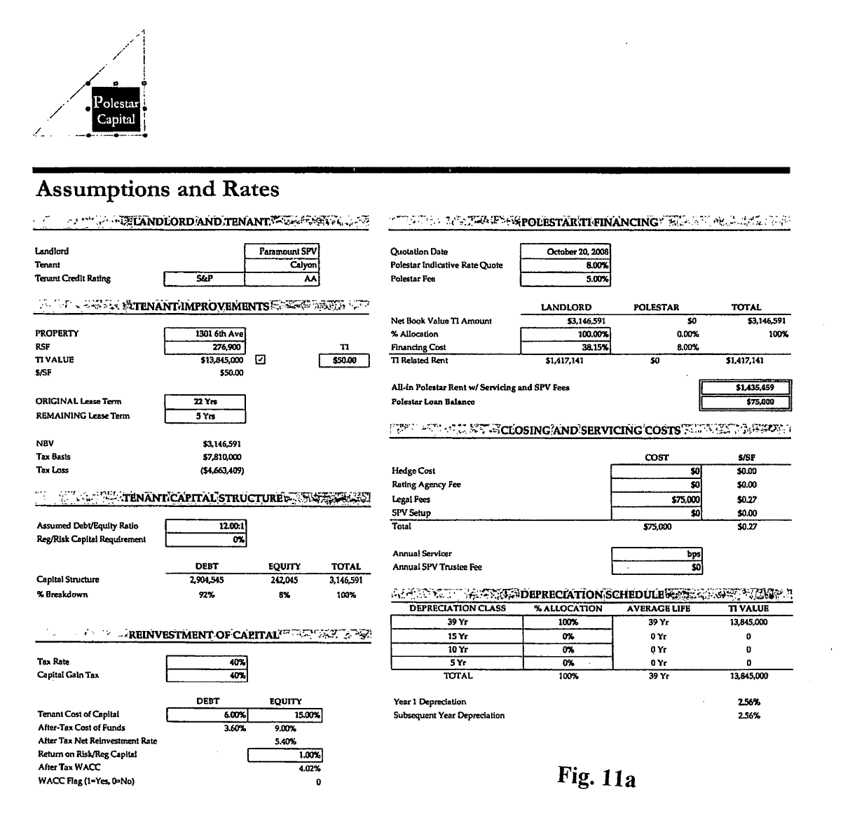

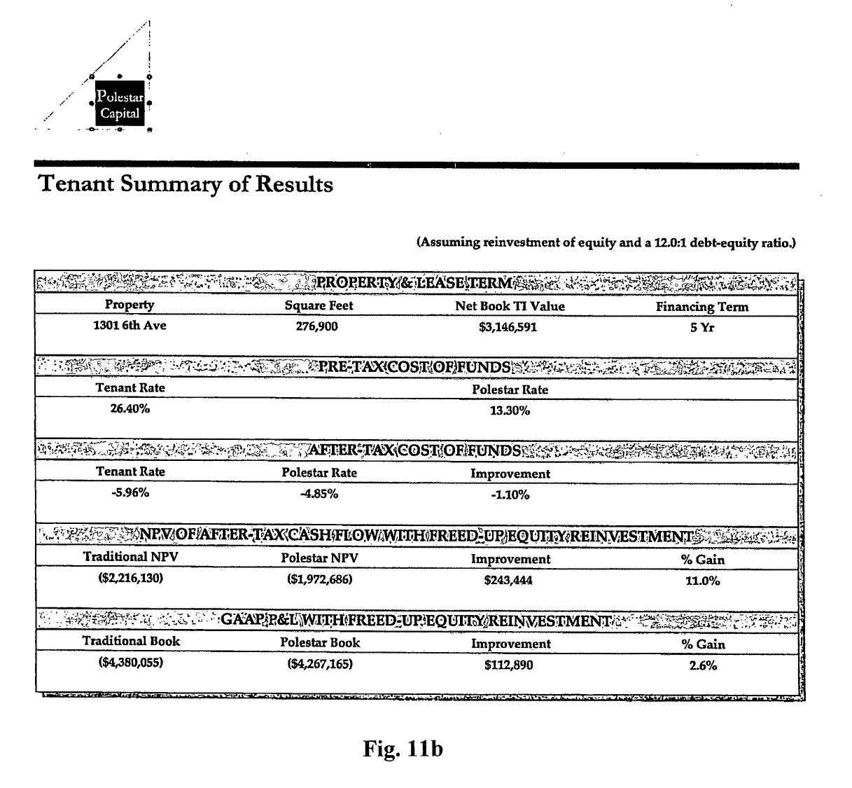

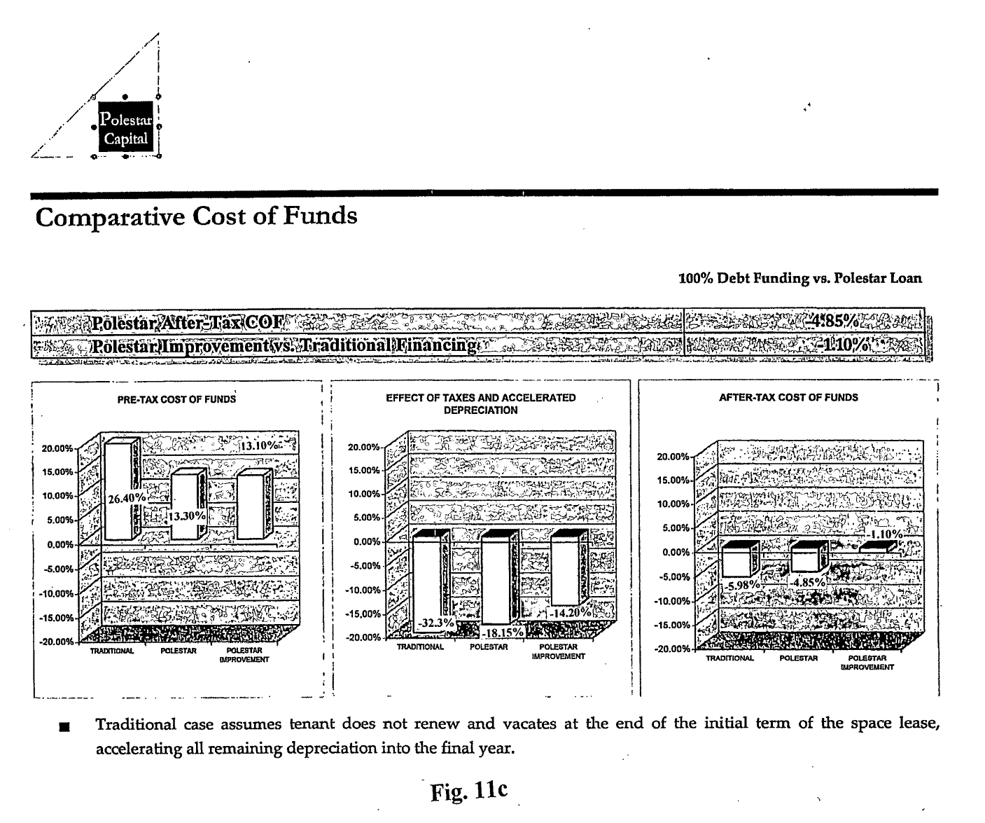

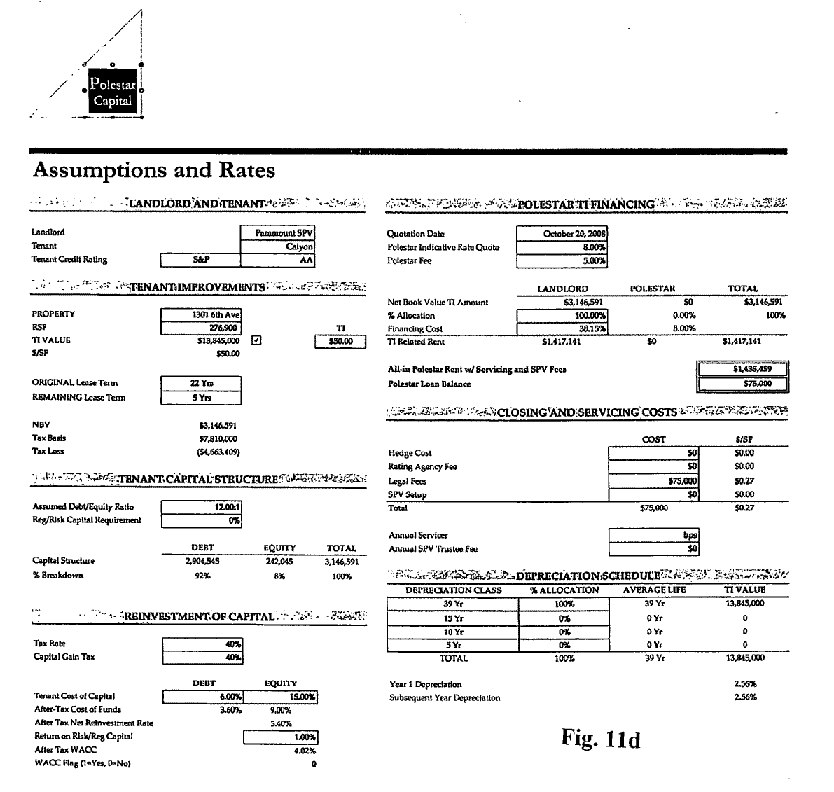

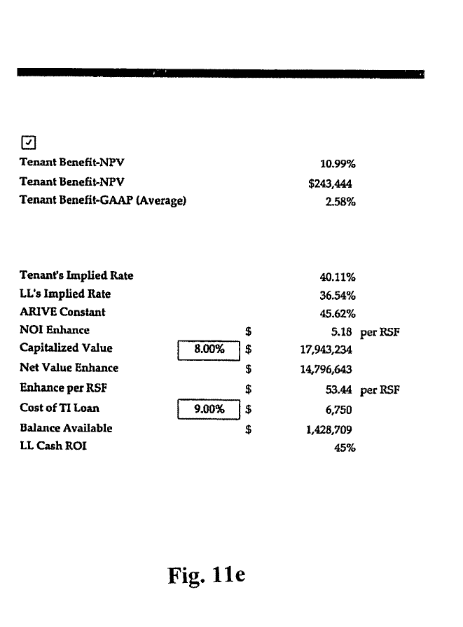

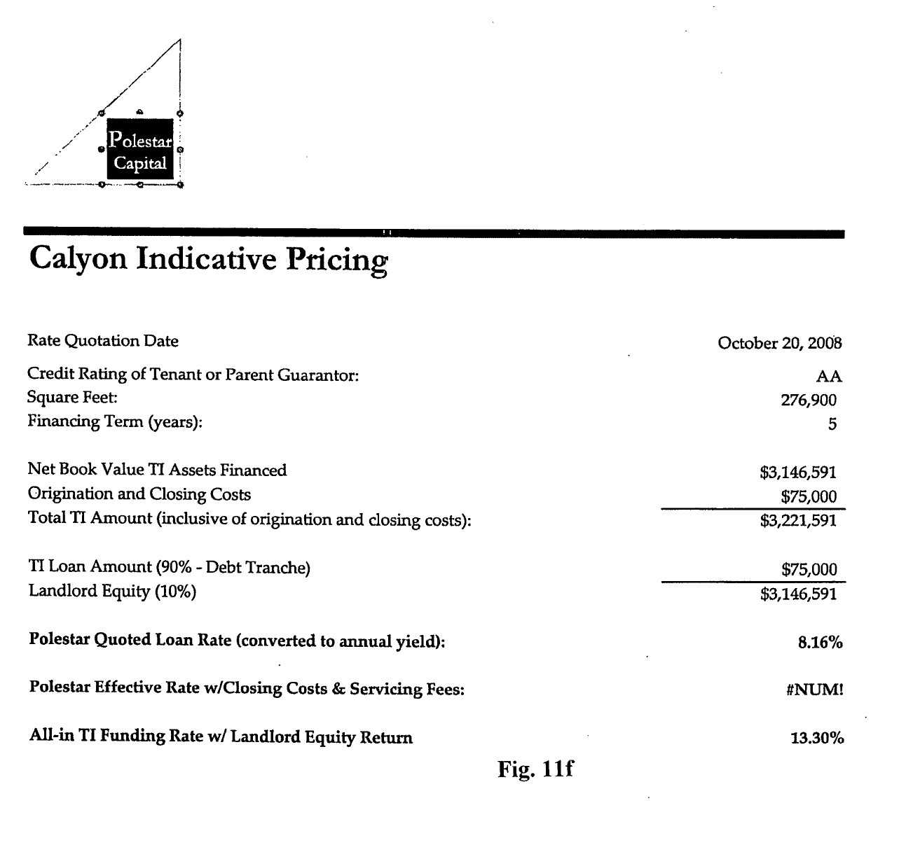

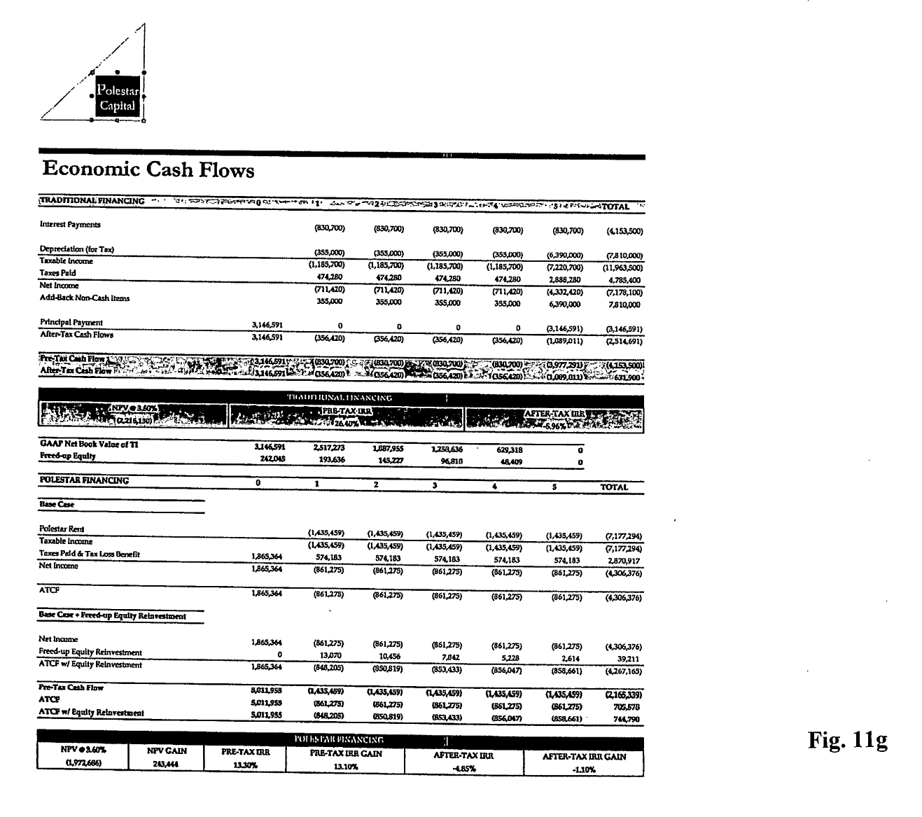

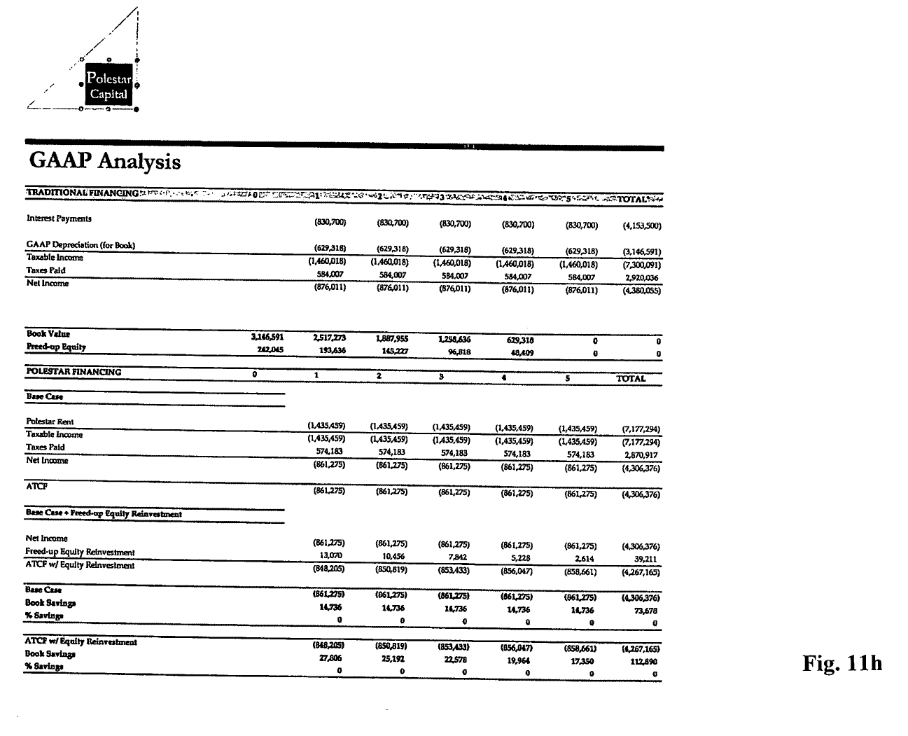

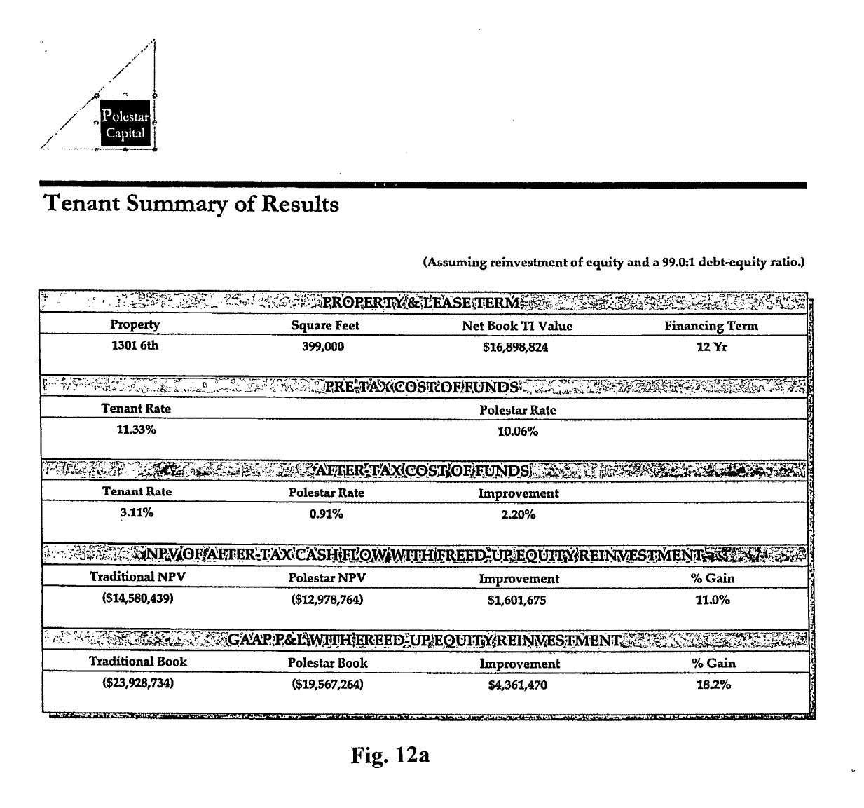

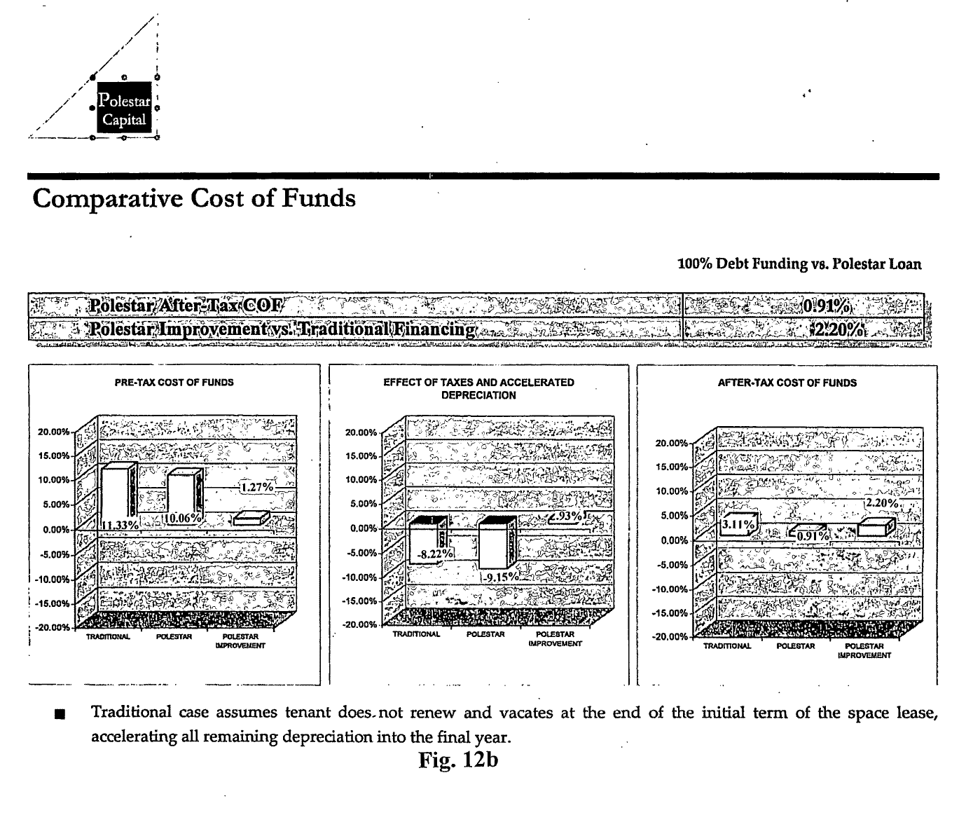

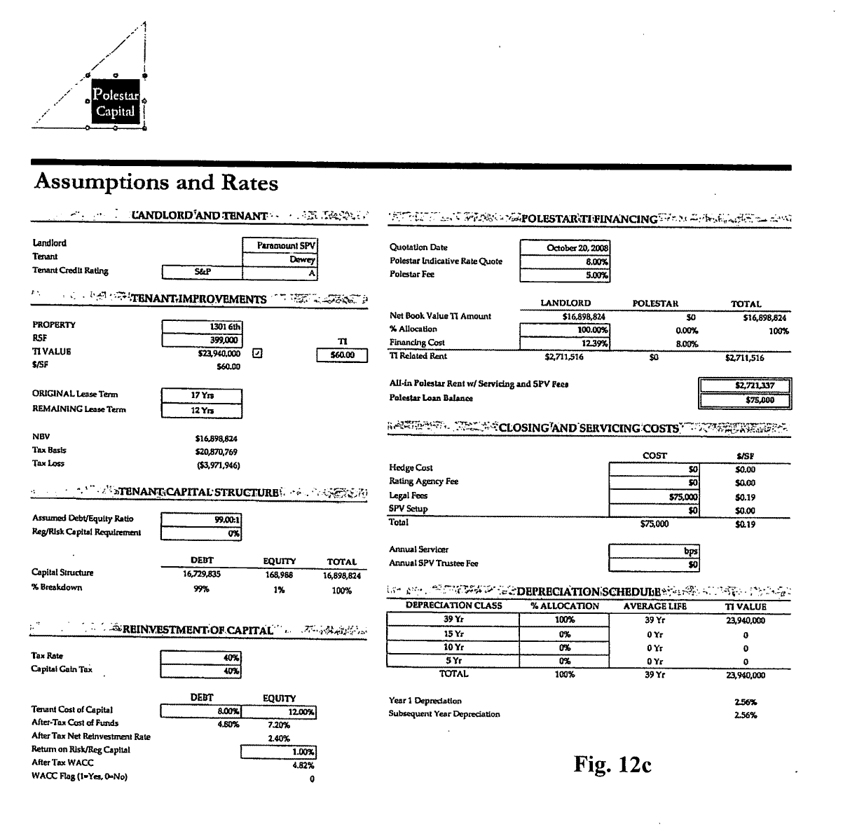

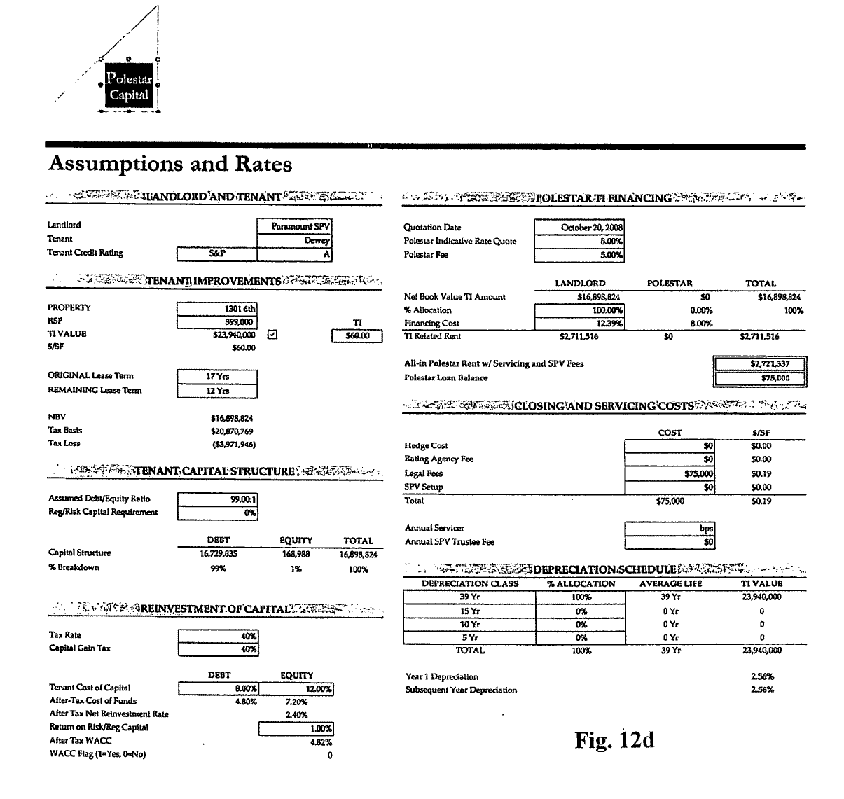

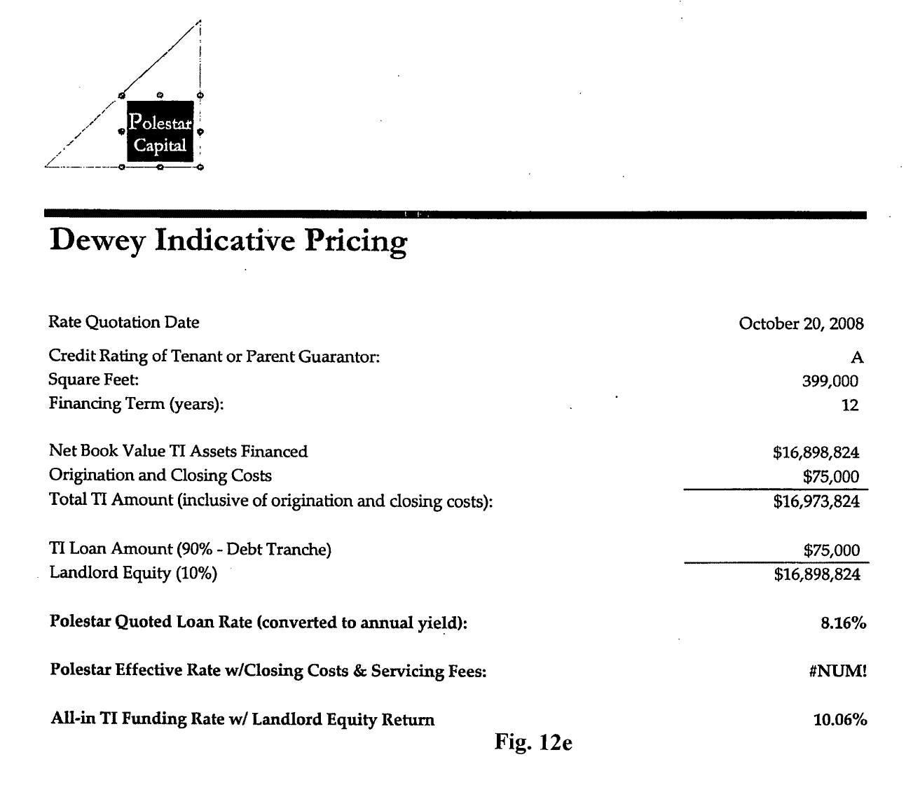

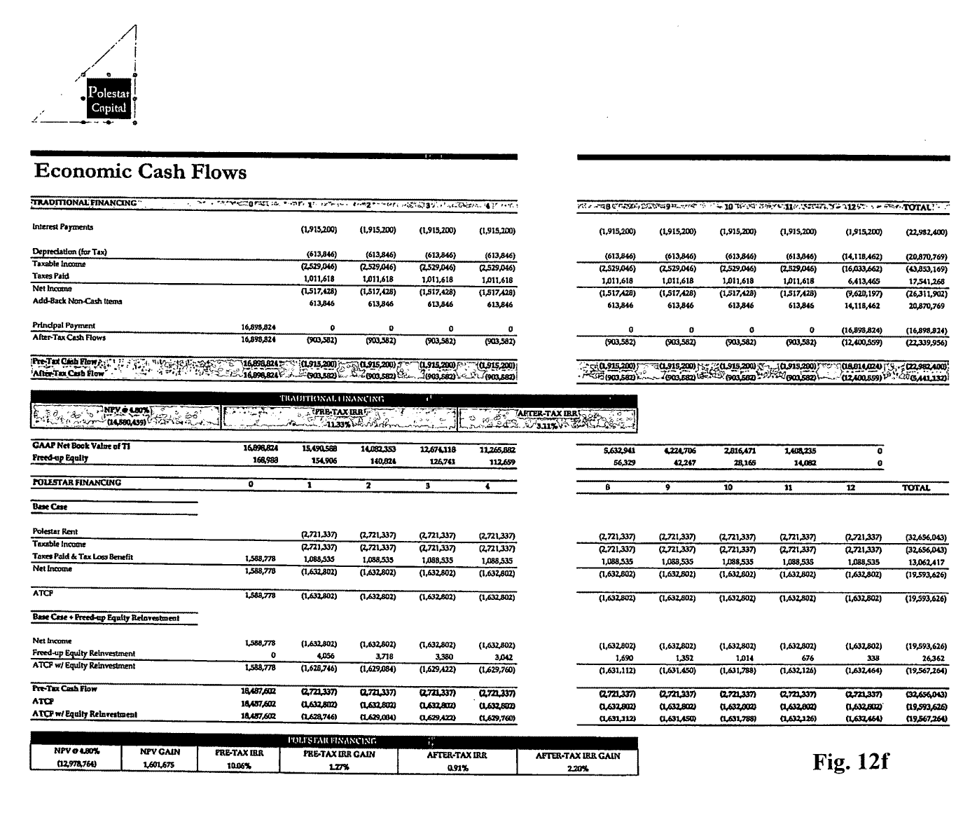

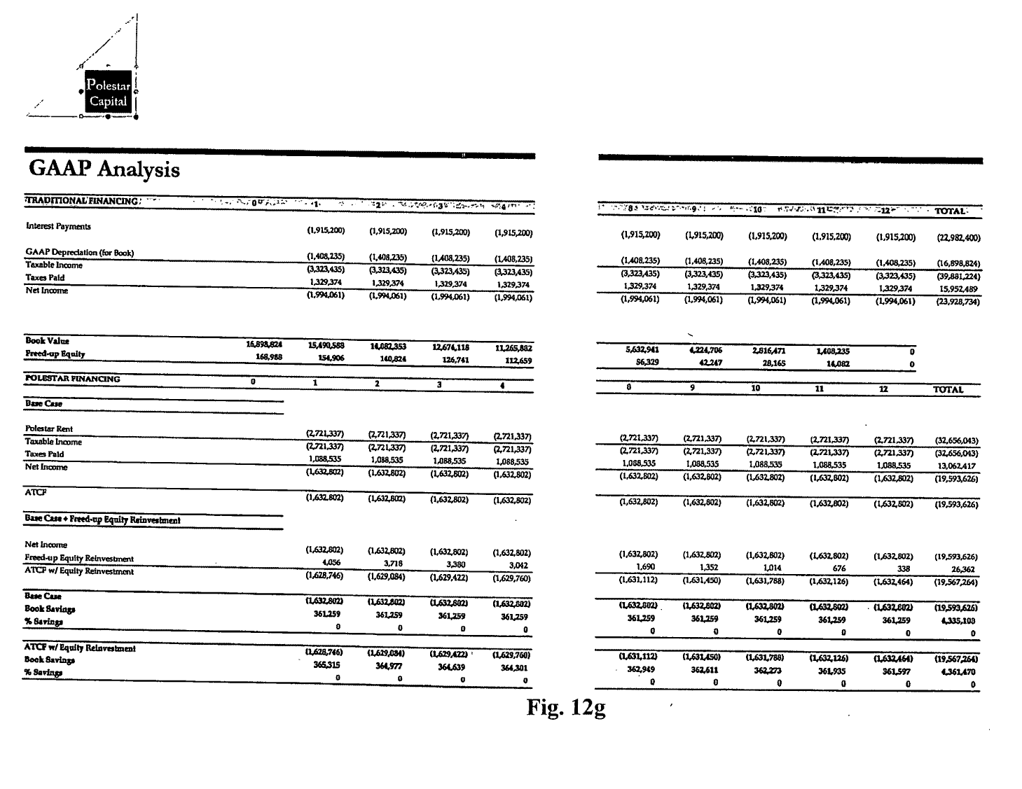

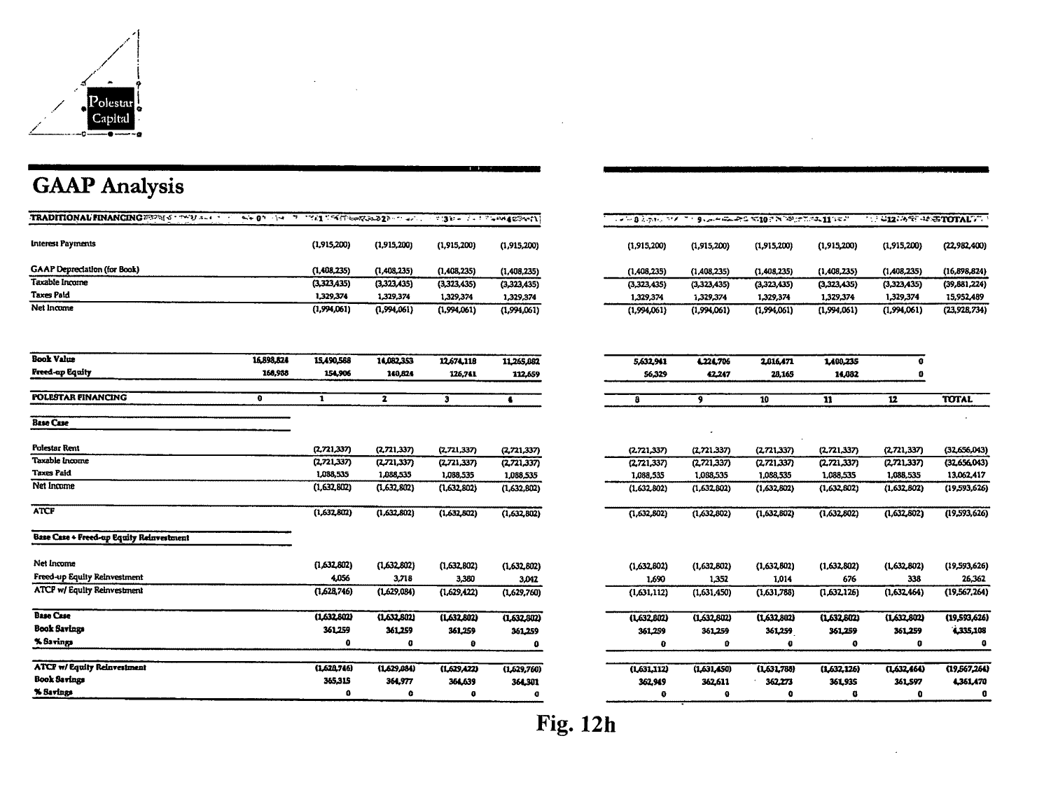

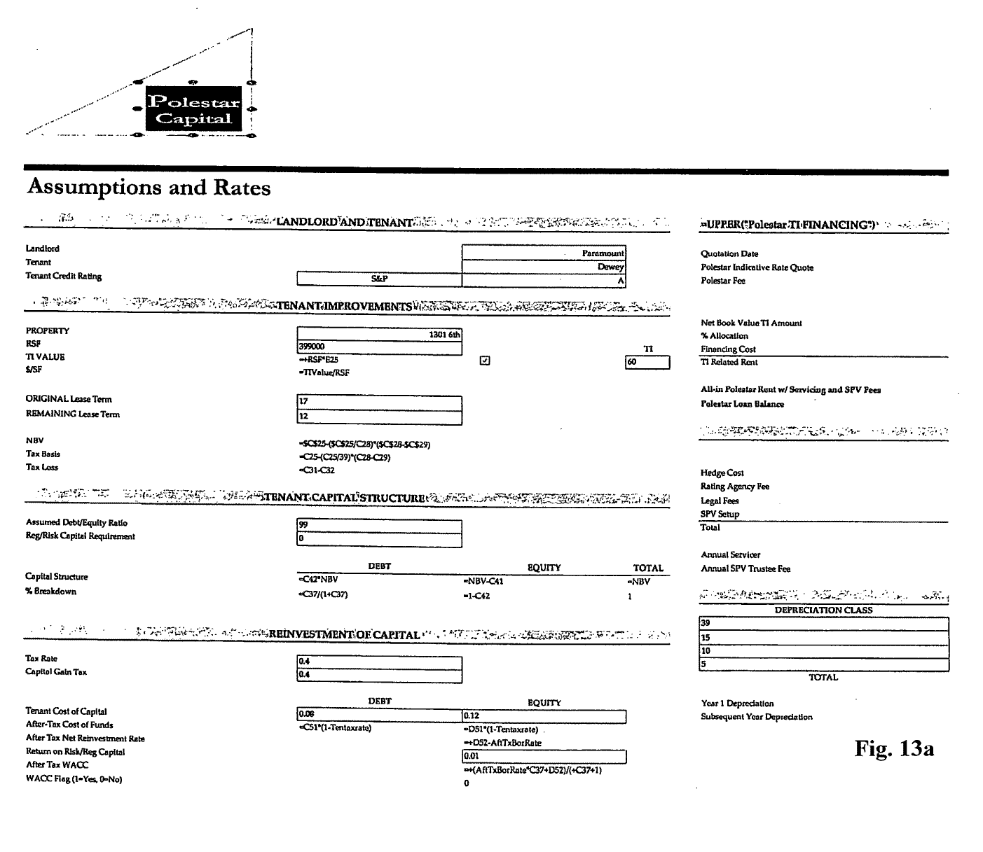

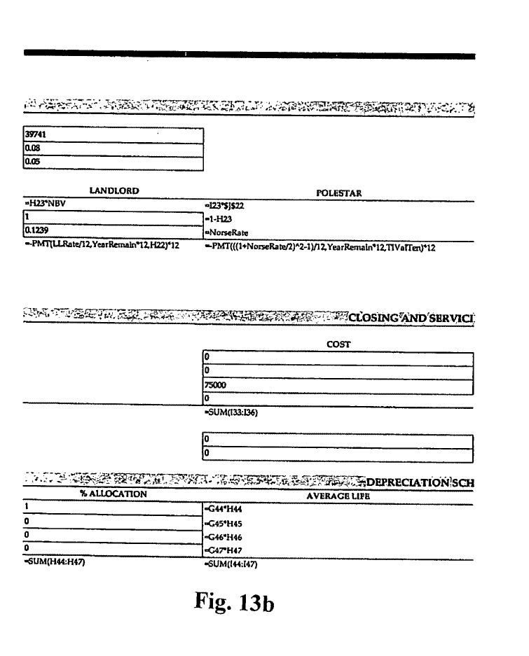

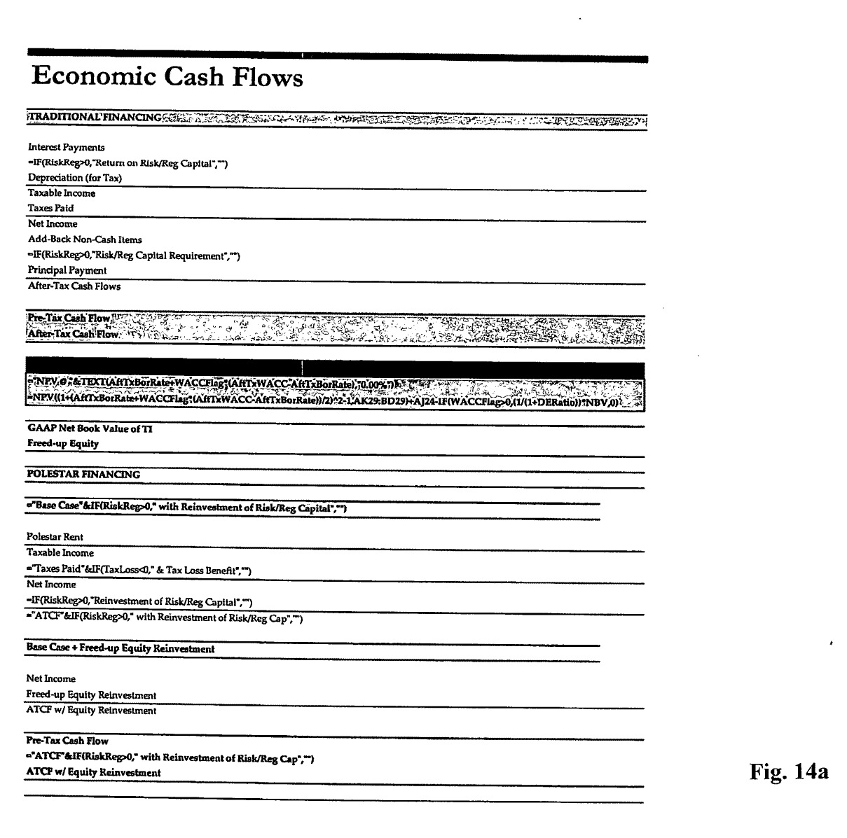

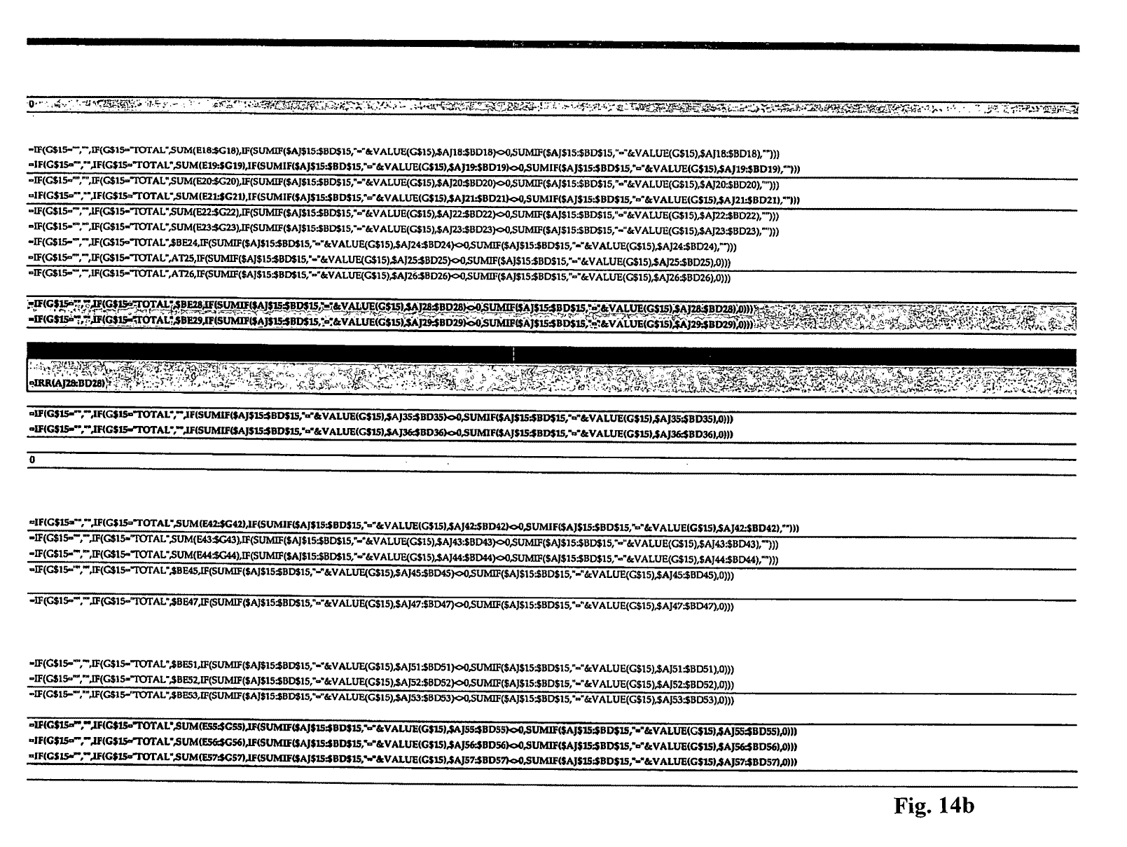

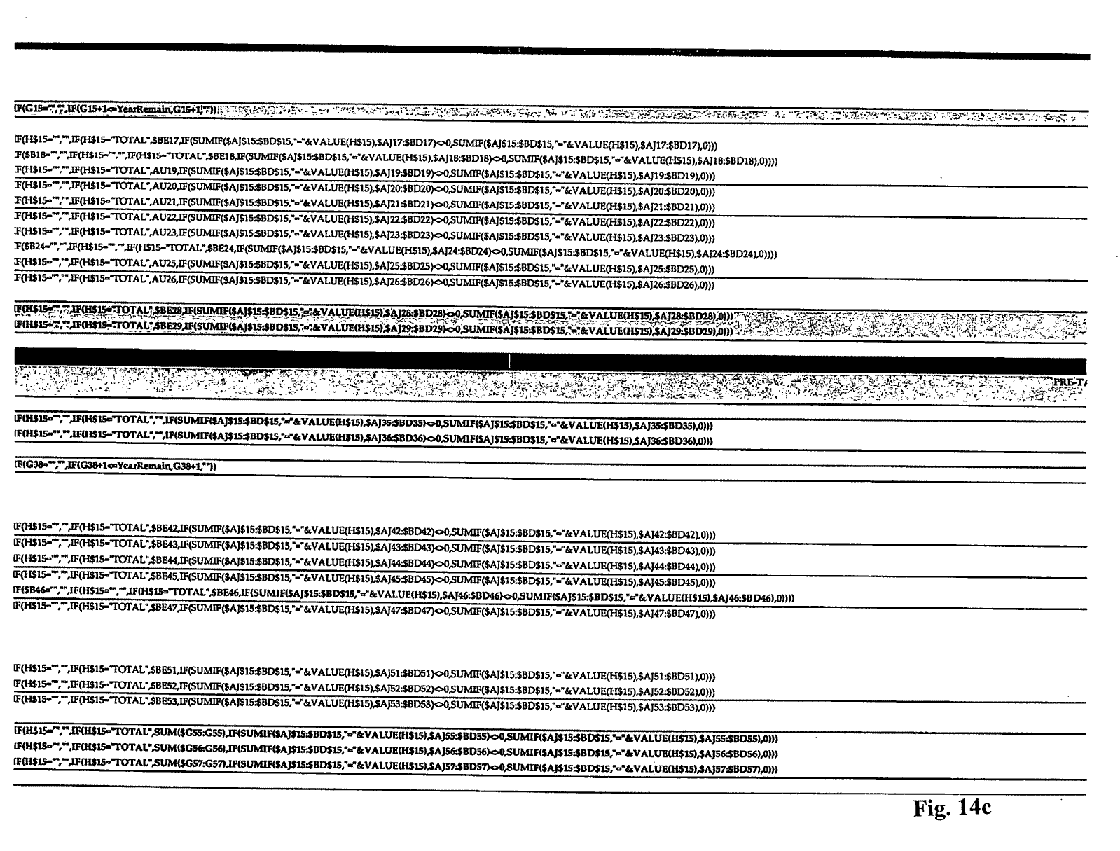

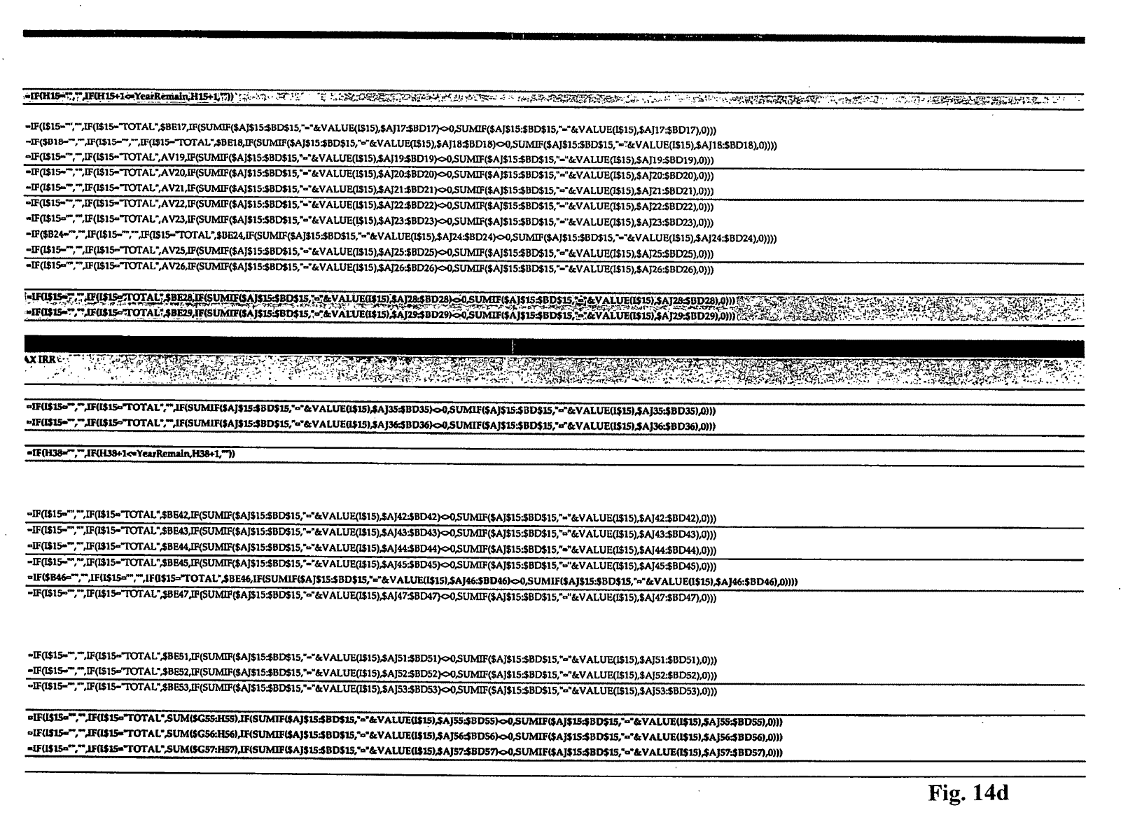

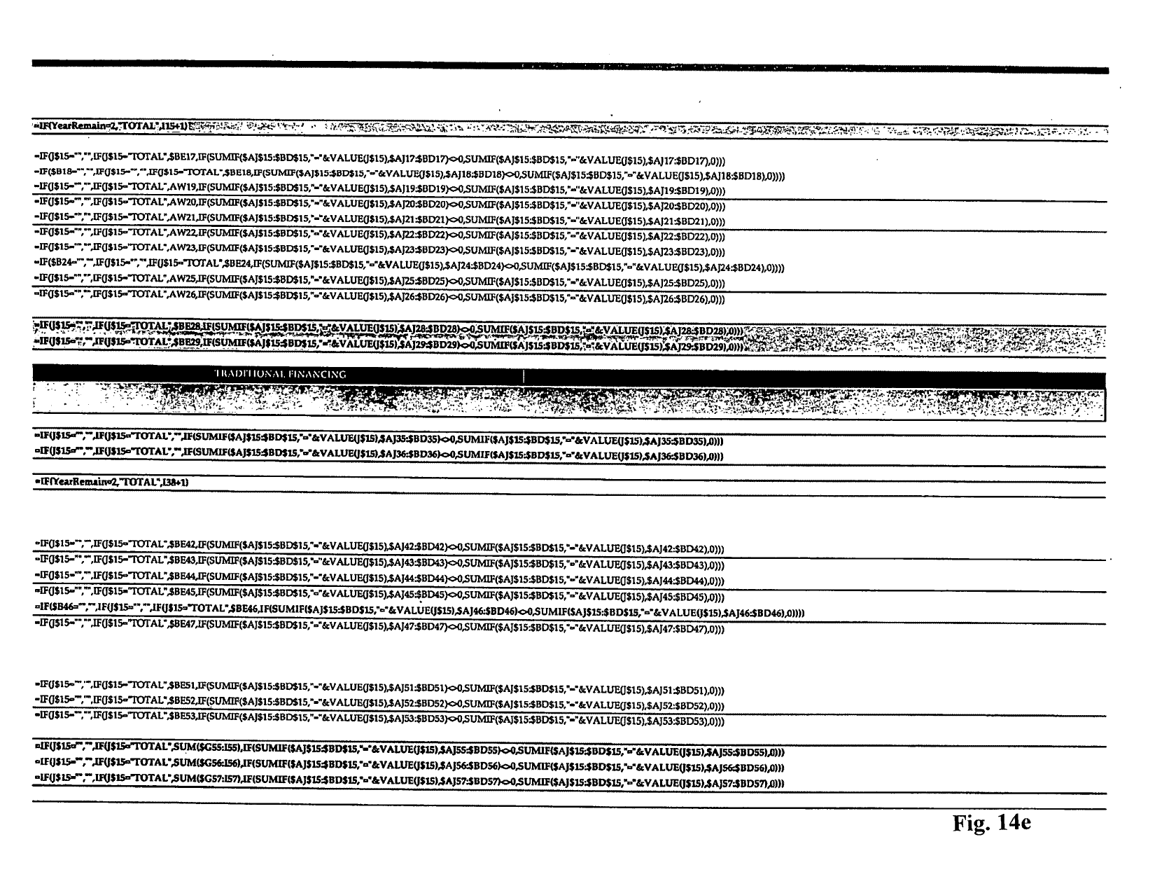

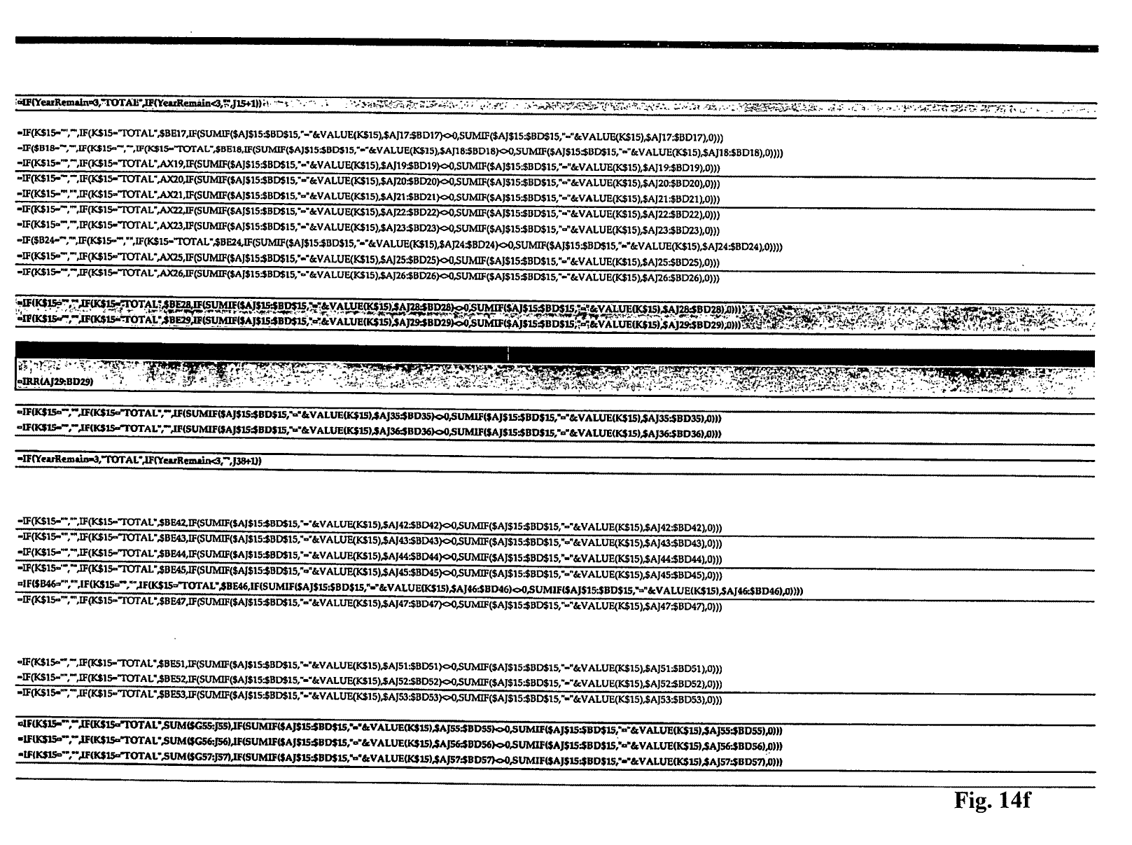

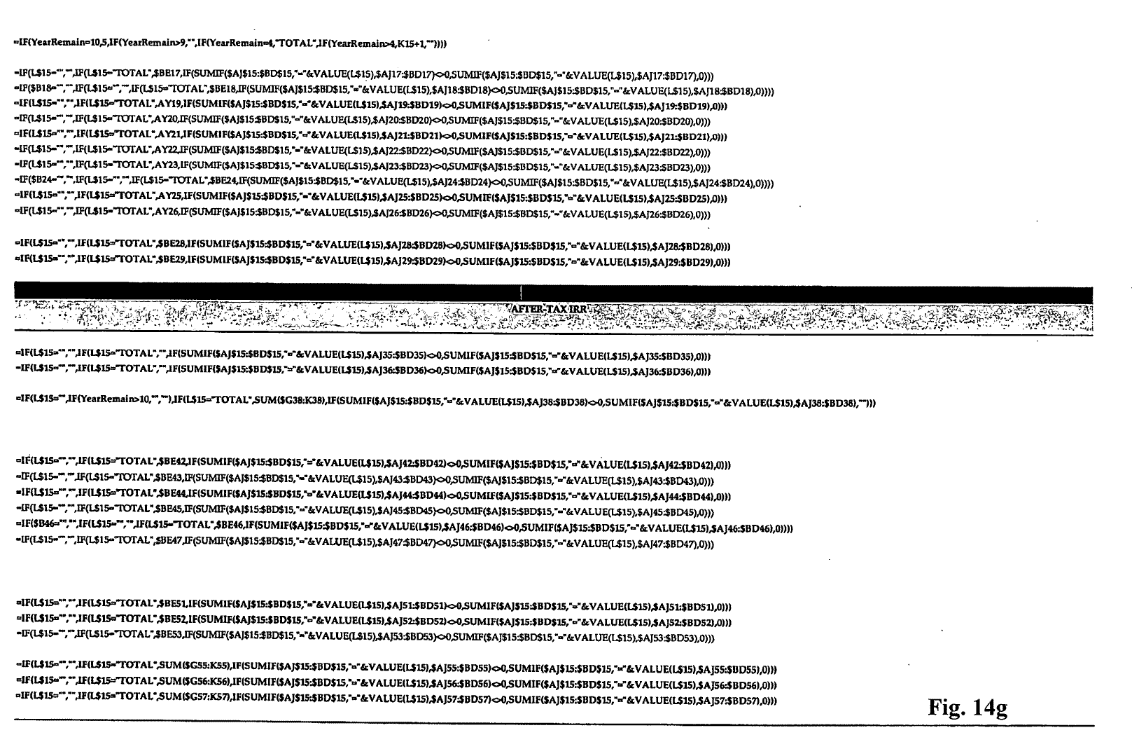

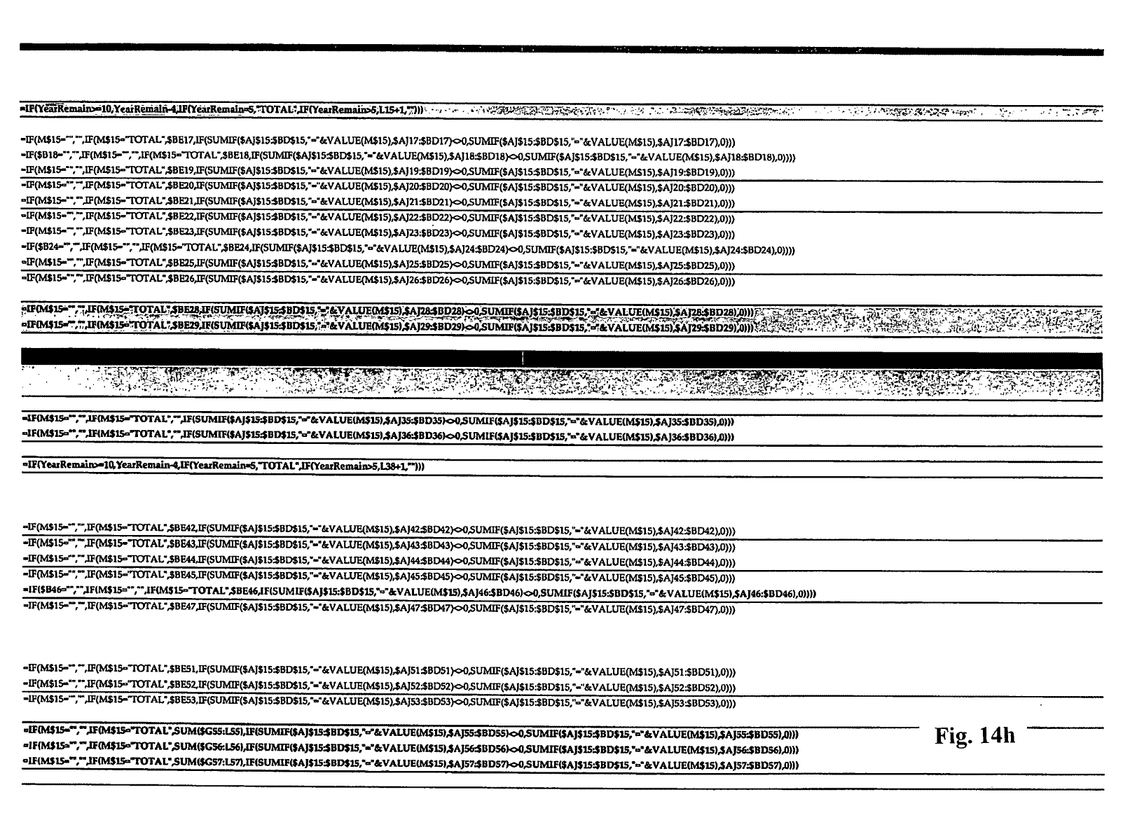

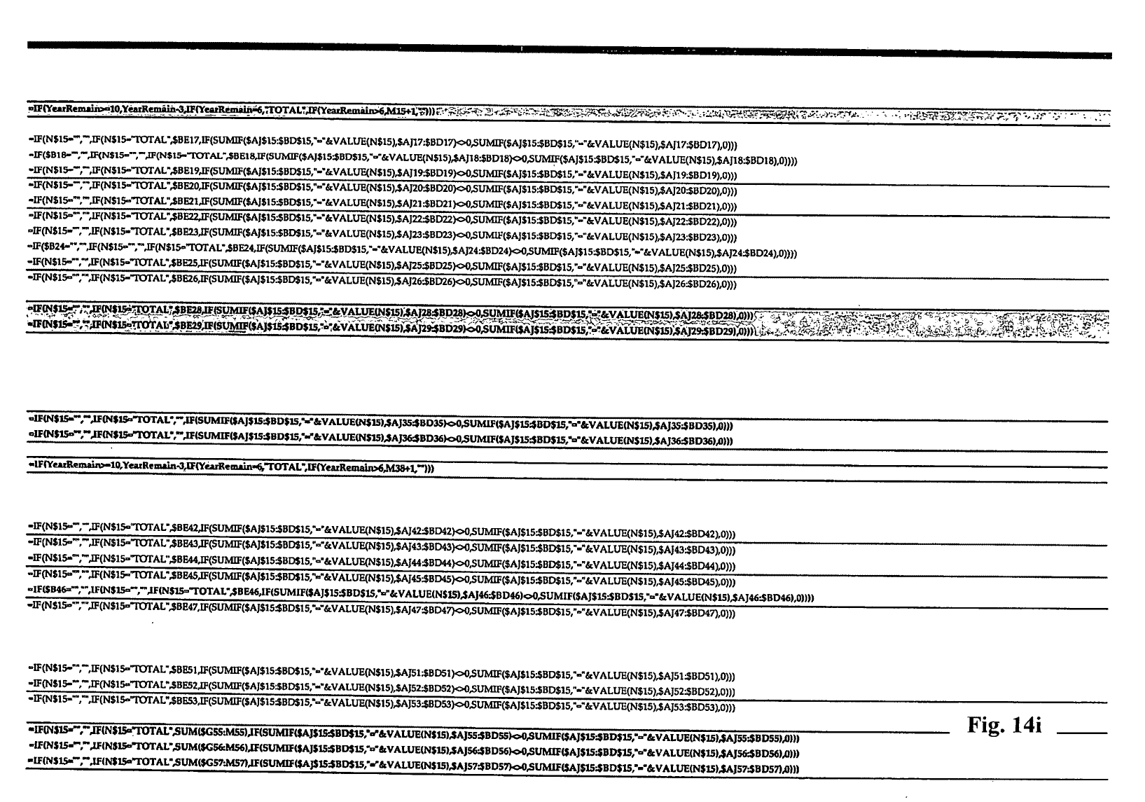

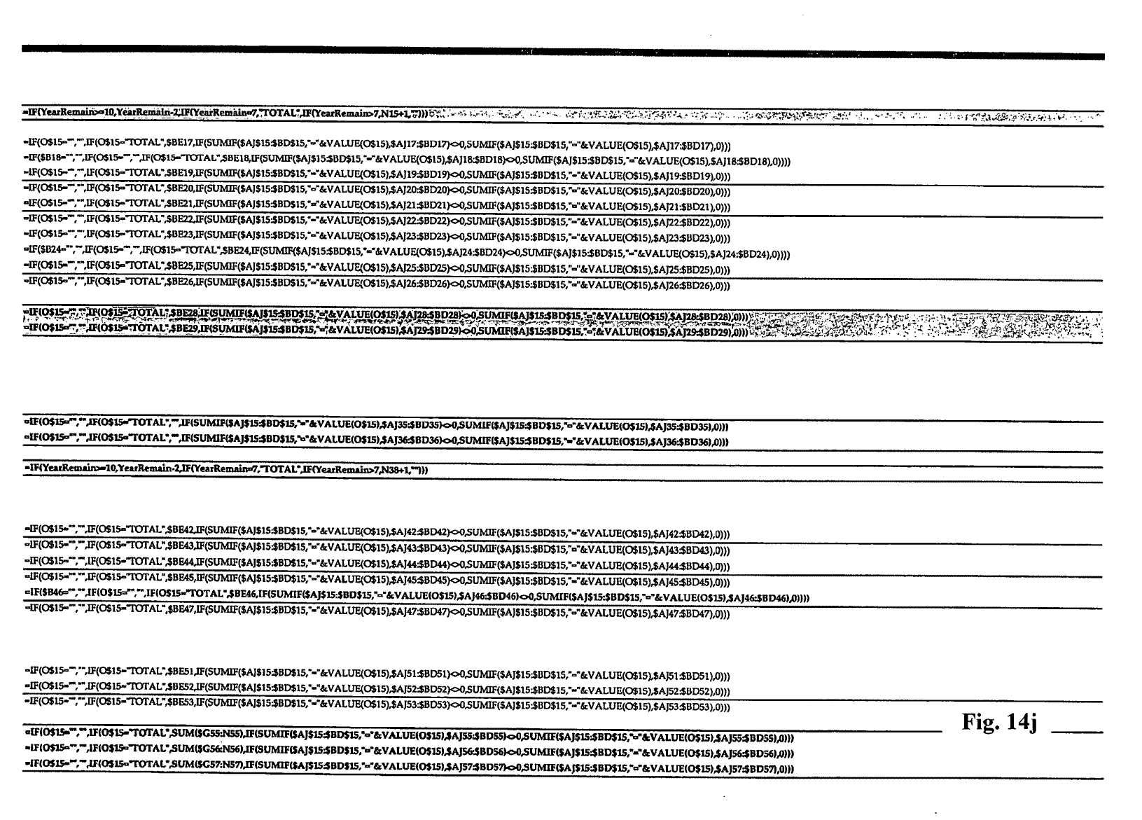

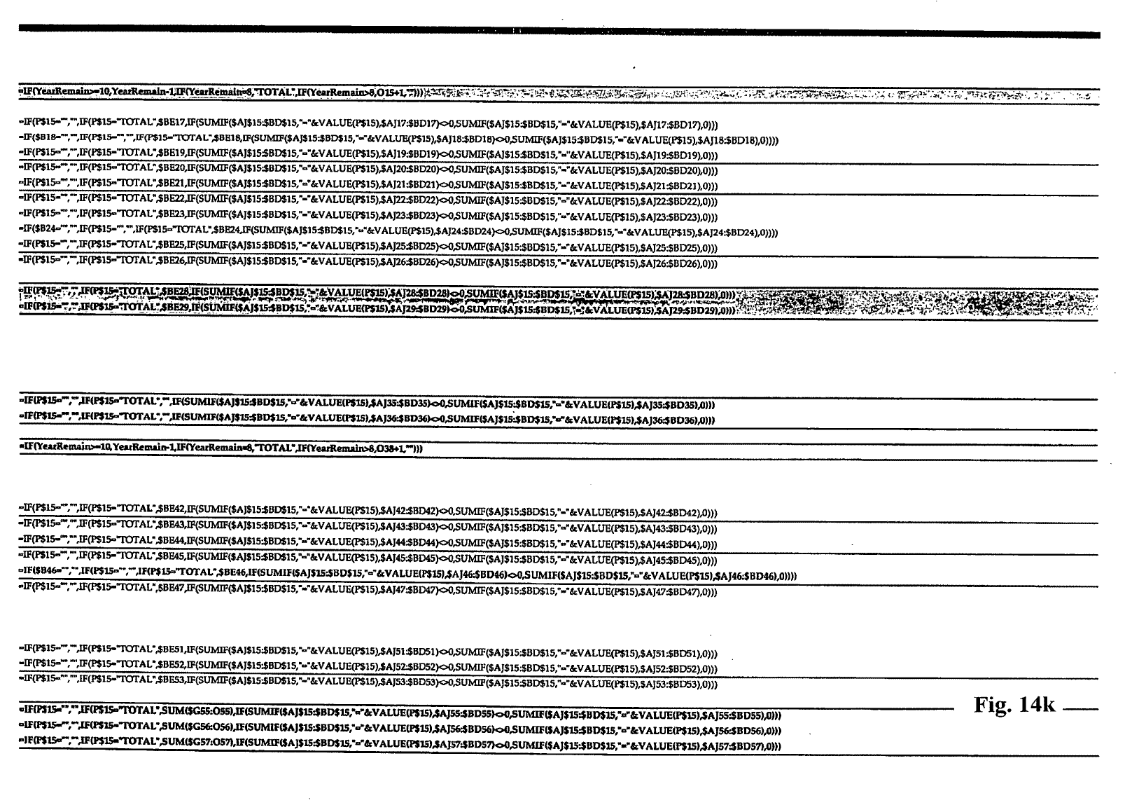

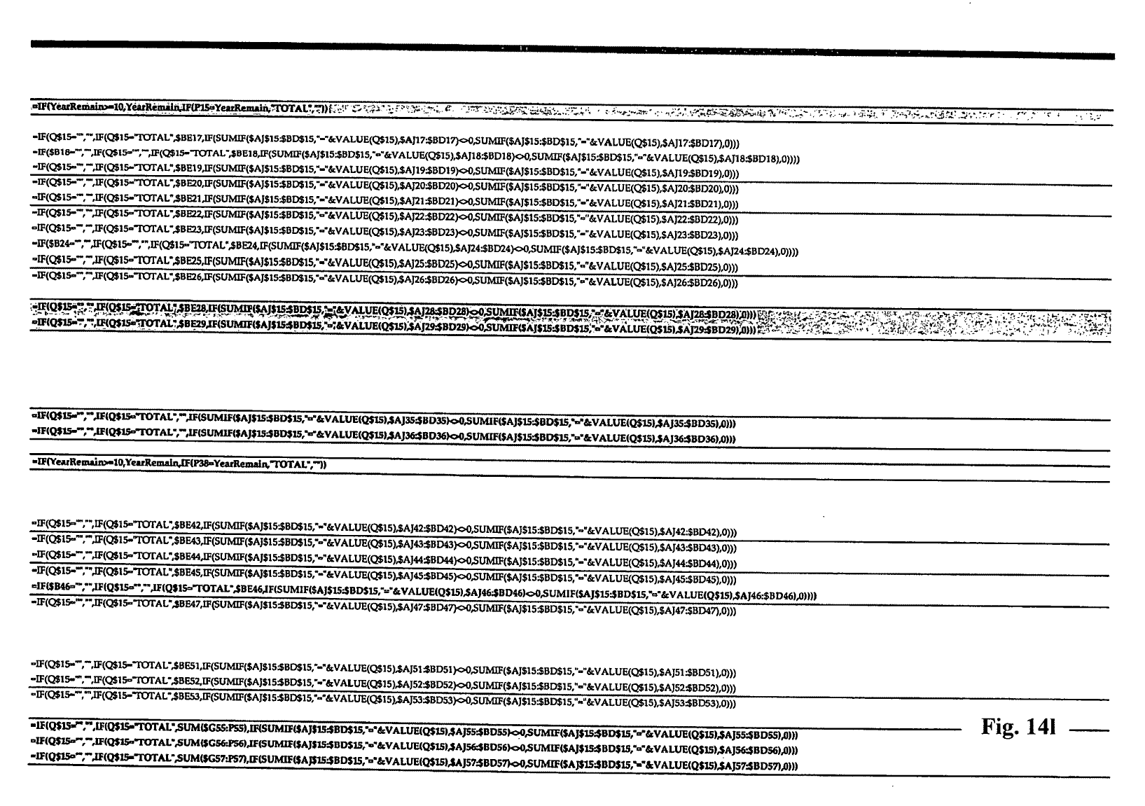

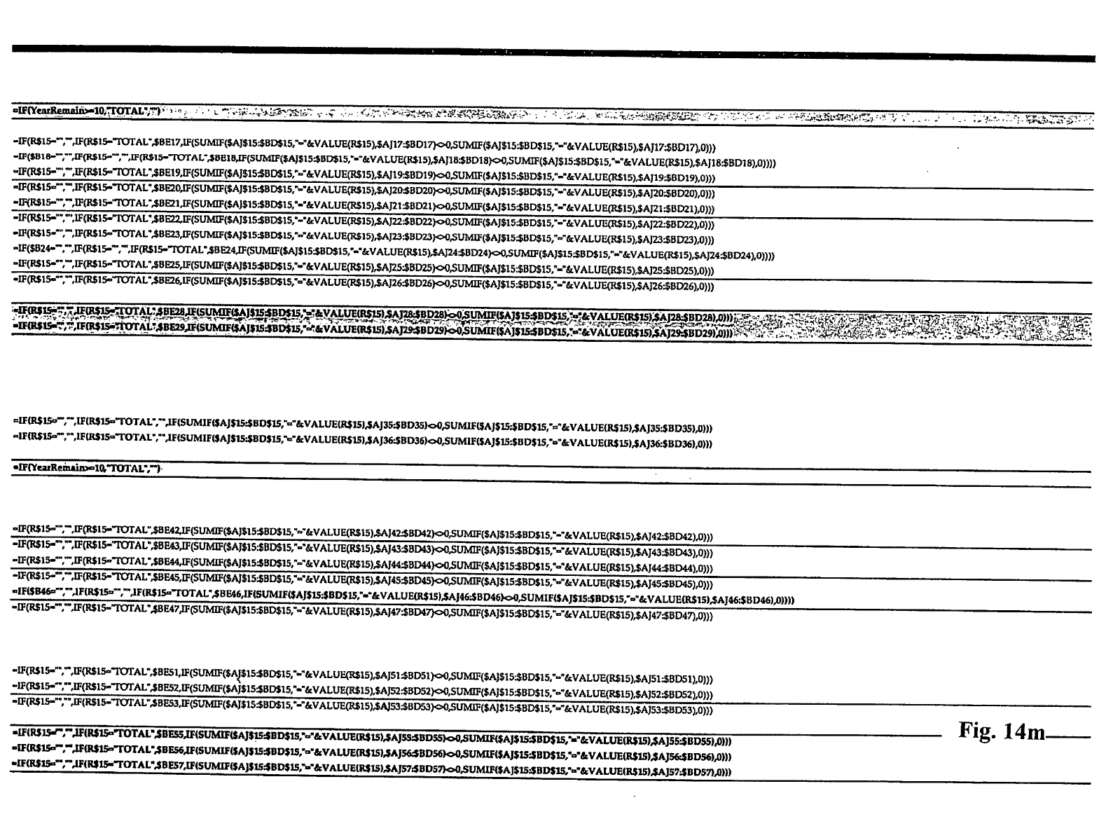

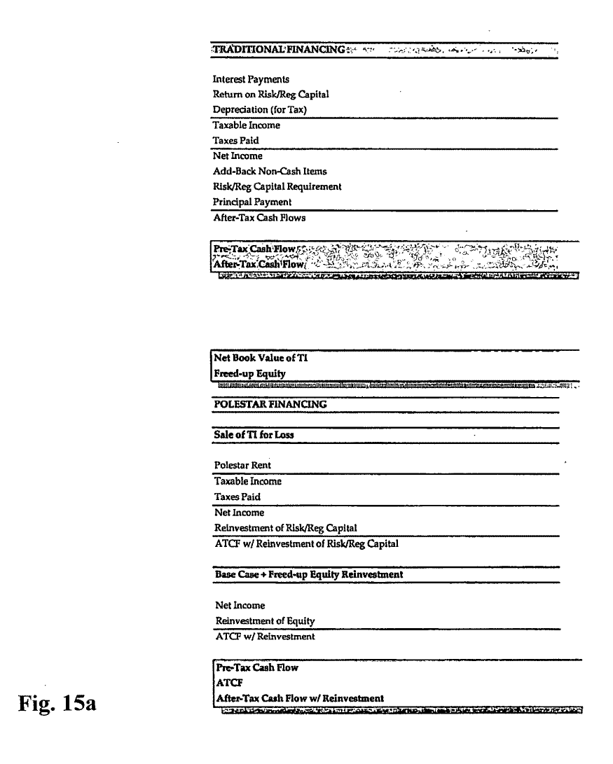

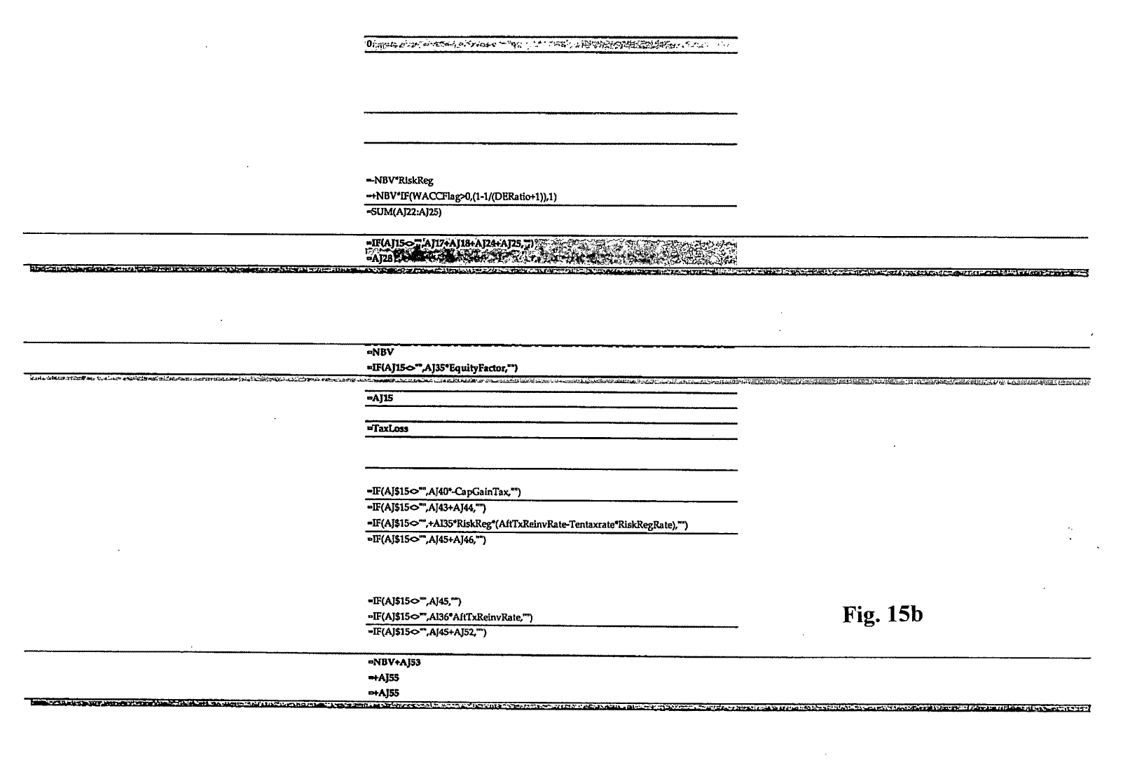

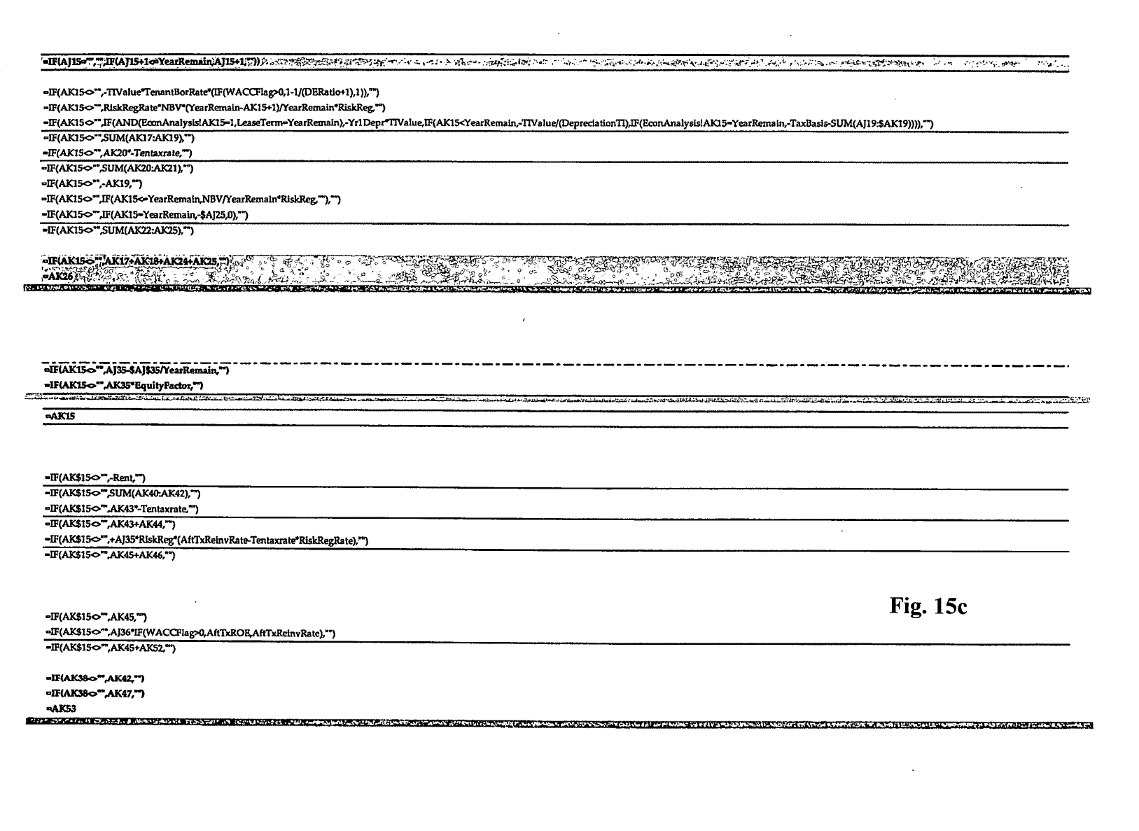

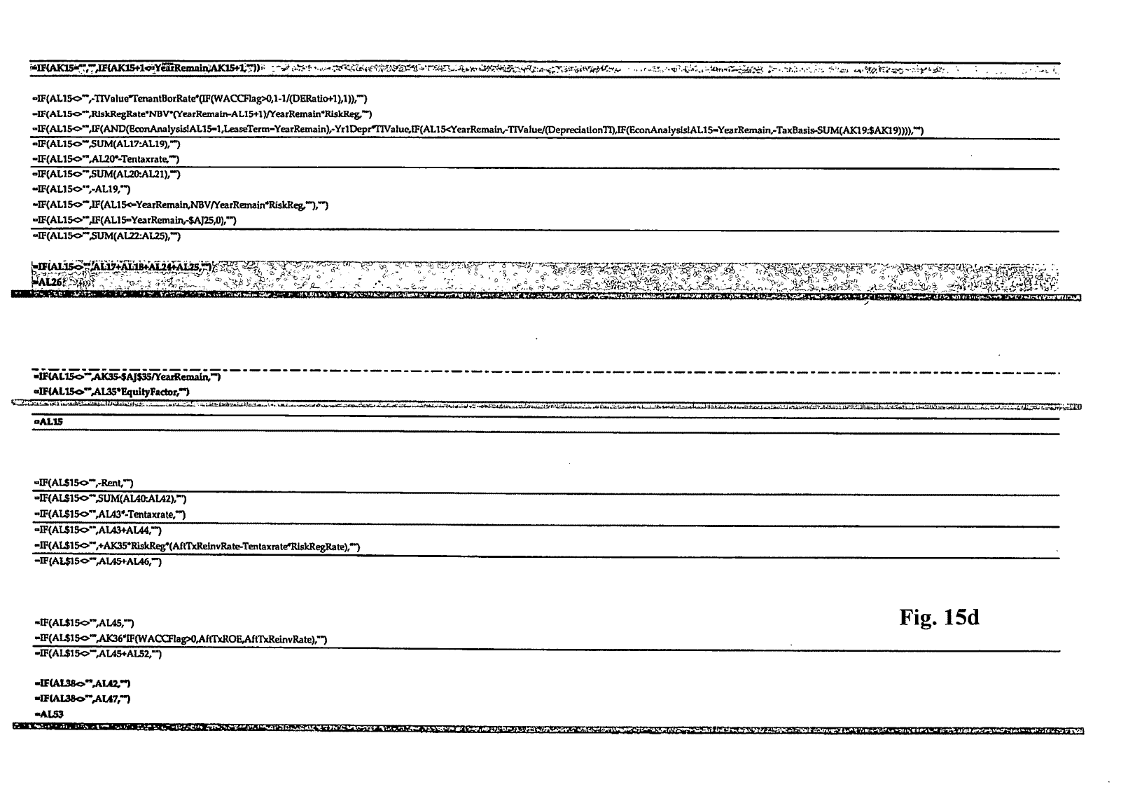

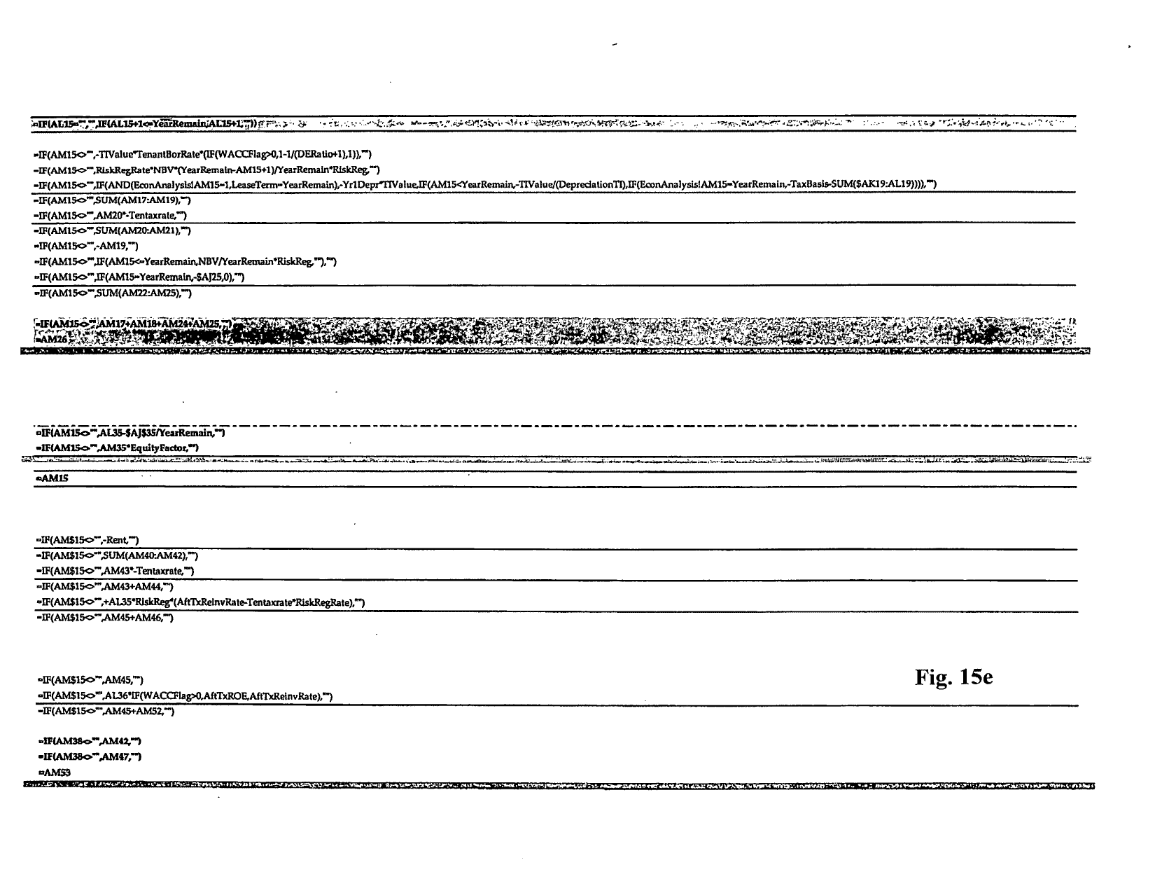

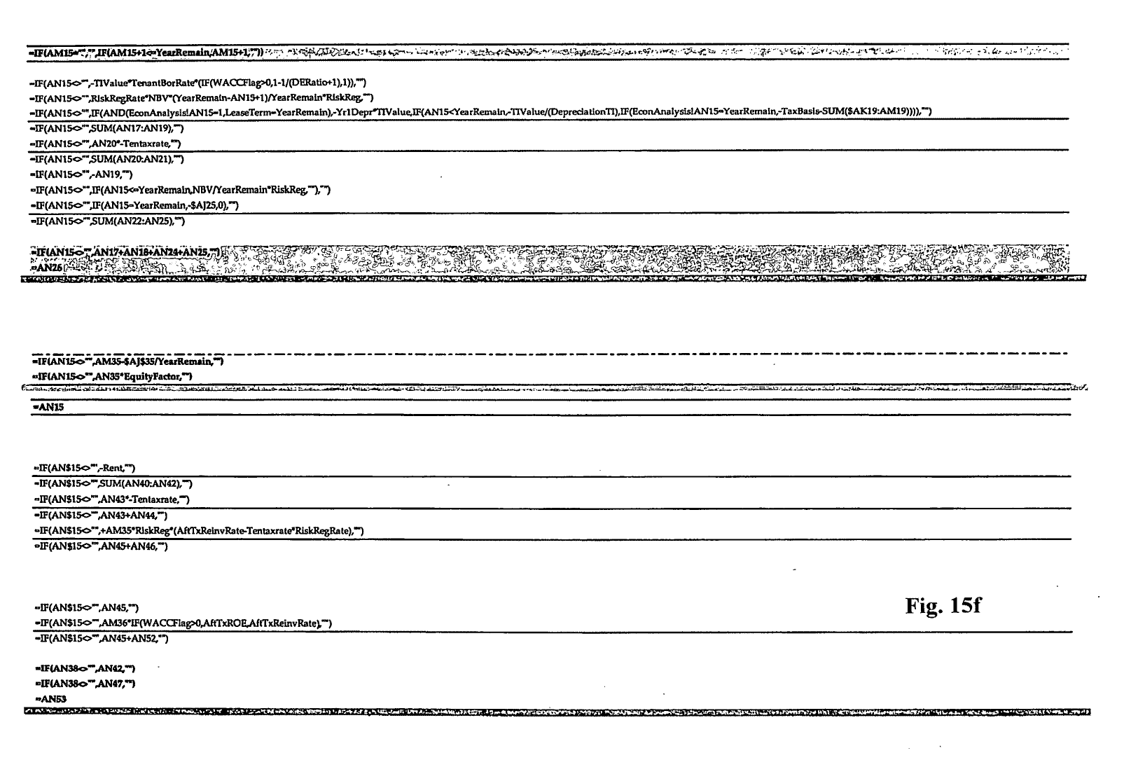

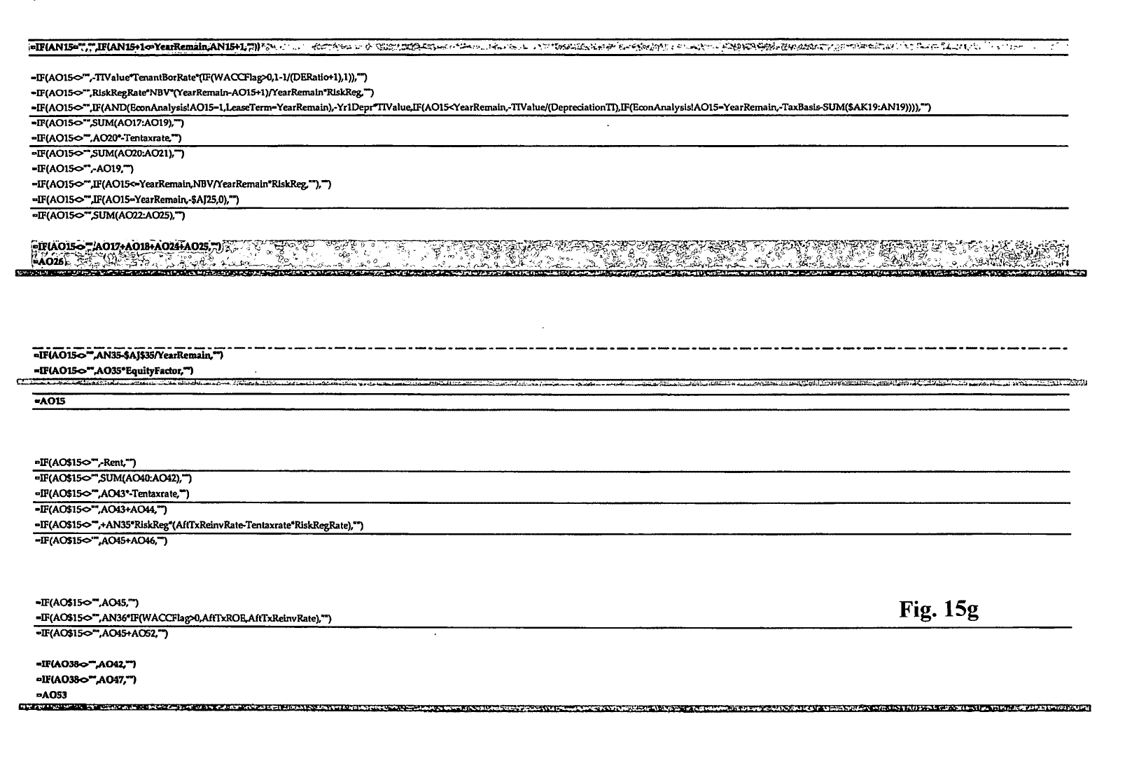

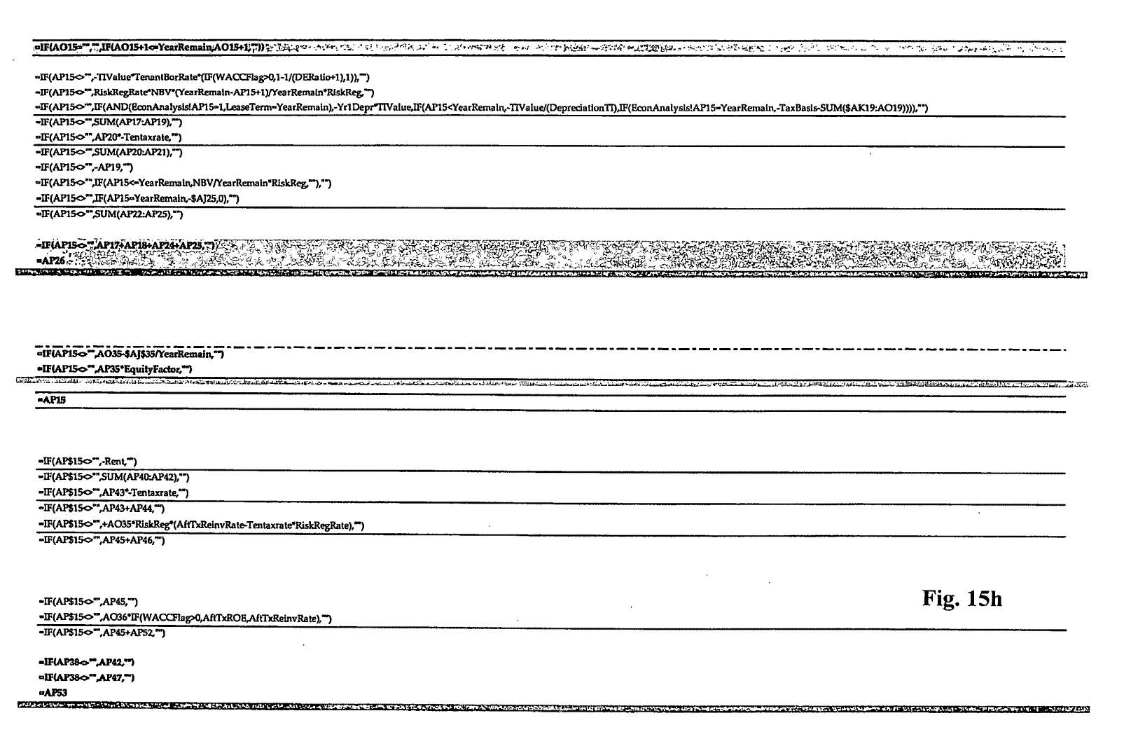

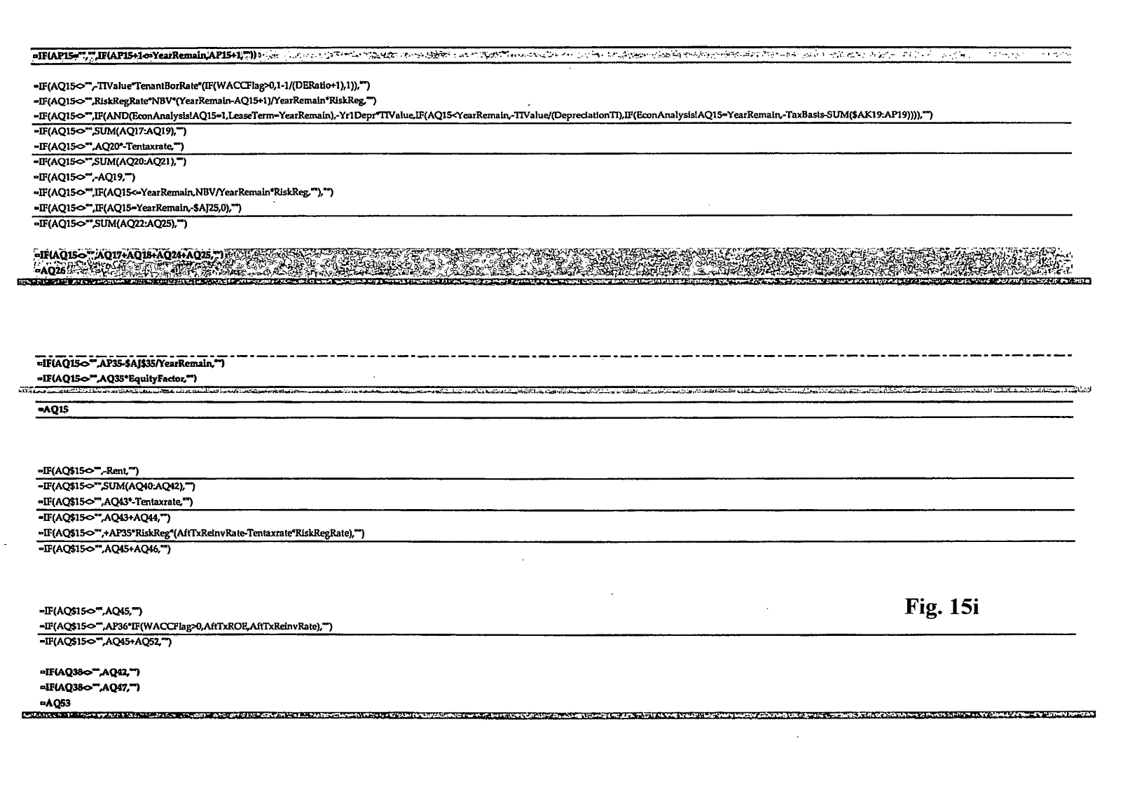

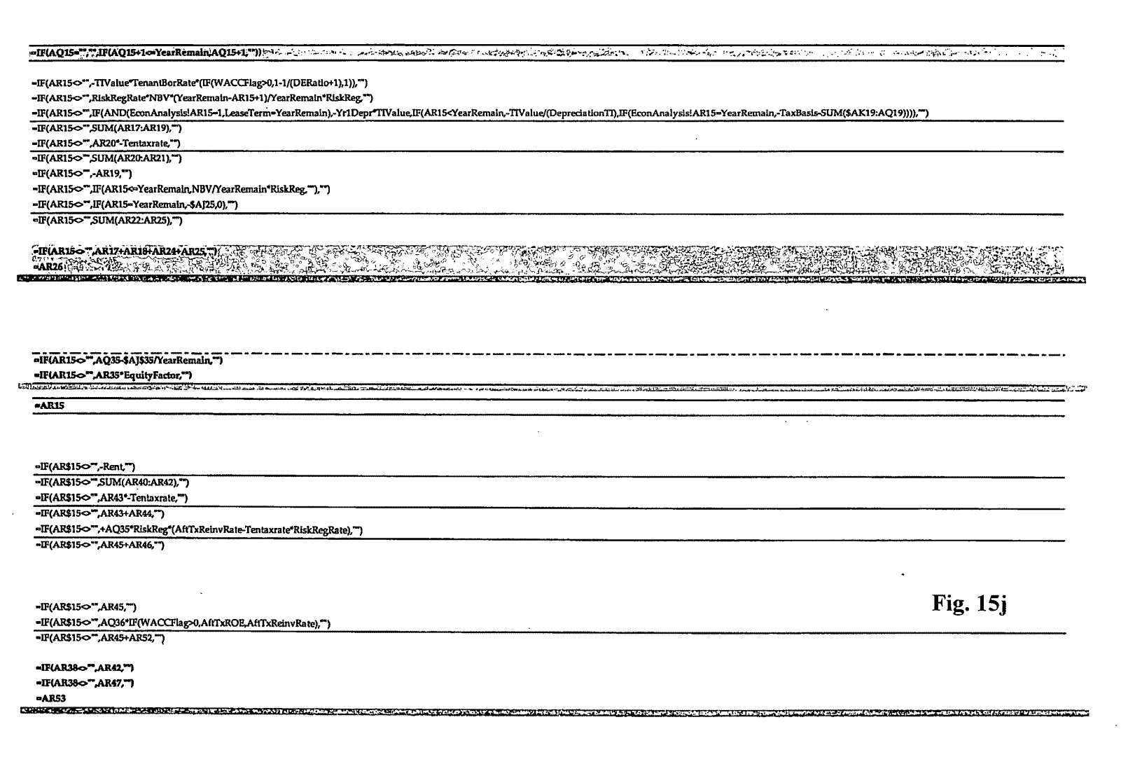

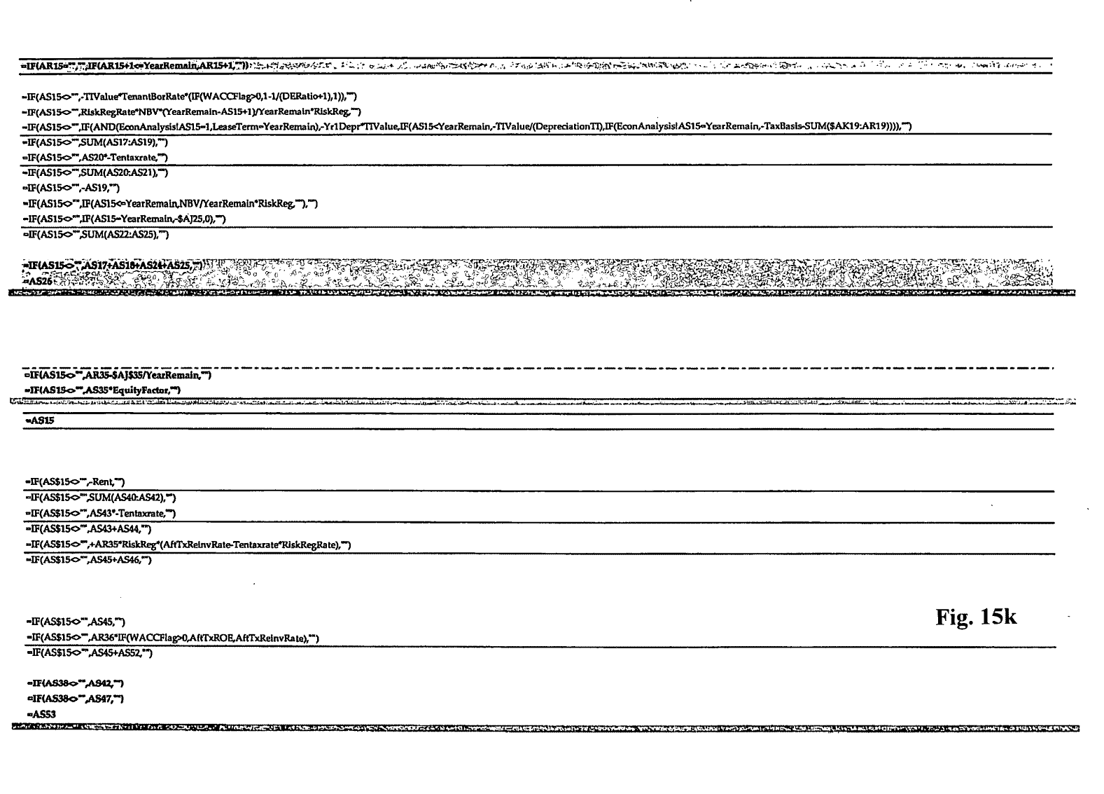

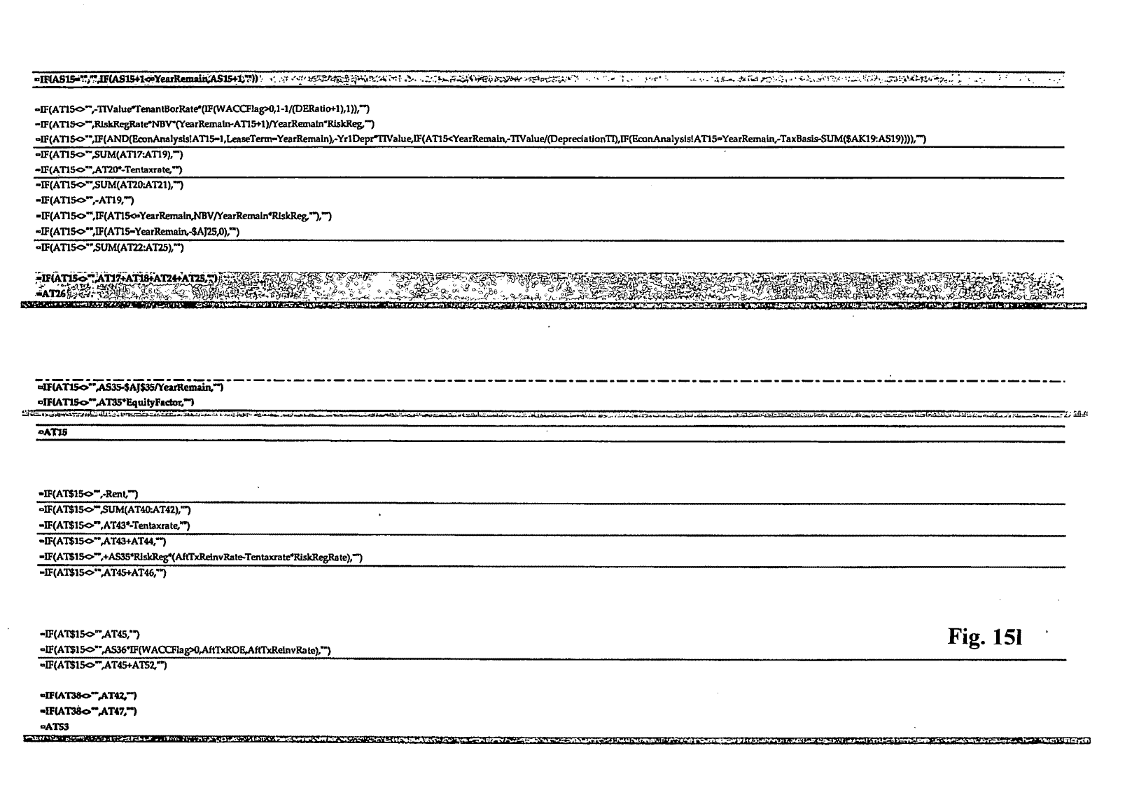

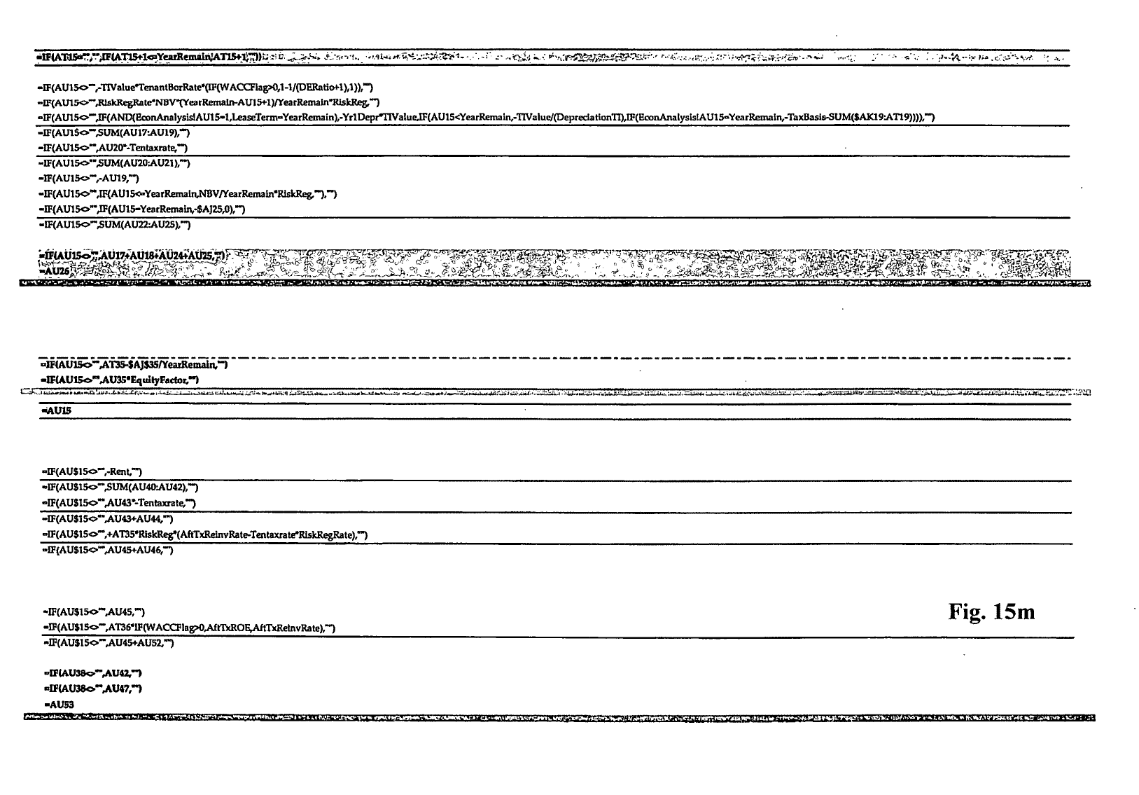

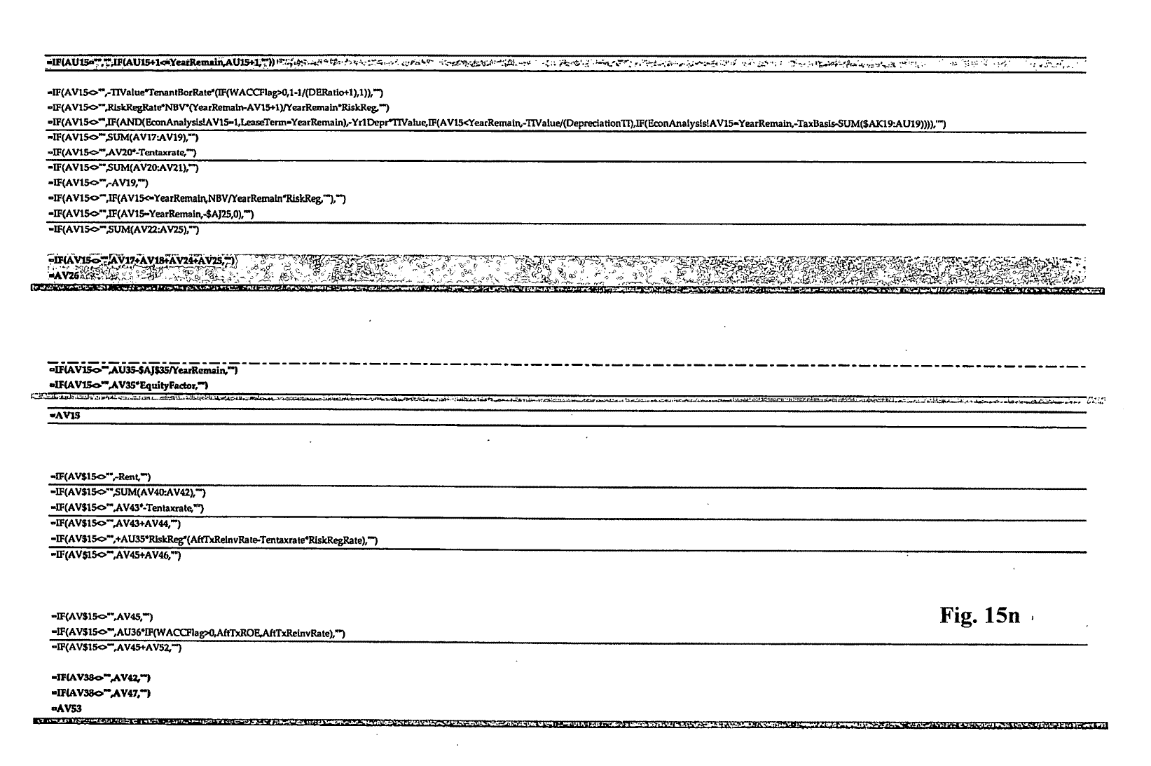

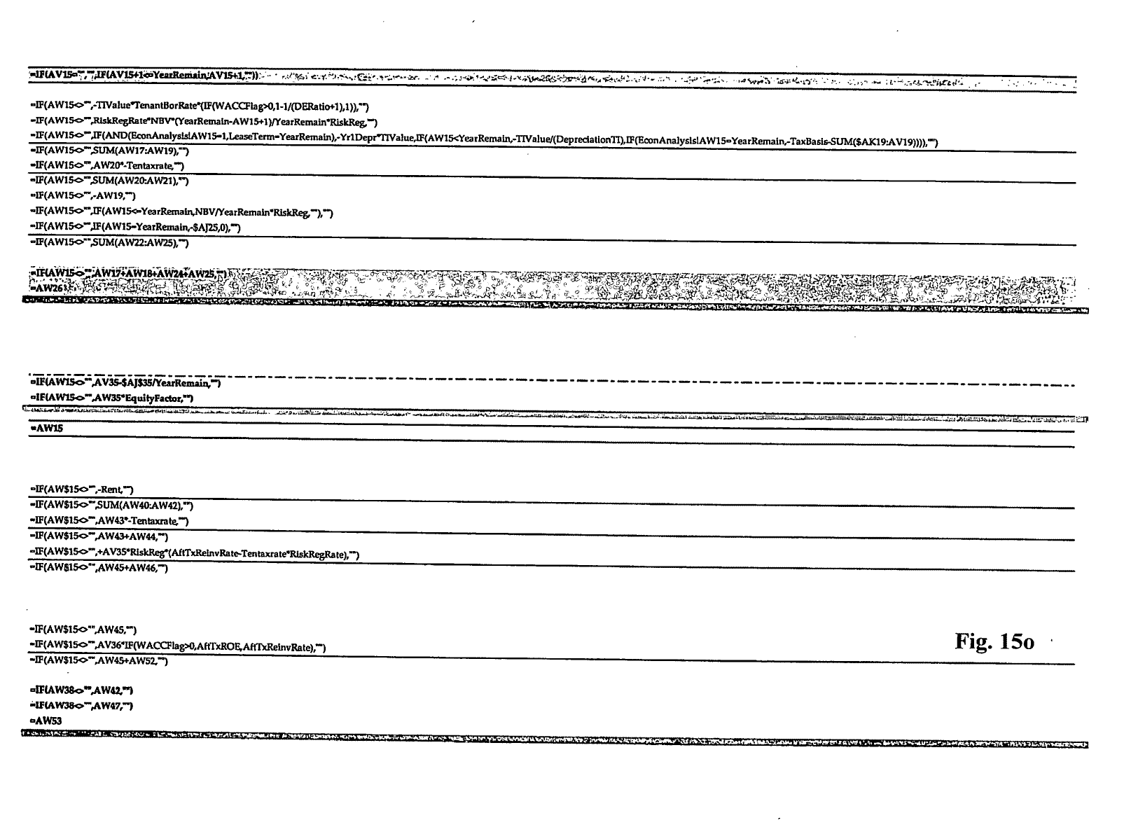

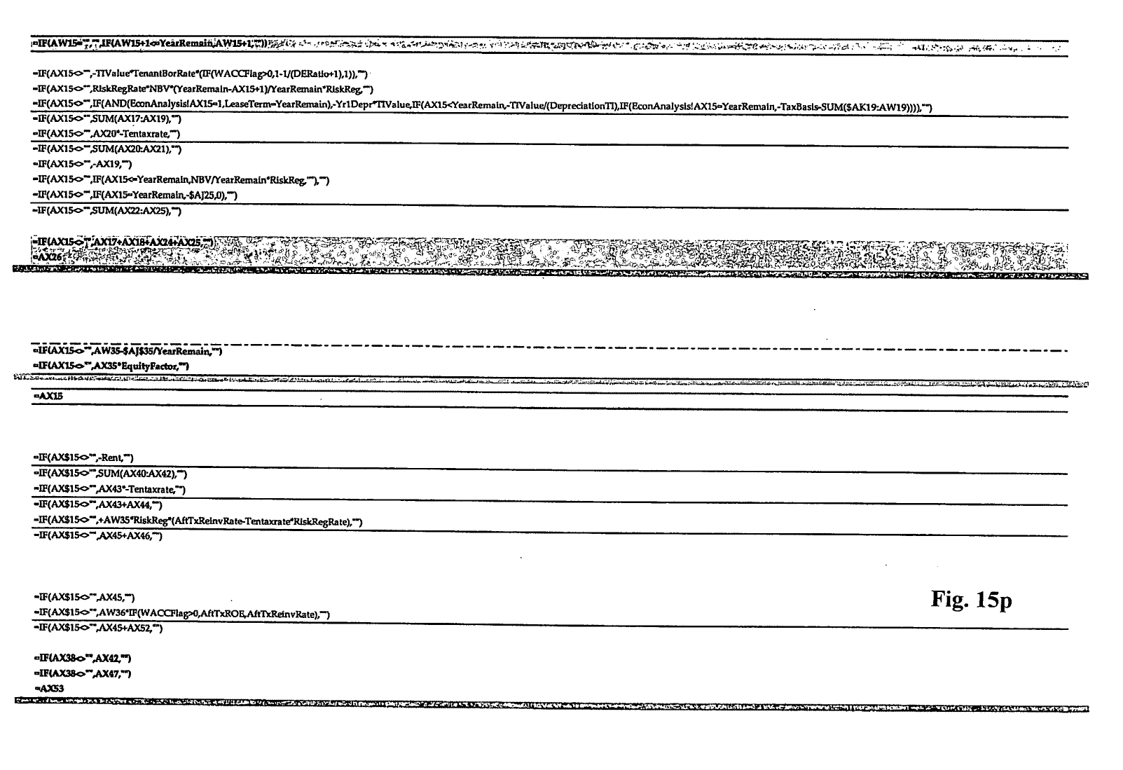

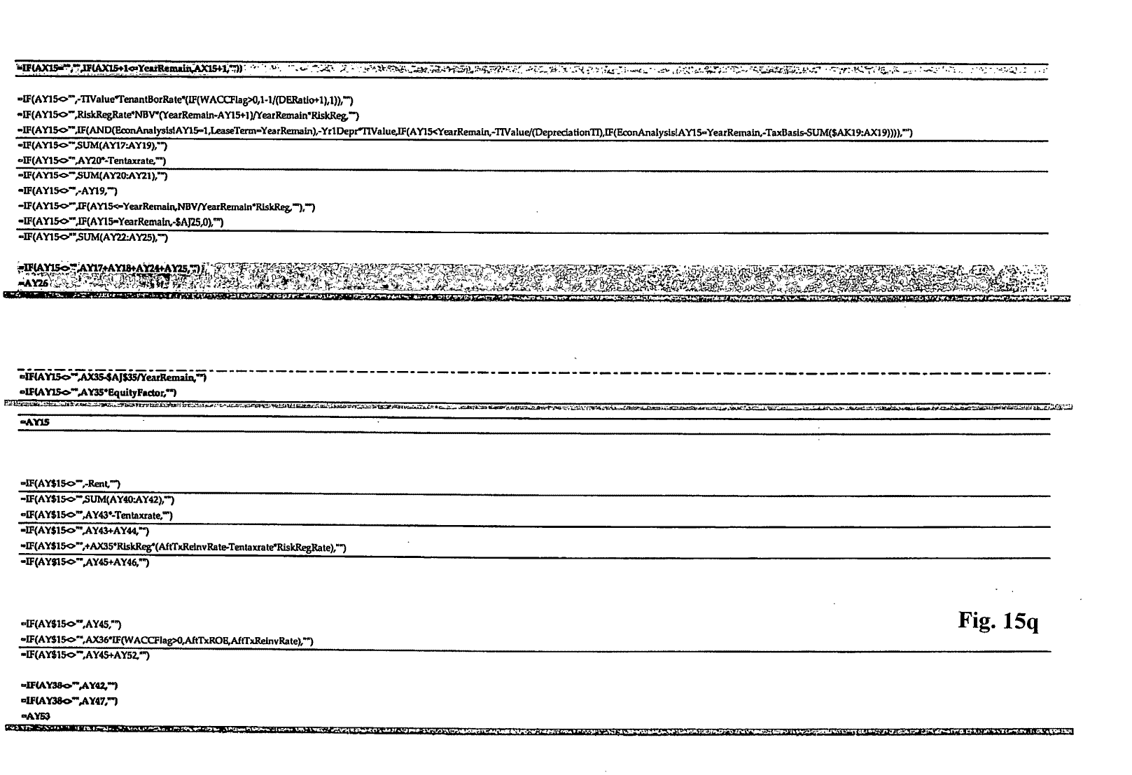

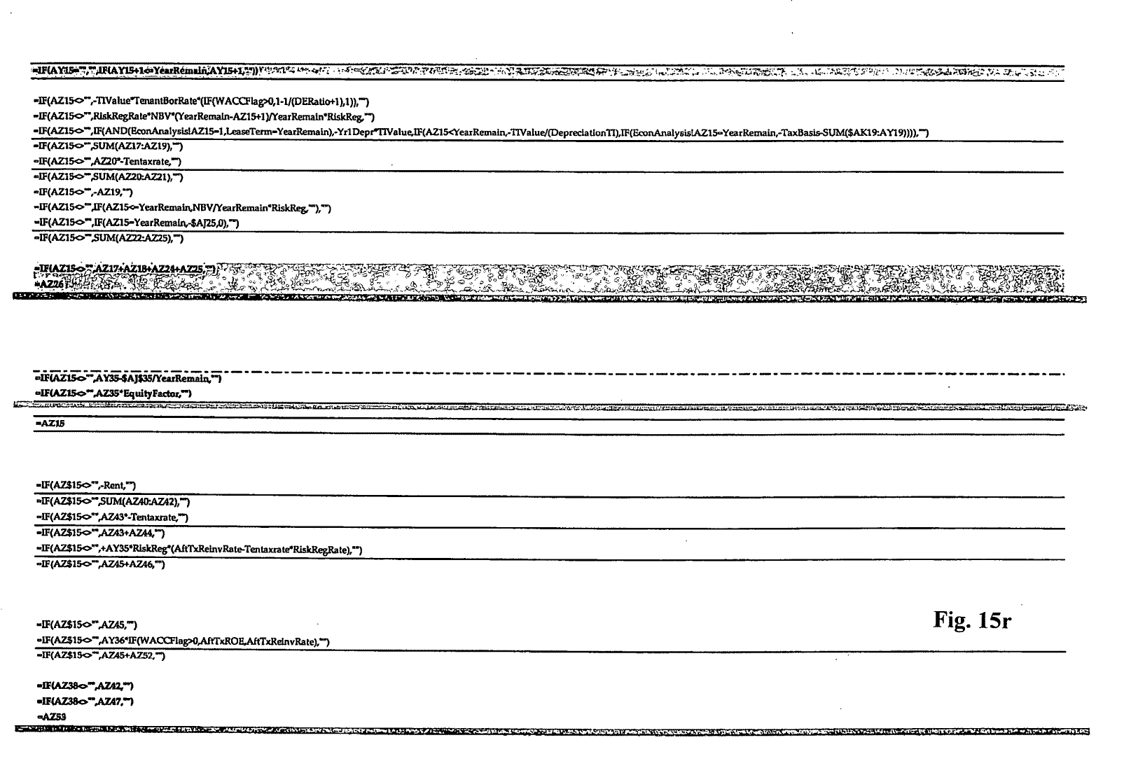

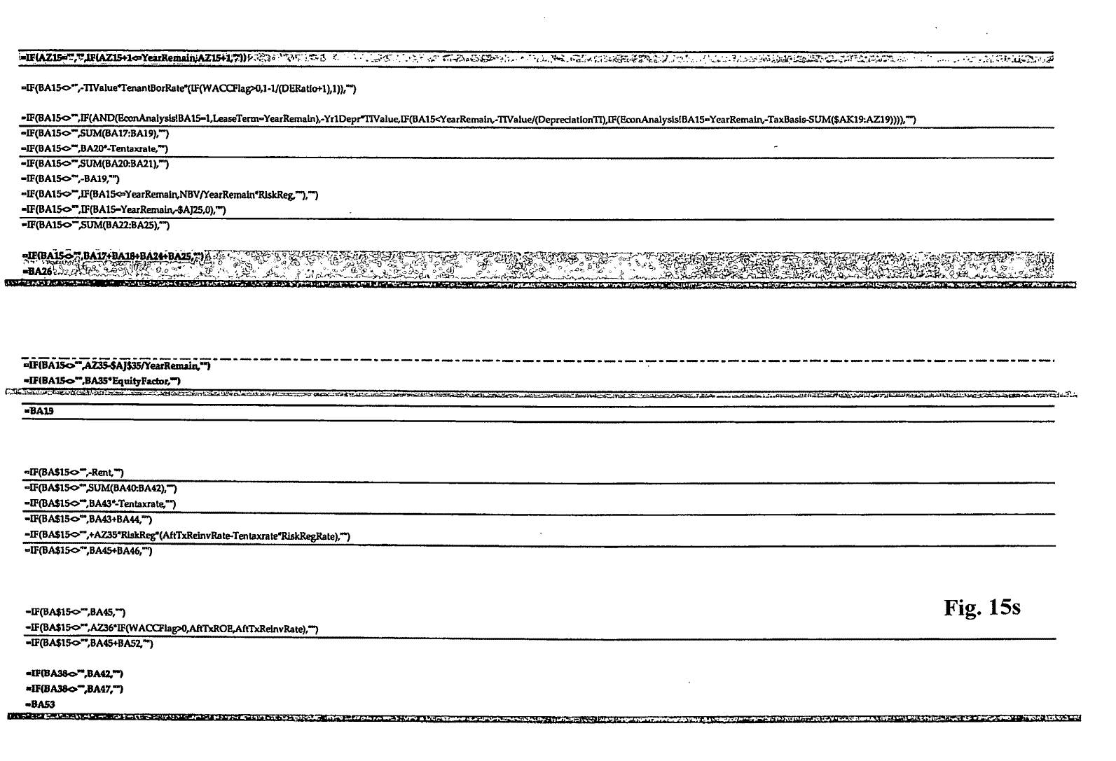

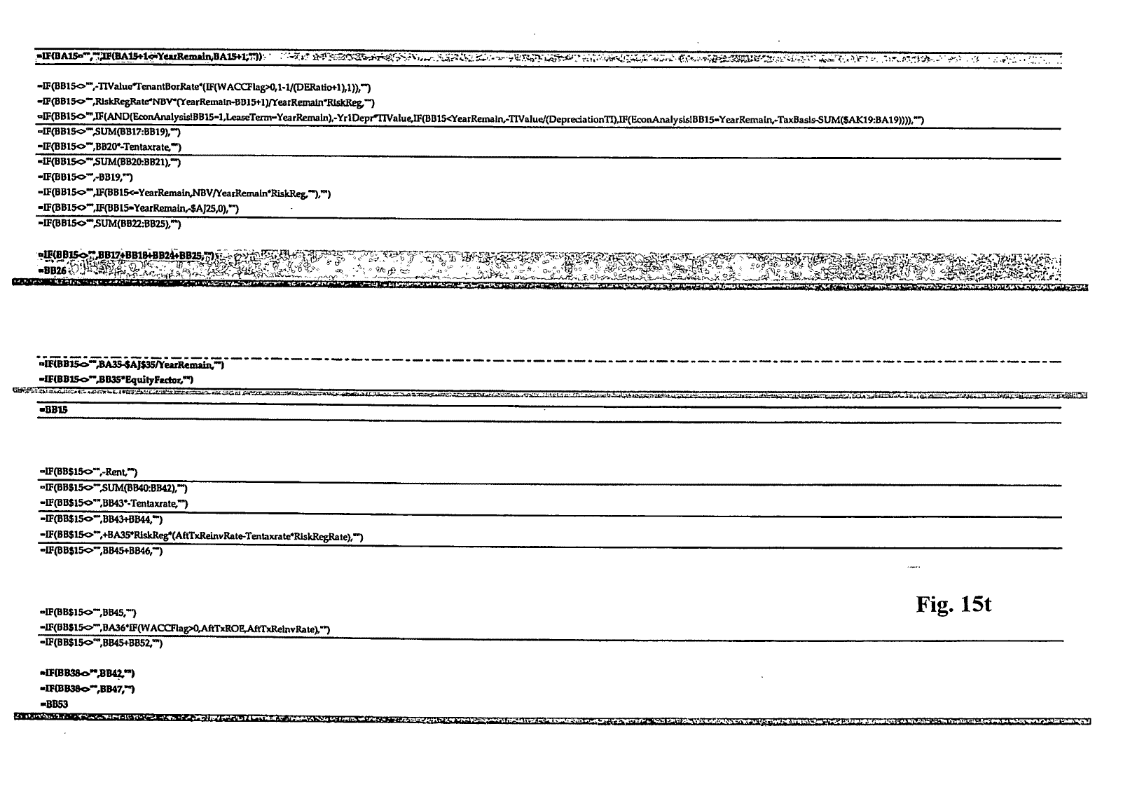

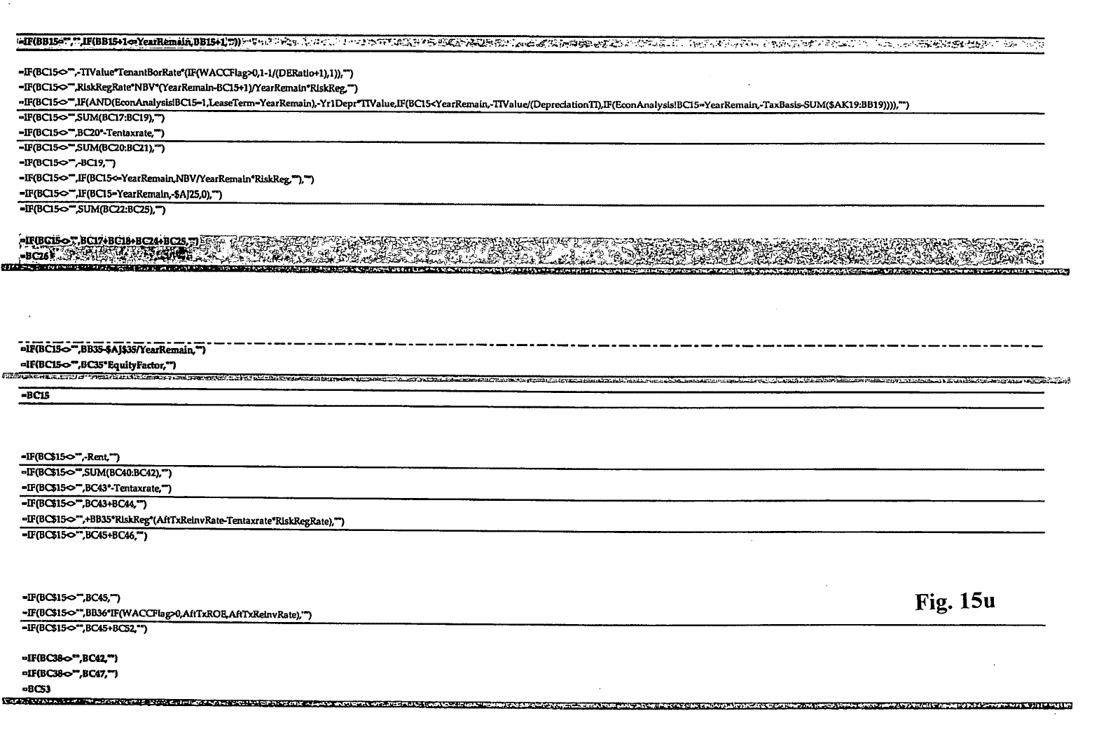

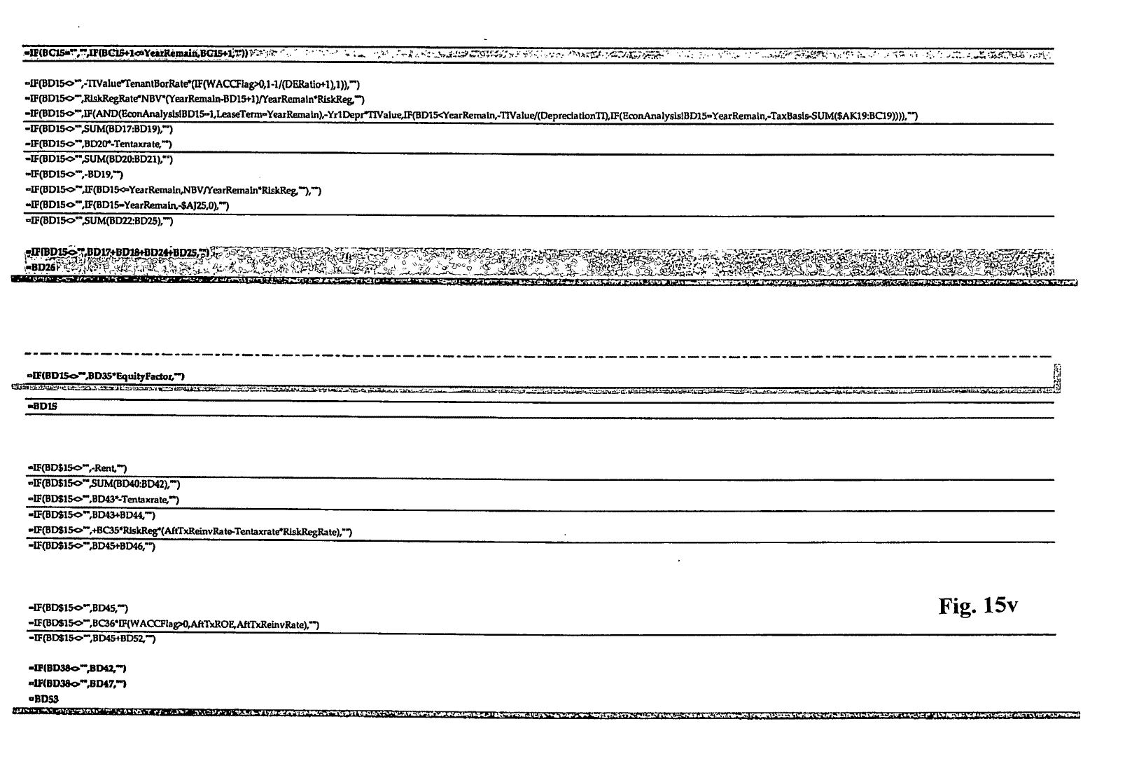

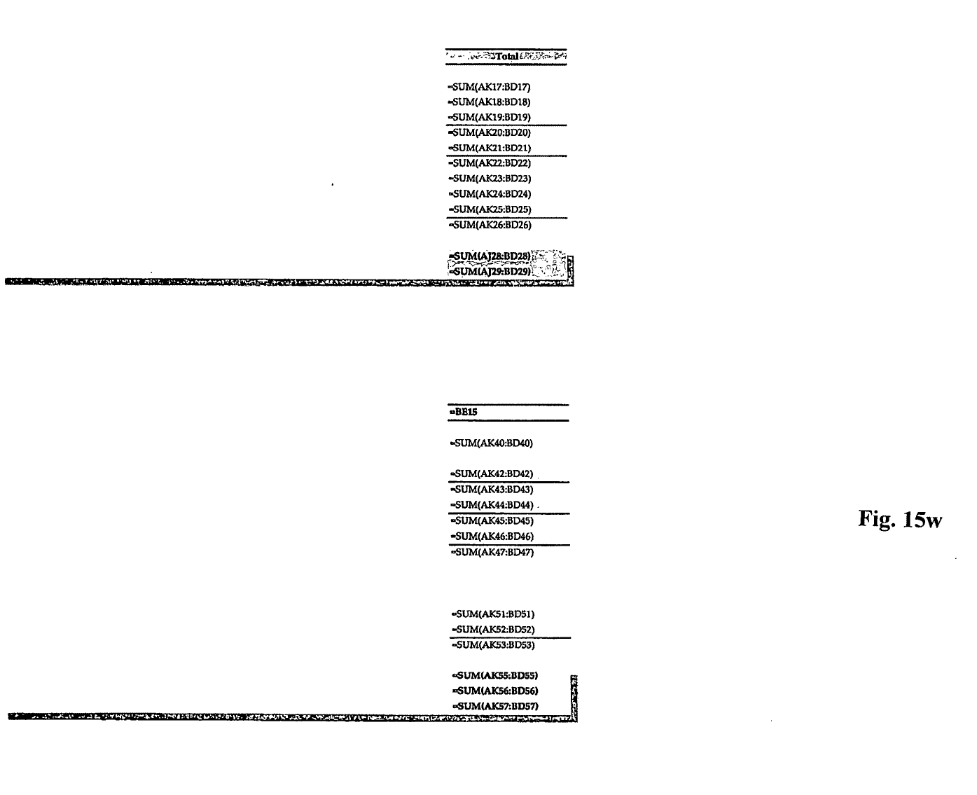

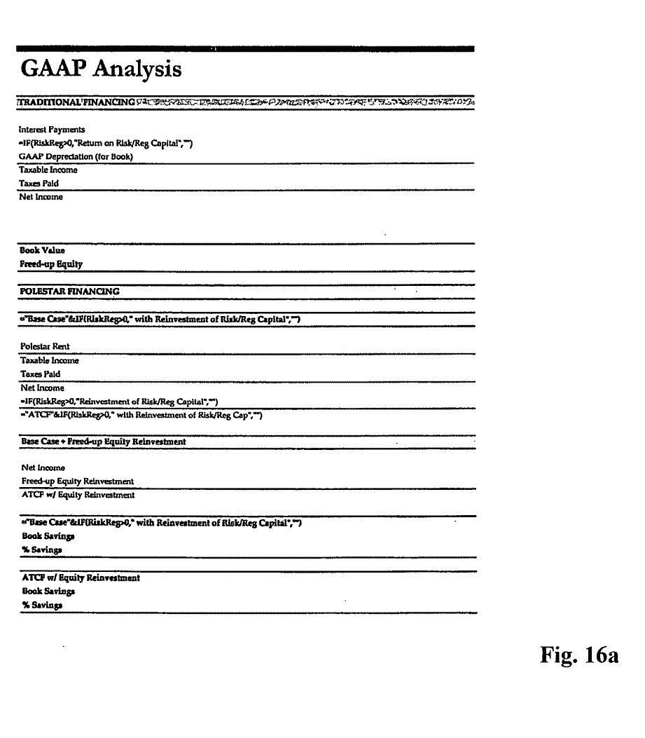

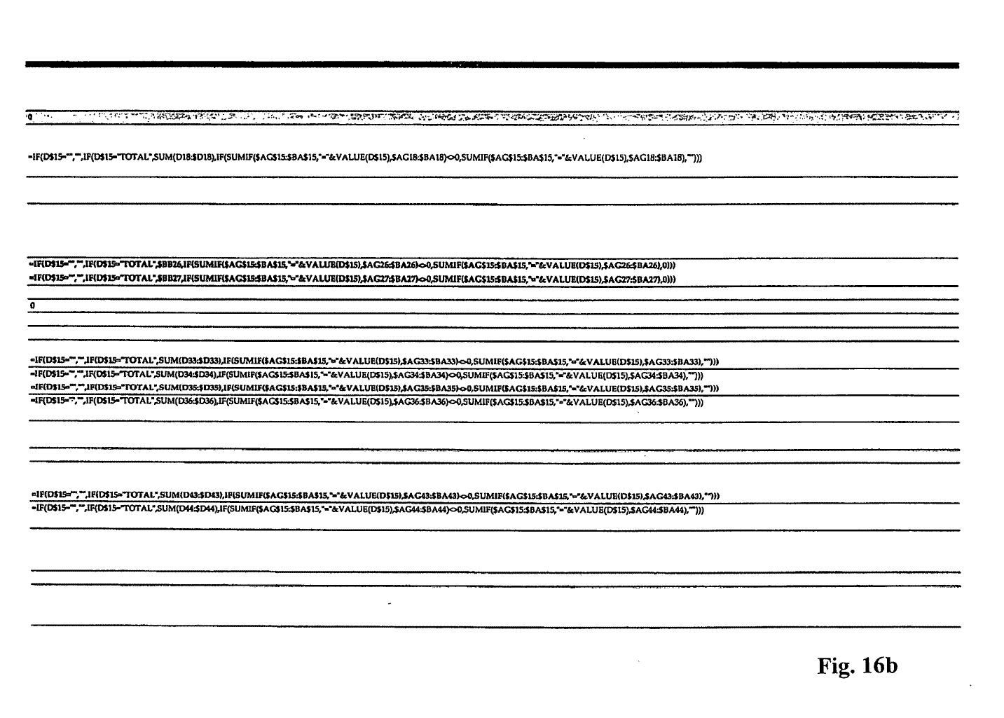

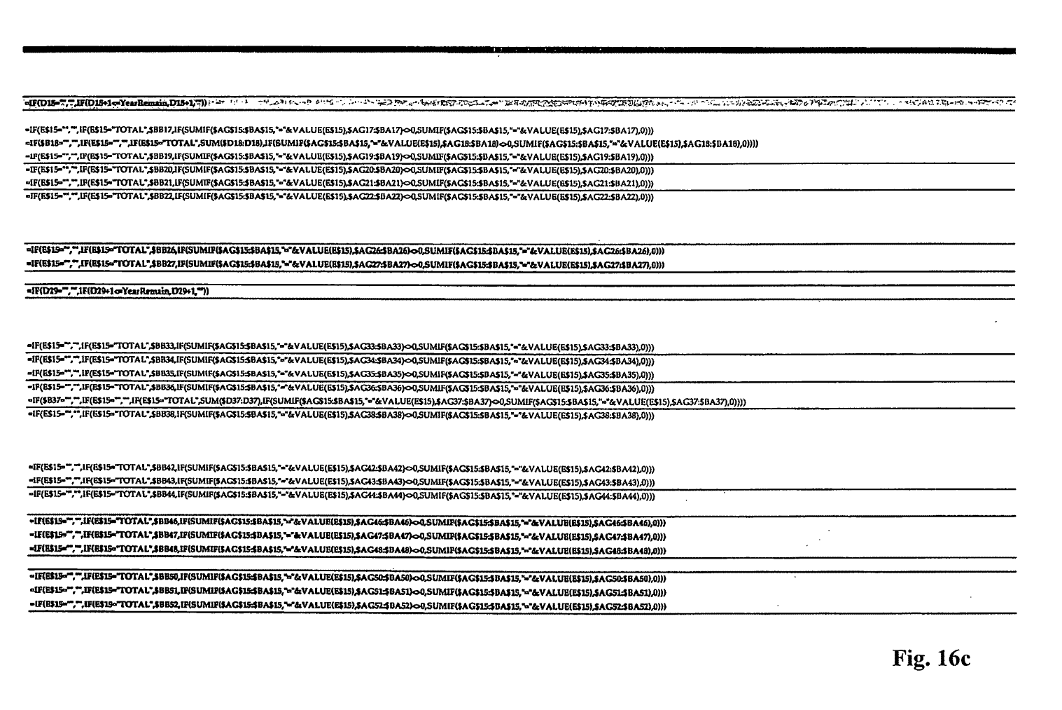

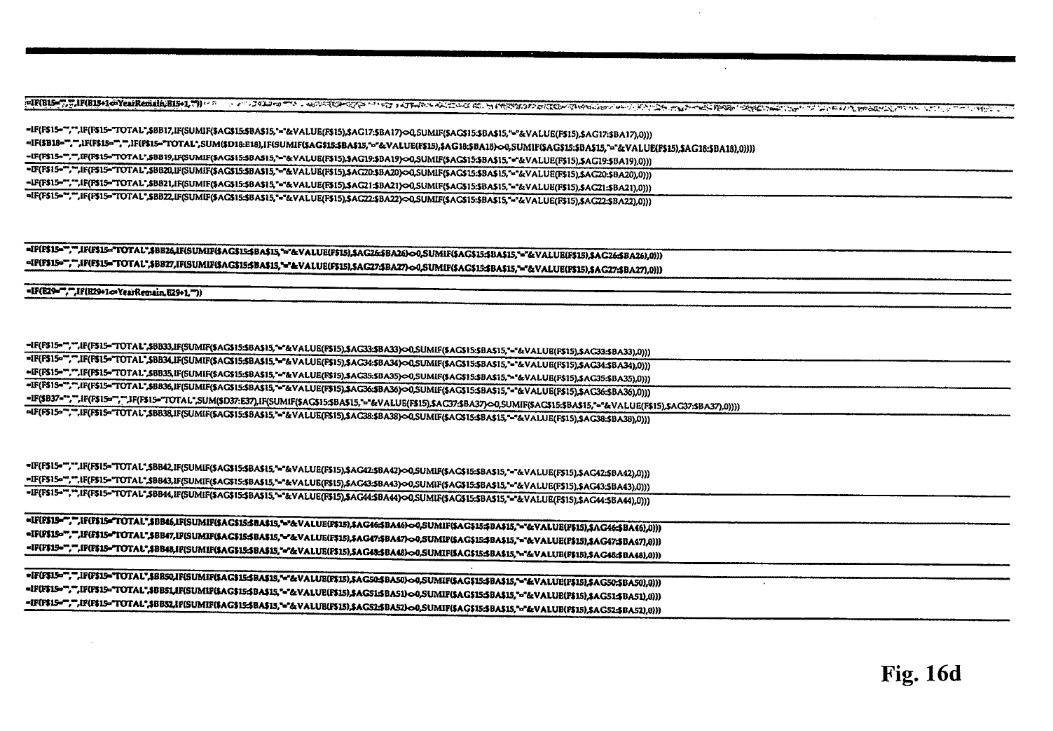

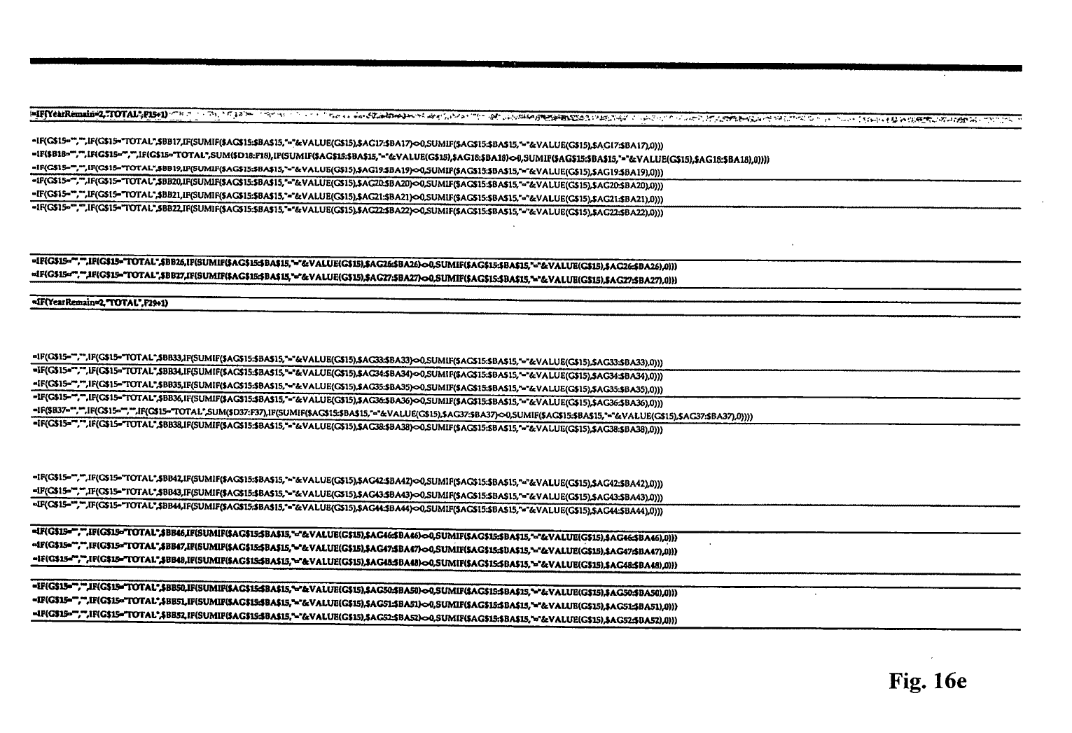

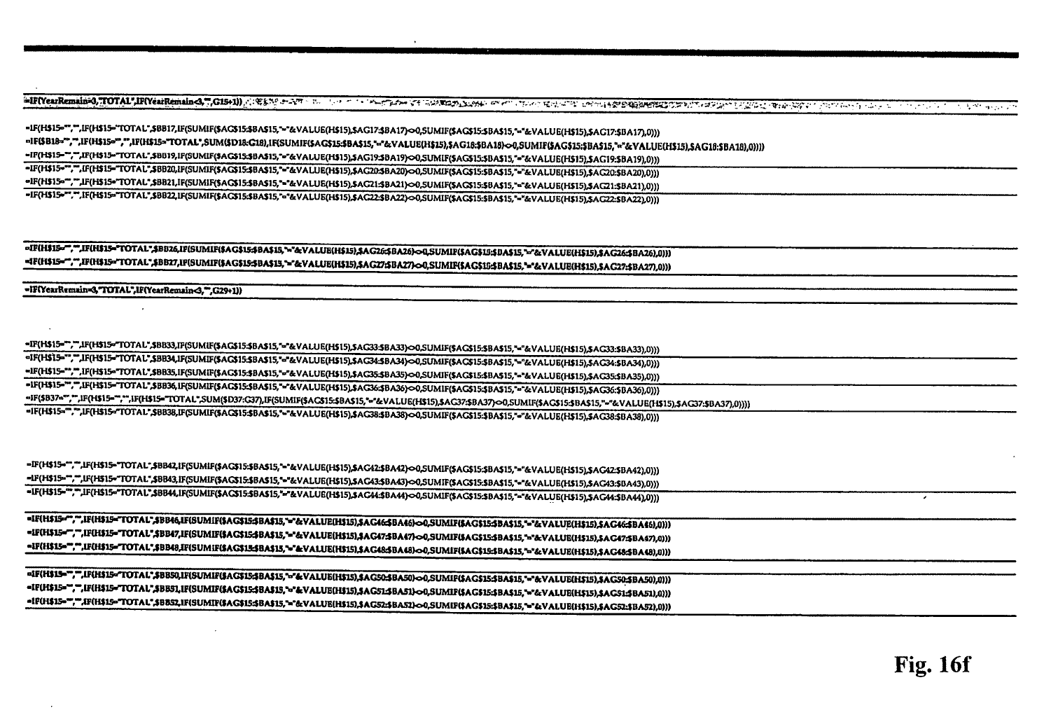

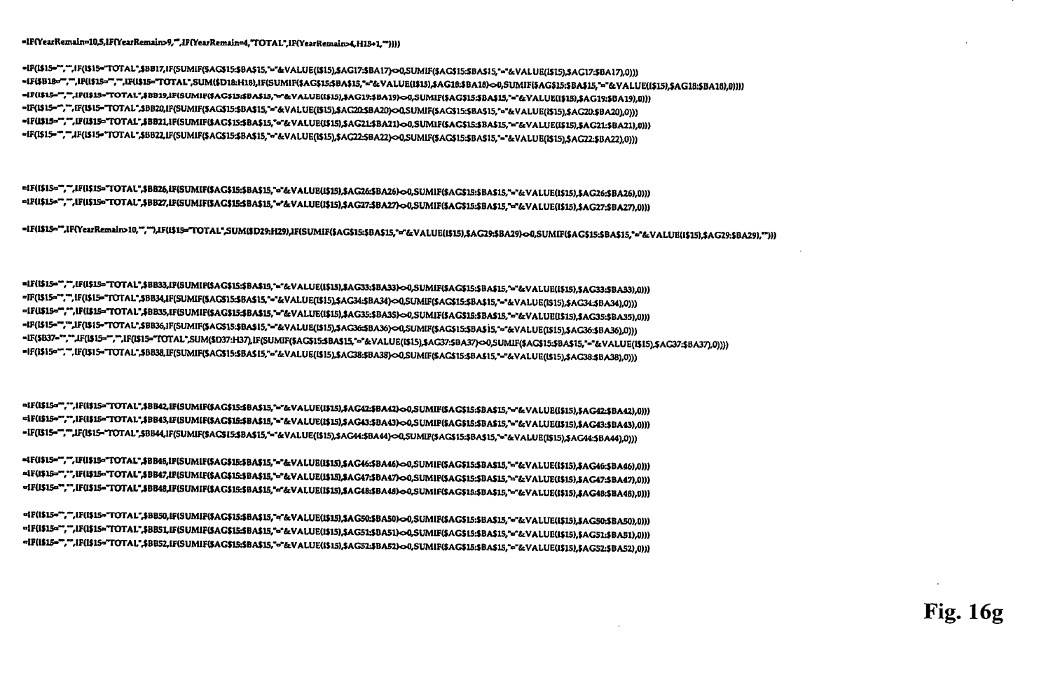

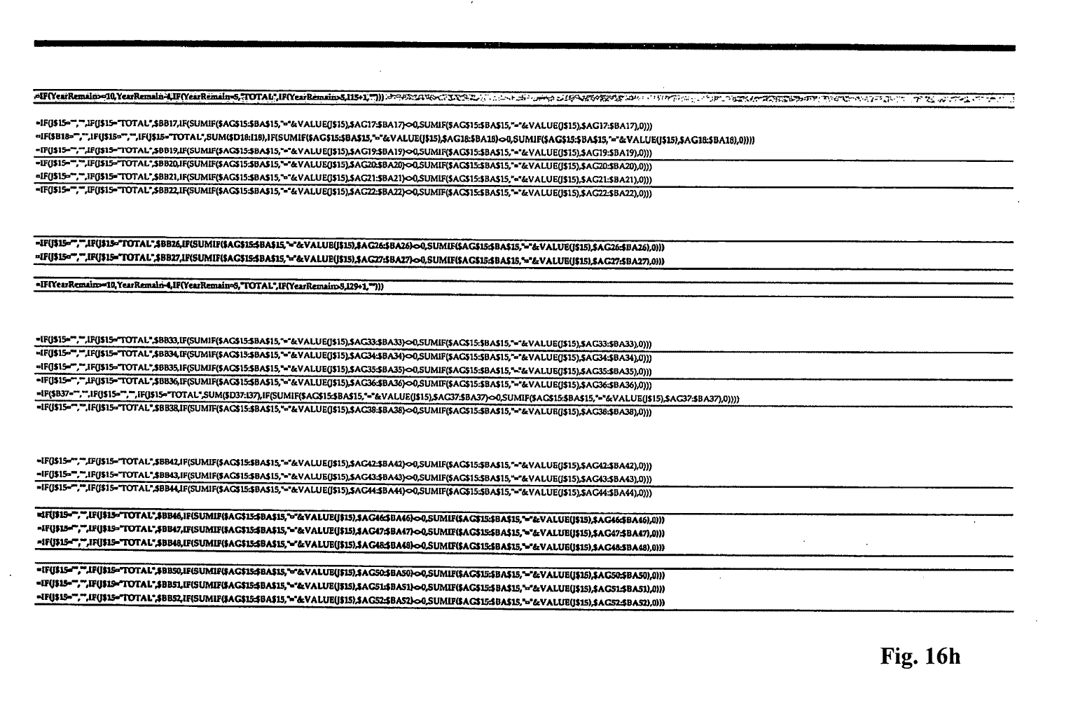

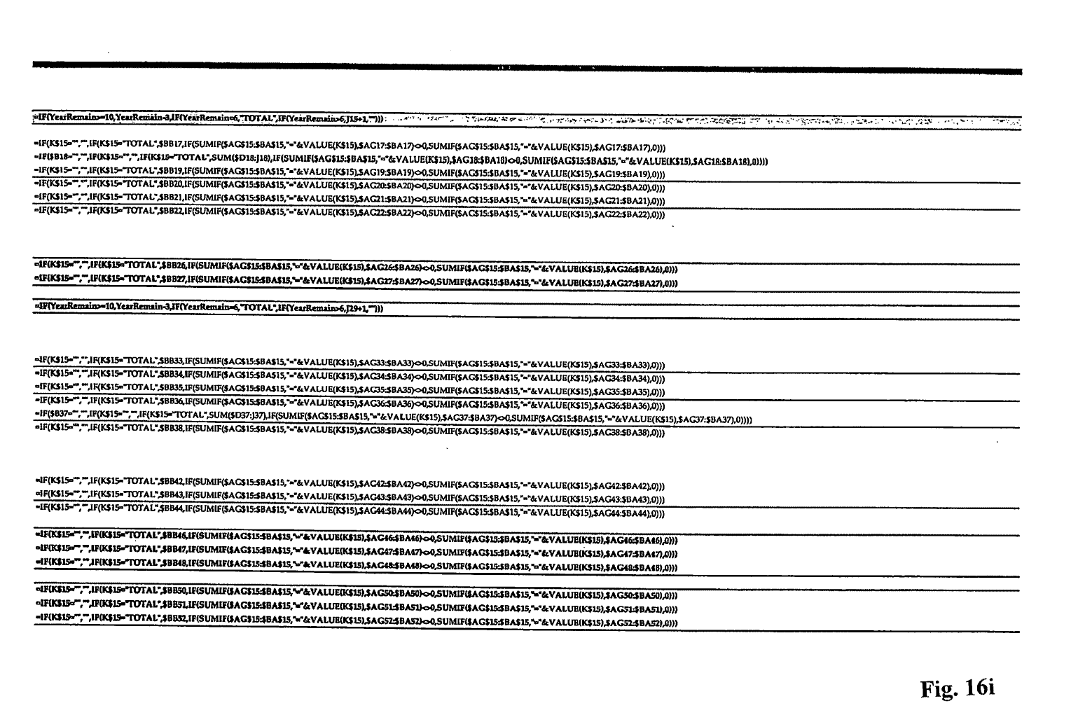

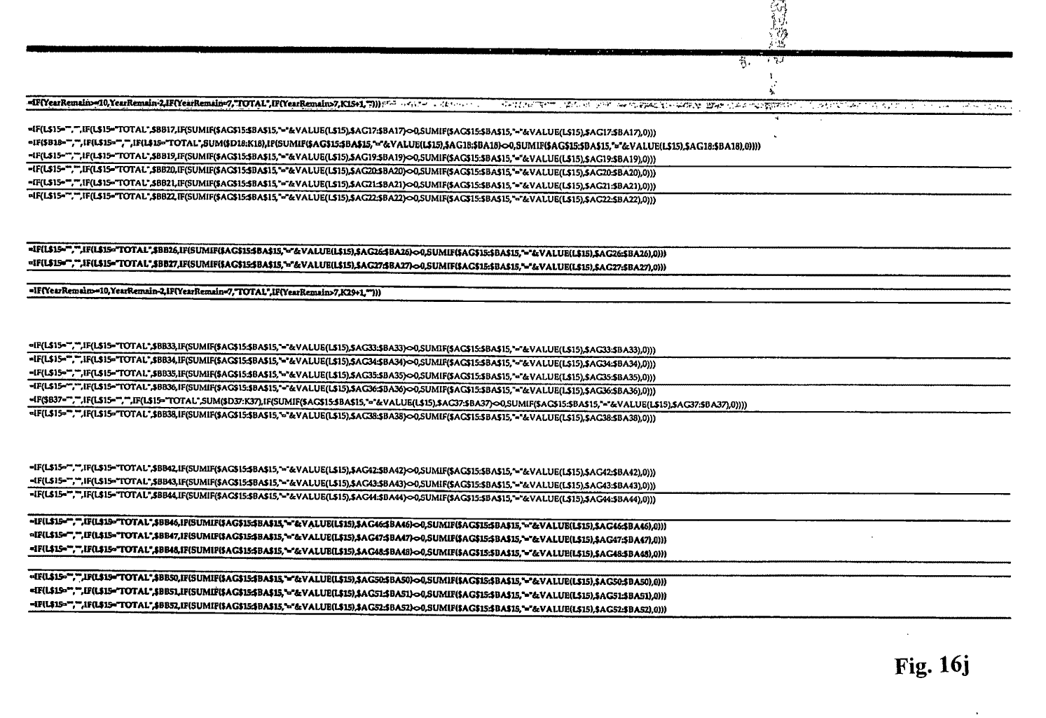

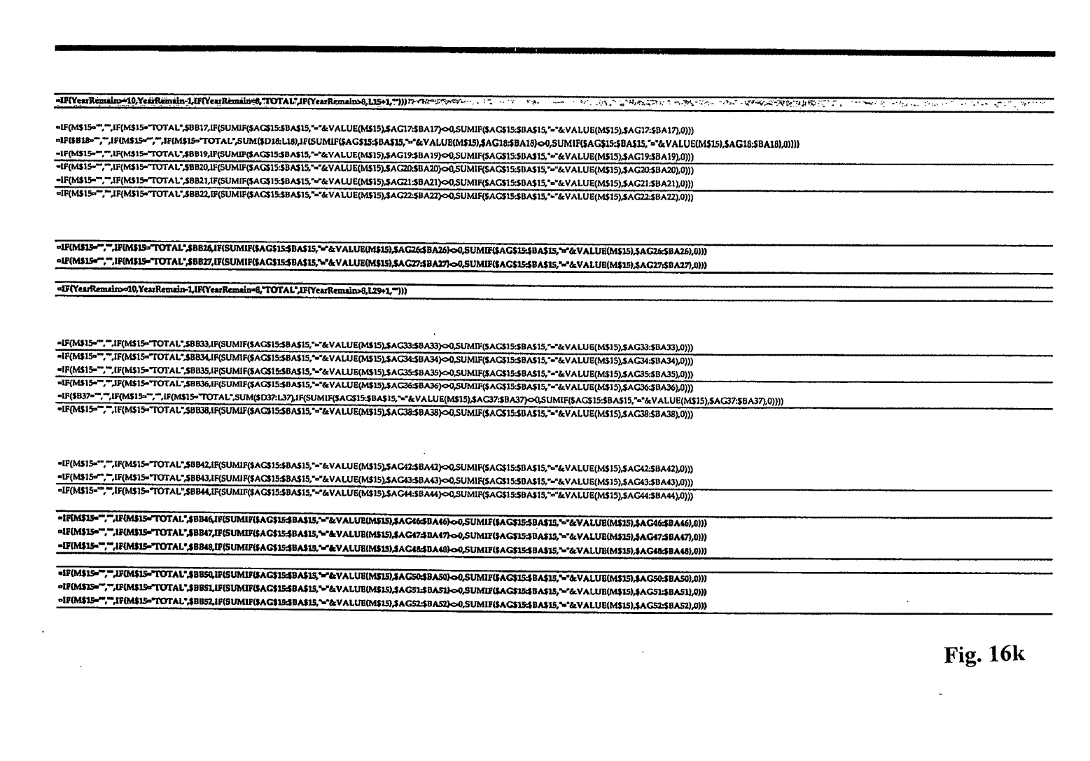

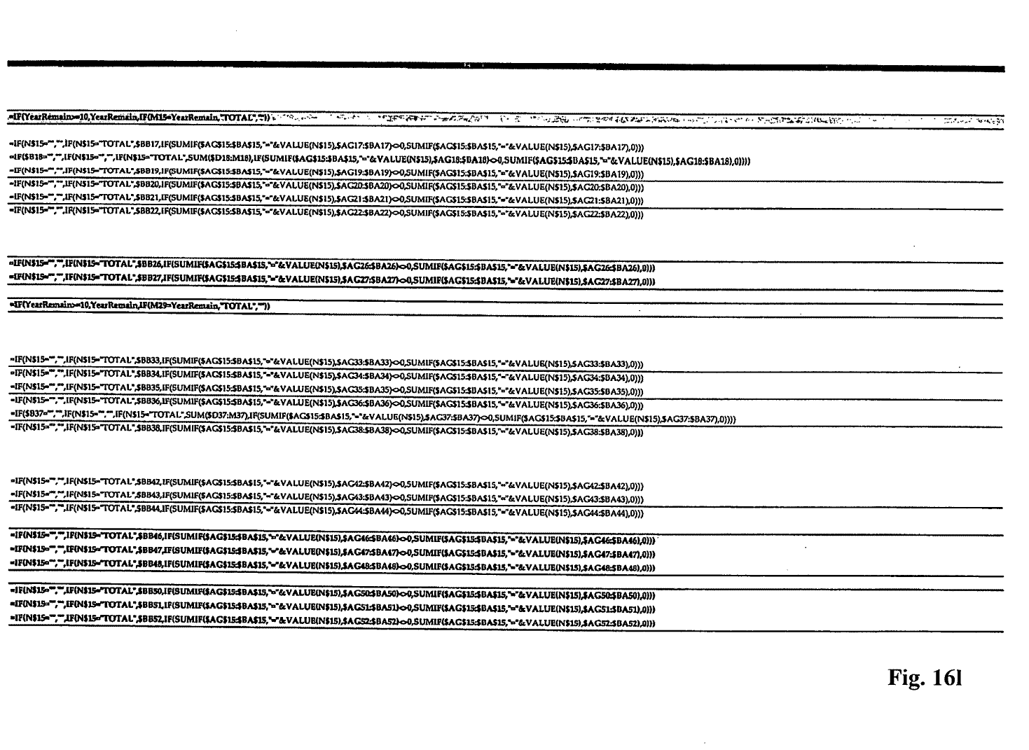

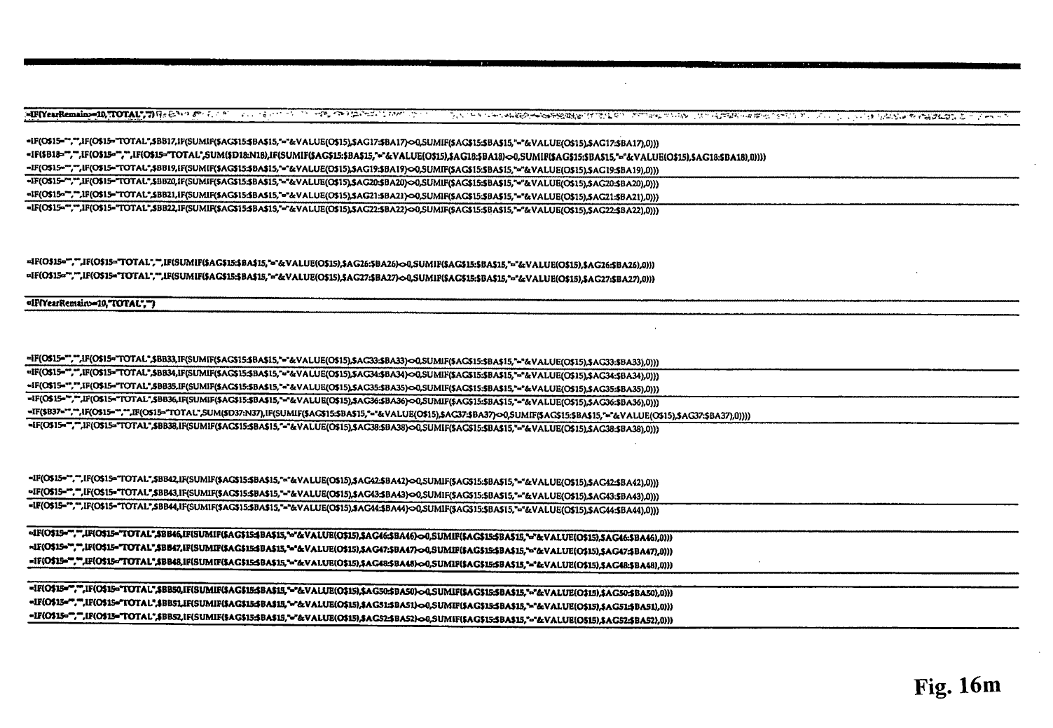

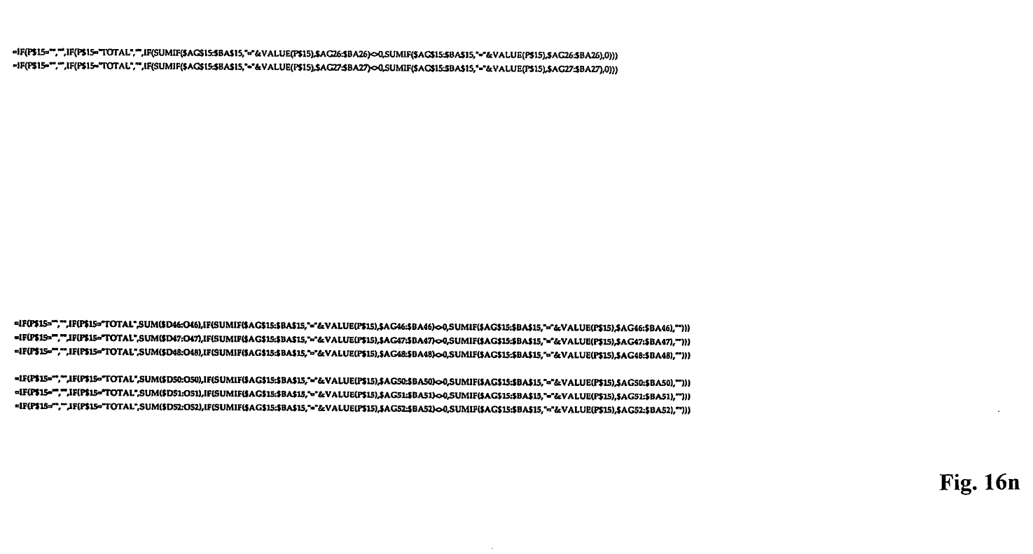

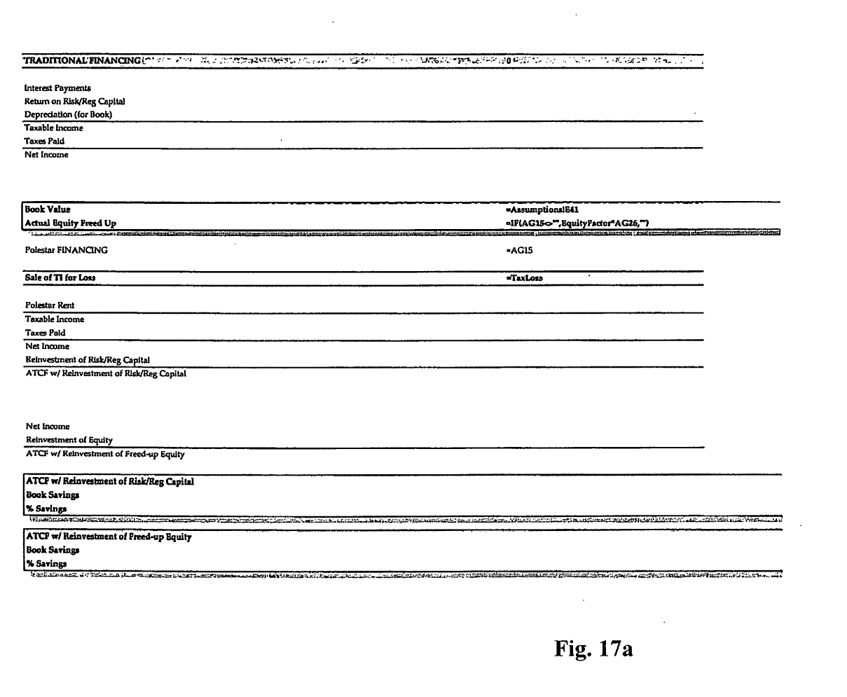

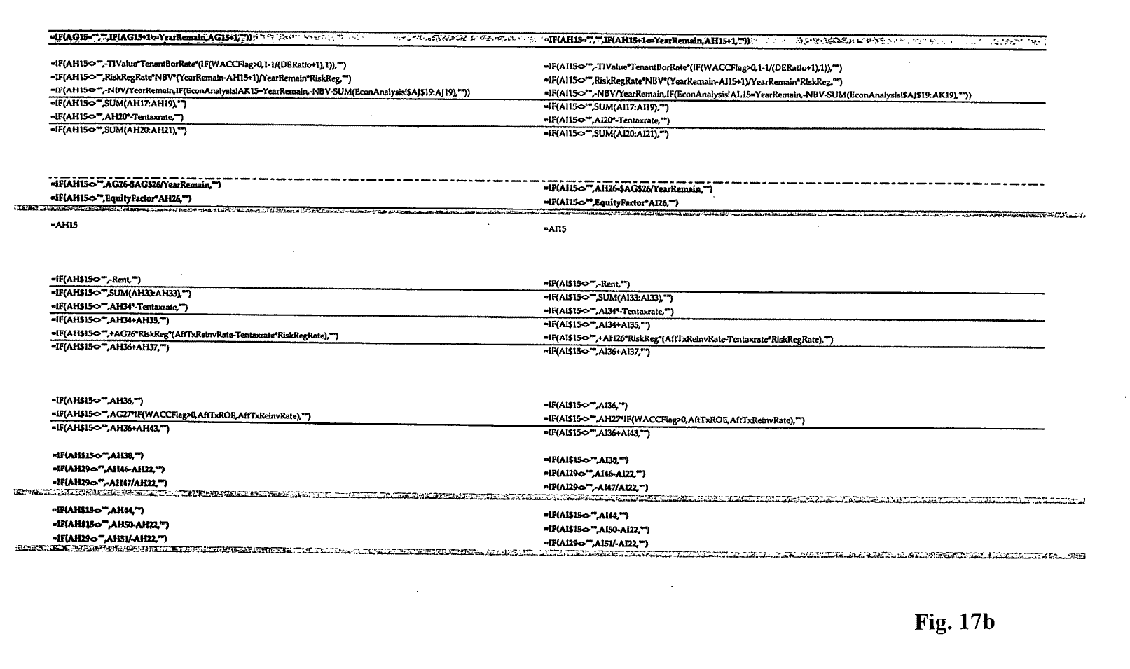

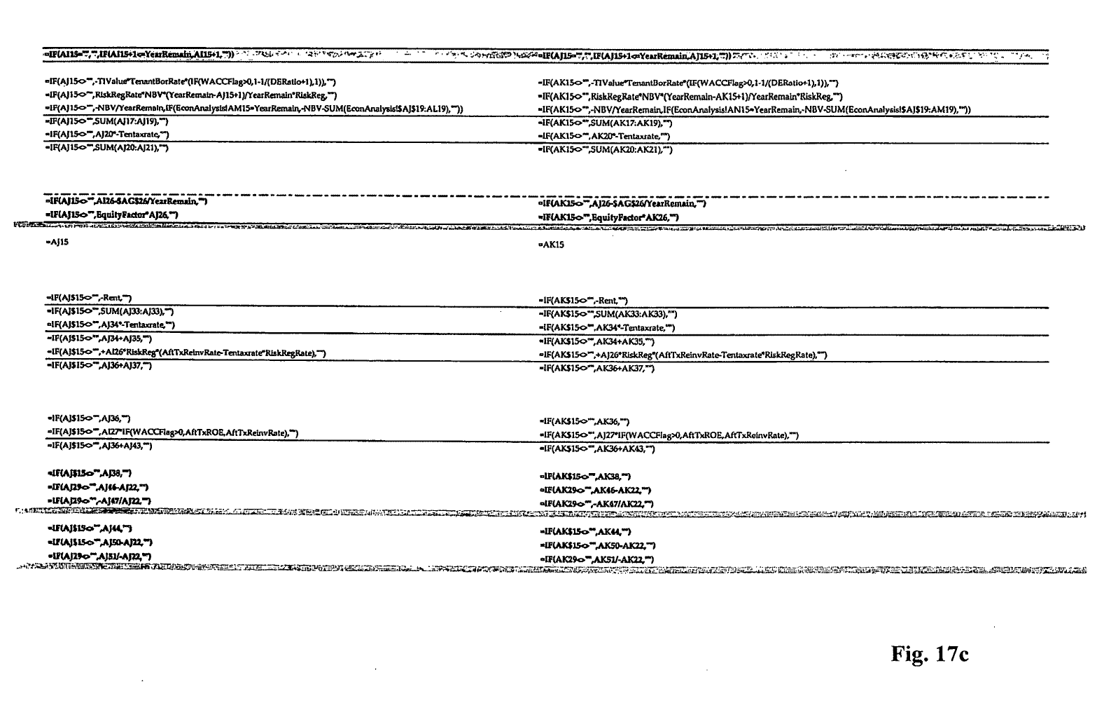

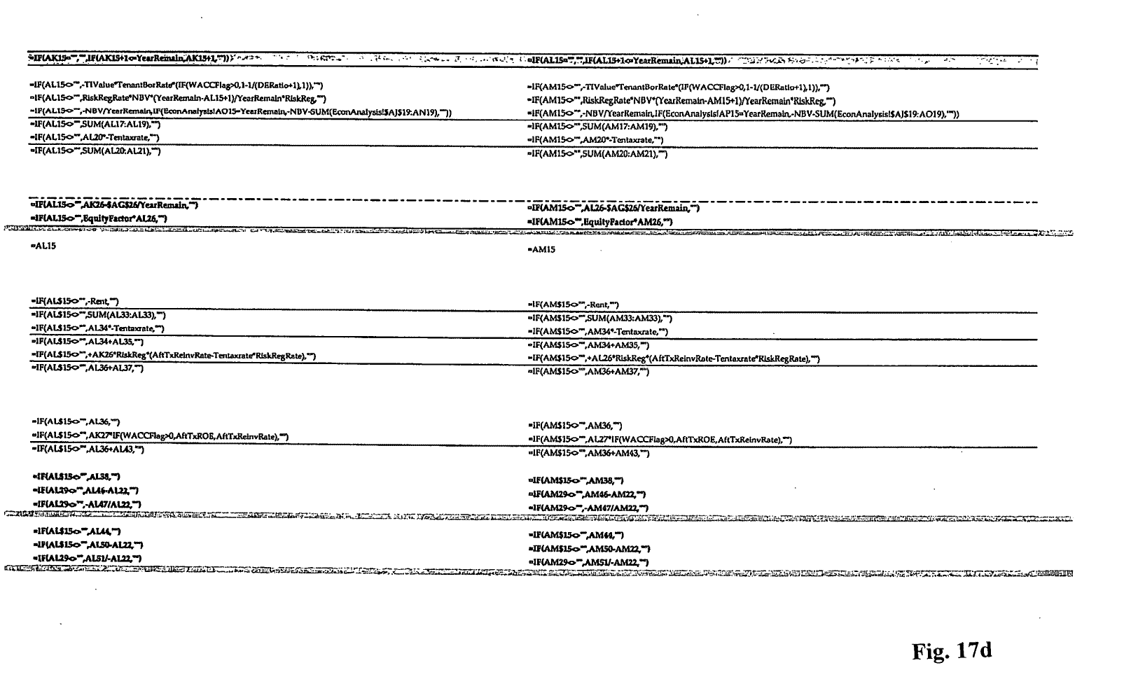

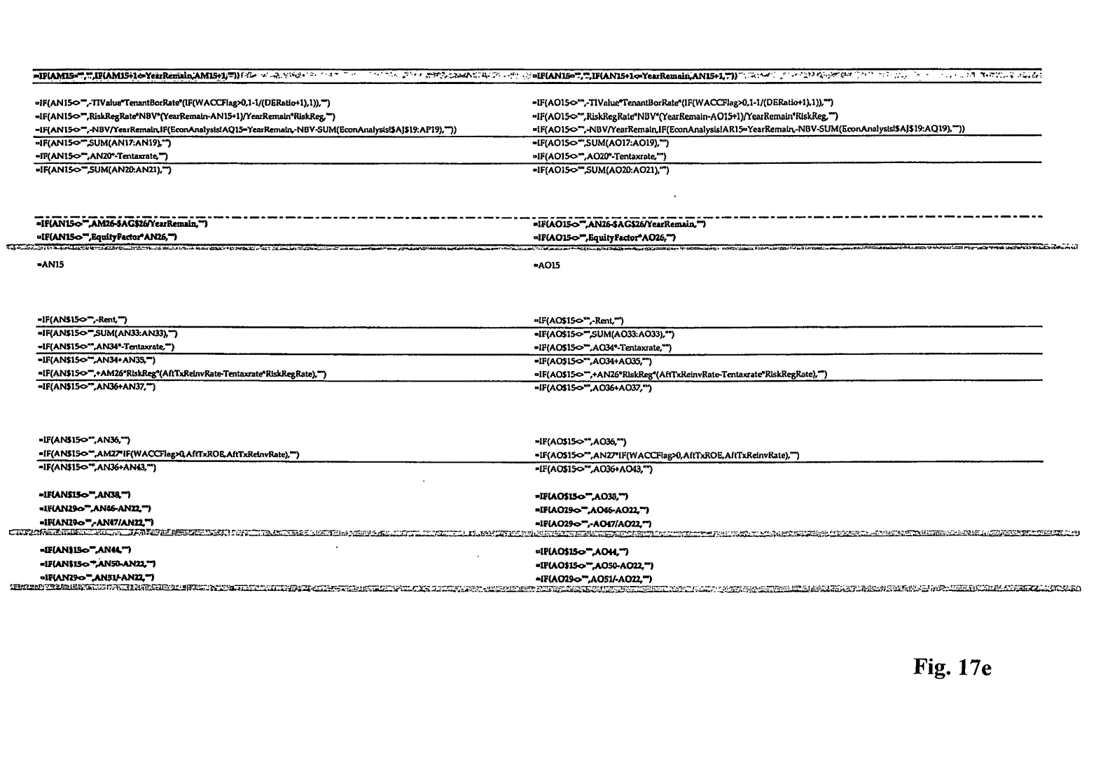

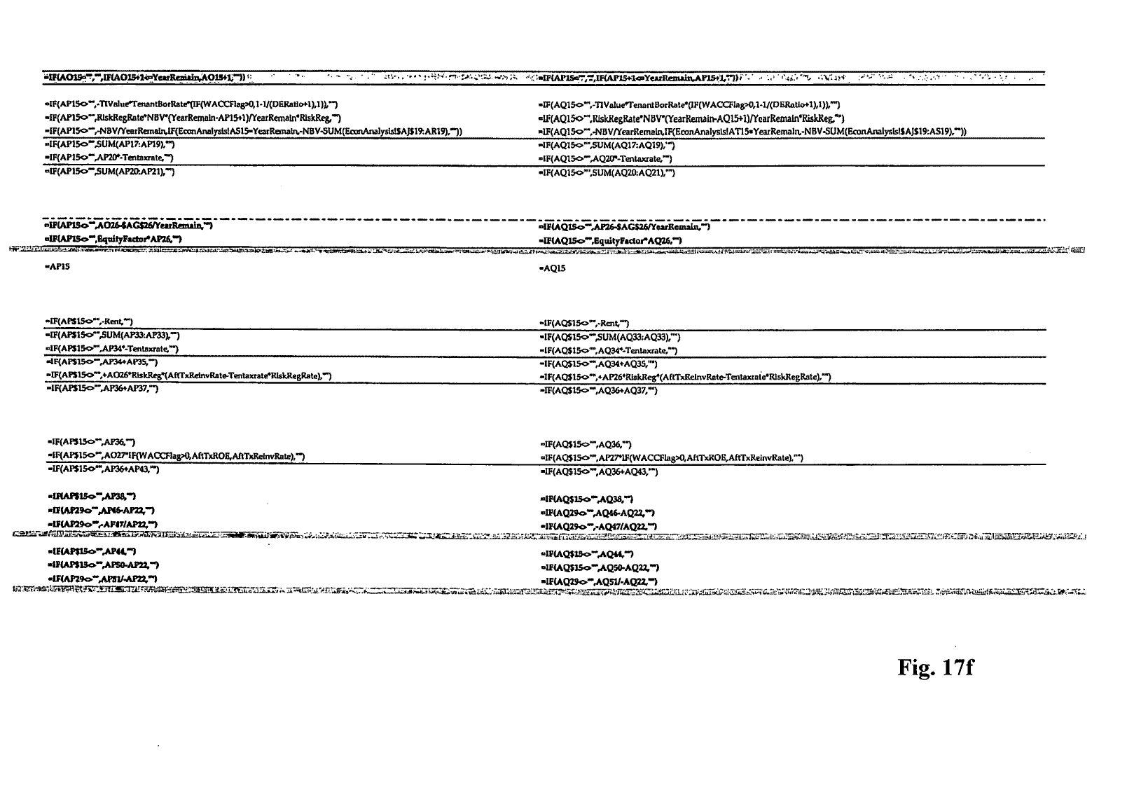

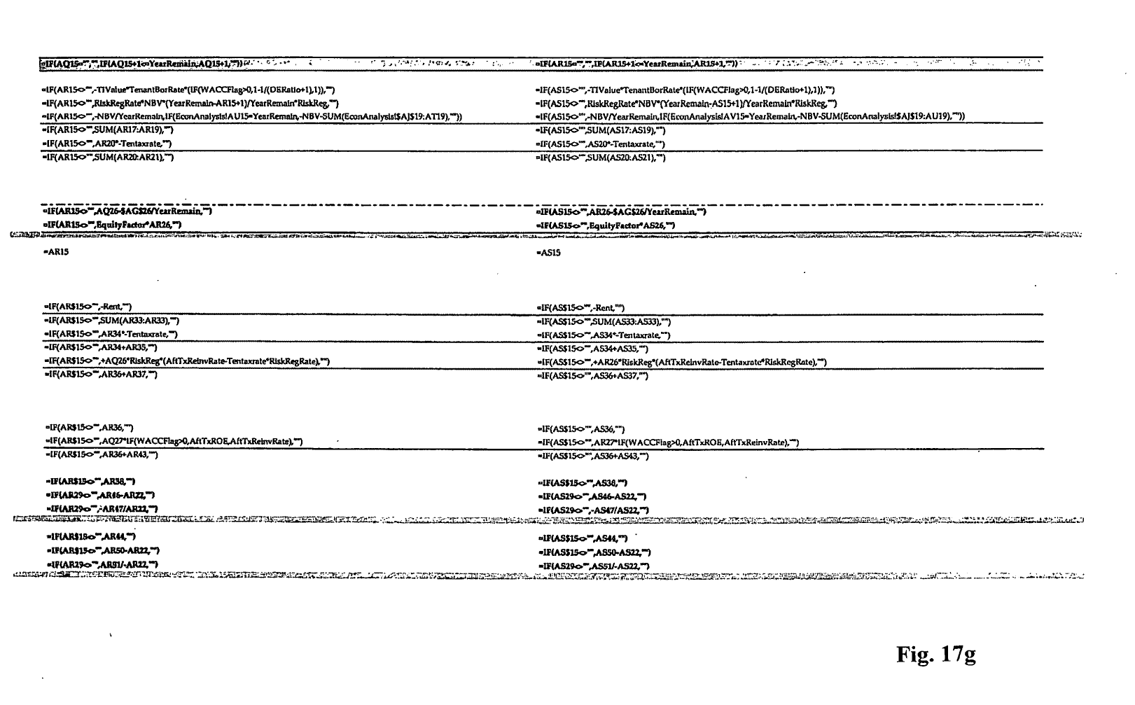

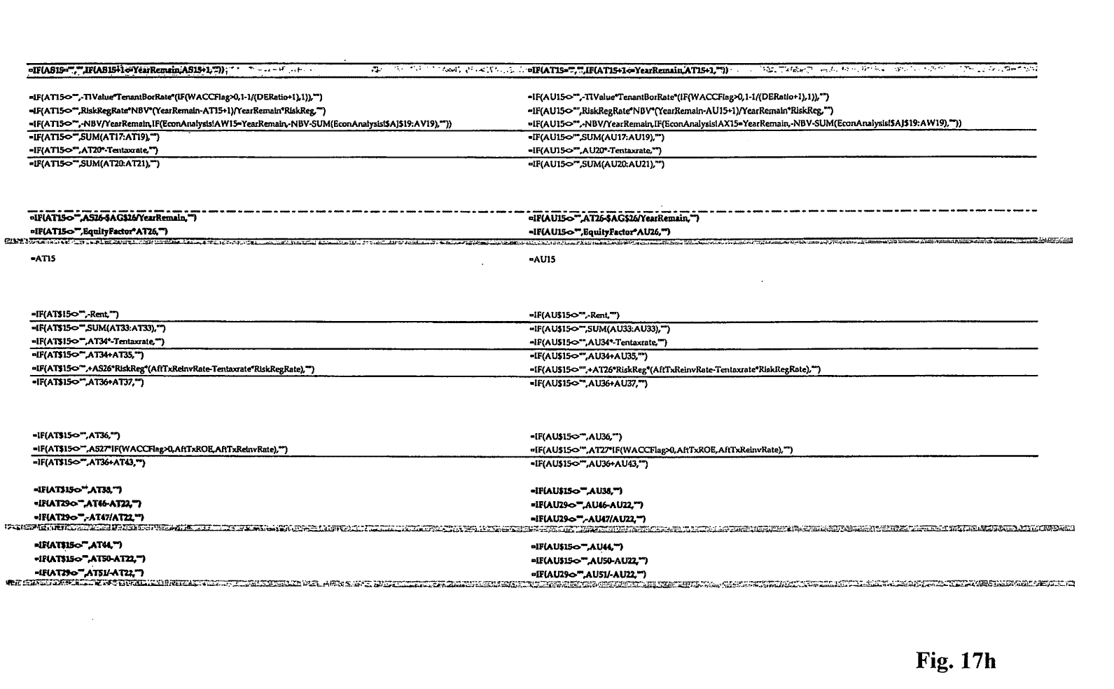

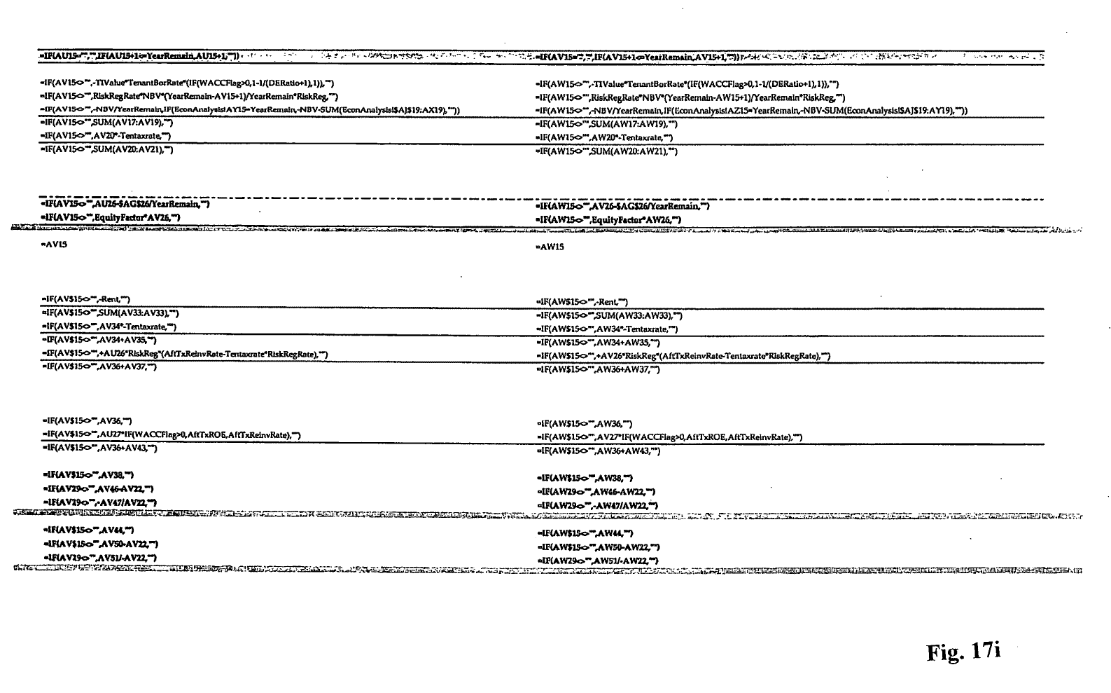

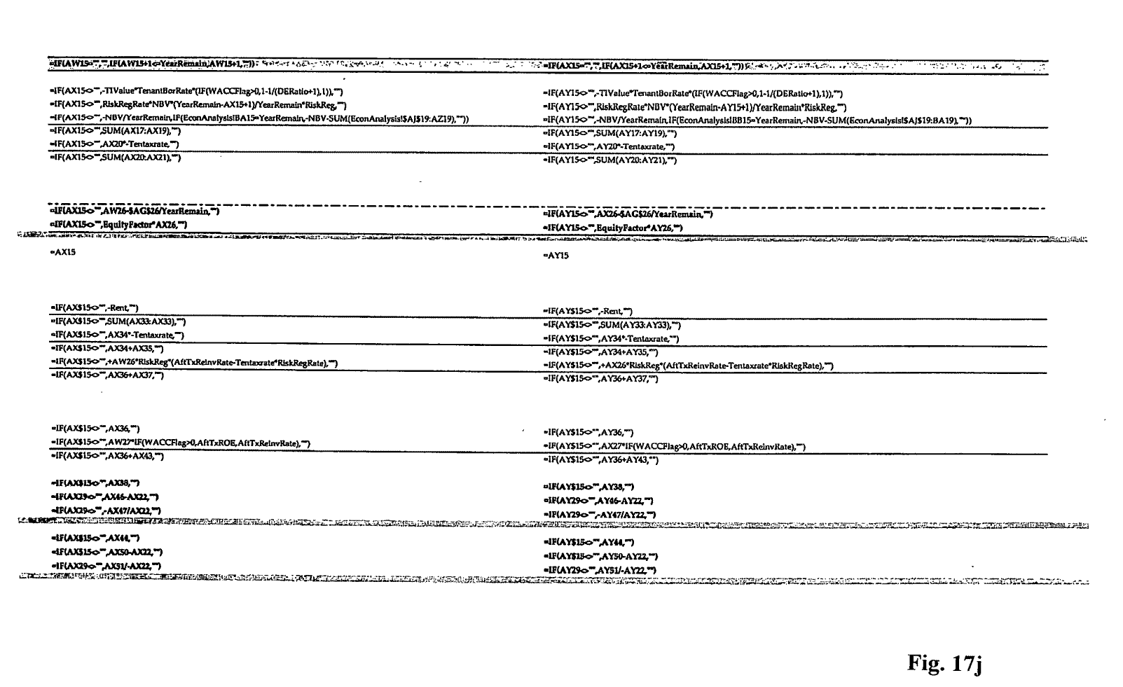

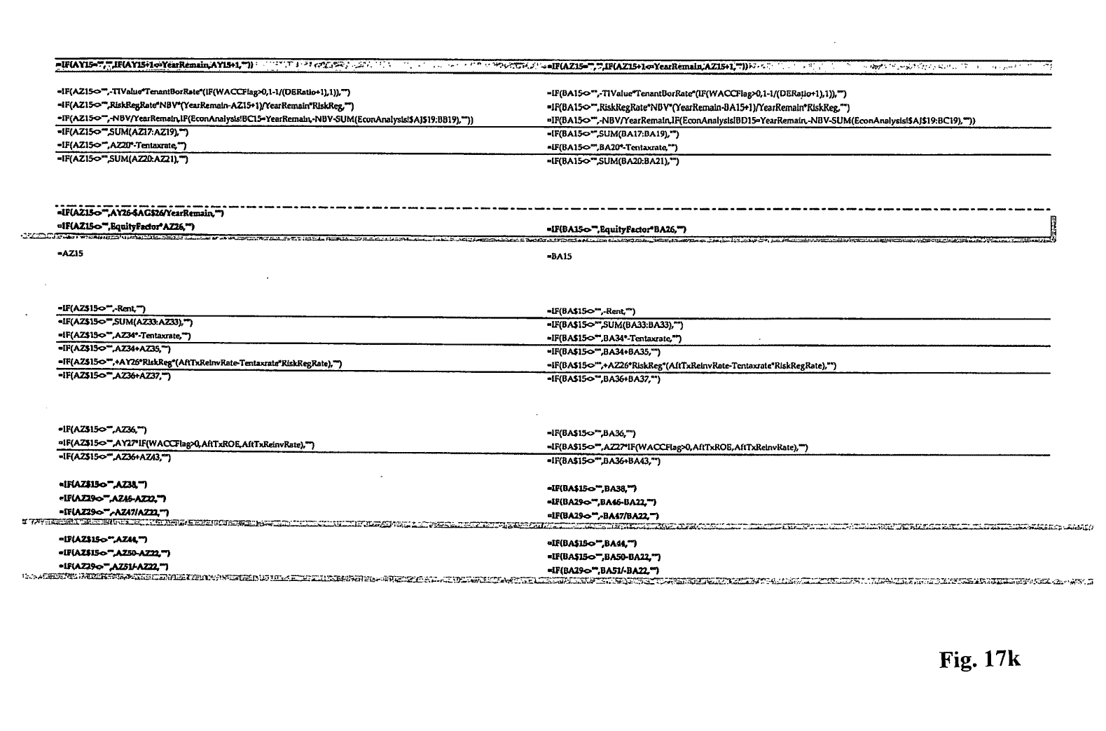

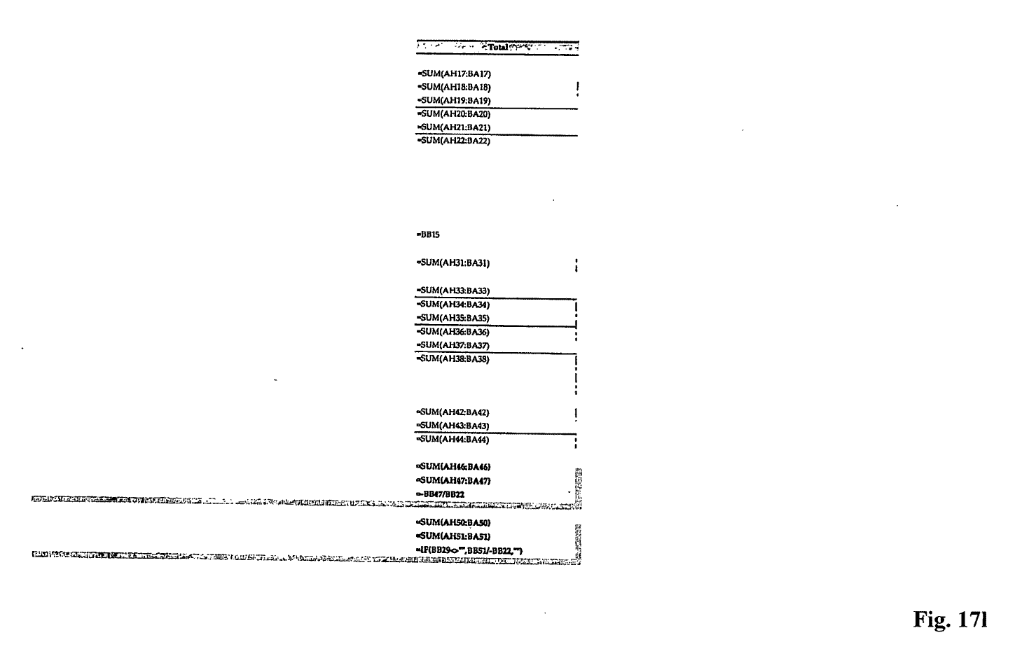

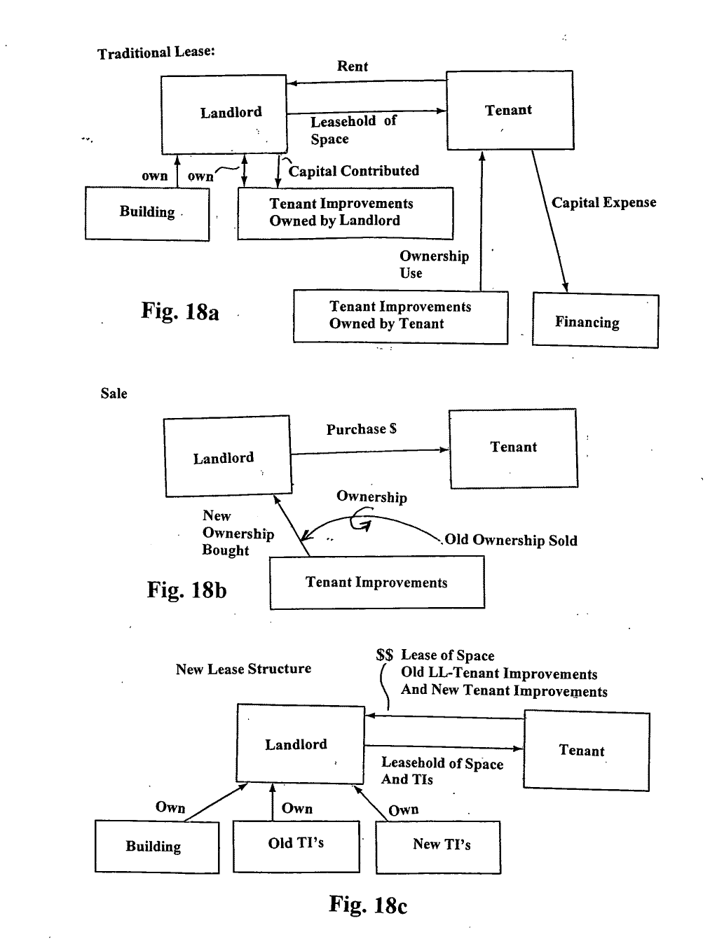

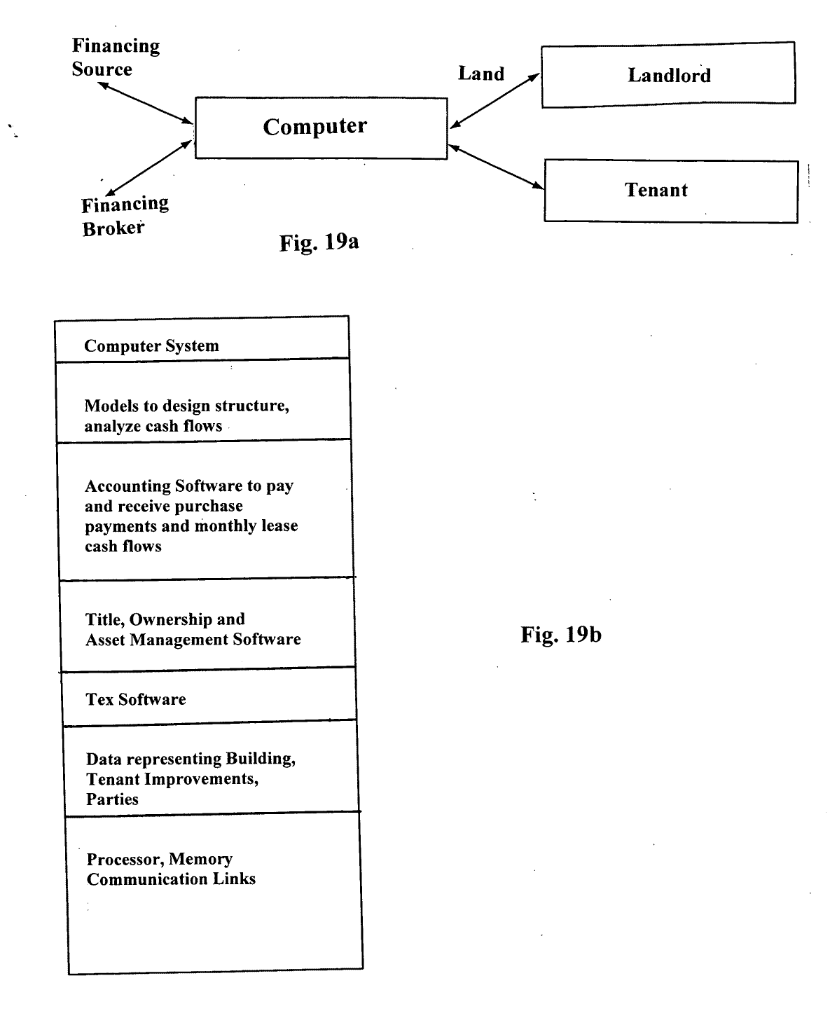

Referring to FIG. 4a, Loan Exchange 400 may deliver an auction capability through a web auction graphical interface and electronic interfaces to participants and Exchange members. The Loan Exchange's information technology infrastructure may use XML data interfaces to electronically transmit to and receive data from borrowers, lenders, custodians, data repositories and transaction processors, over the internet, or over other computer network facilities.

Transactions on Loan Exchange 400 may used standardized terms, conditions and transaction protocols, which may improve transaction efficiency and reduce uncertainties that may arise from negotiations among transaction participants. Loan Exchange 400 may specify that loan documentation, seller representations, seller disclosures and other transaction terms and conditions be uniform and standardized, to improve market efficiency.

Loan Exchange 400 may qualify buyers by verifying willingness and ability to make timely loan purchases. Such qualification may include credit checks or the posting of bonds or security deposits.

Loan Exchange 400 may conduct reverse auctions, in which buyers may express bids in the form of bond-equivalent yields, with the lowest yield winning the right to purchase the tenant improvement loan offered by a seller. Loan Exchange 400 may assist tenants and landlords in organizing special purpose financing vehicles using leases 100 that use uniform terms and conditions, and in providing guidance on market investment preferences. Sellers may offer loan requests, in single credit and pooled transaction forms, to multiple buyers.

An auction may be initiated on Loan Exchange 400 when a seller lists a request for a loan. To describe the loan, a seller may be requested to provide information roughly parallel to that obtained during a loan origination under the procedure described in connection with FIGS. 3d and 3e, above. An auction may occur in an open format, in which bids are visible to all participants, or in sealed bid formats, in which bids may be visible only to sellers and to Loan Exchange 400. Sealed bid auctions my be preferred by certain tenants, such as government or municipal institutions.

Loan Exchange 400 may provide anonymity of buyers and/or sellers during auctions so as to ensure competition and fairness.

Loan Exchange 400 may accept transaction fees for intermediating purchases and sales calculated as a percentage of asset value, and fees on a per-transaction basis for services such as transaction preparation, listing, documentation, settlement and clearing.

VII.C. Data Warehouse

A suite 500 of electronic data warehousing, data extraction and data analysis tools may be provided to store and analyze information relating to tenant improvement financing assets and structures. These data and tools may provide insights to interested parties into the credit and financial characteristics of closed tenant improvement loans.

Data Warehouse 500 may interface with a series of parties, including bond administrators and servicers 200 and tenants 102, to capture relevant tenant improvement loan data. Loan Exchange 300 may supply certain information to Data Warehouse 500 with respect to Exchange transactions and market circumstances.

Data received from bond administrators and servicers may include securitization name, securitization issue date, tenant name, tenant credit rating or shadow credit rating, tenant location, tenant SIC code, loan number, landlord name, current loan balance, cumulative loan payments to date, loan payment status (current or delinquent), late payment history (number of times delinquent in past 60 days, 90 days, 120 days, 180 days, 210 days, 240 days, 270 days, 300 days, 330 days, 360 days, 1.5 years, 2 years), recovery status if in default, tenant bankruptcy status, Chapter 7 or Chapter 11 filing, lease acceptance or rejection if tenant is bankrupt, among other data elements. Data received from tenants may include quarterly audited financial statement, or extracts therefrom, among other data elements. Data received from Loan Exchange 300 may include transaction listings by tenant and landlord name, tenant credit ratings or shadow credit ratings, tenant SIC code, transaction dates, transaction dollar amounts, transaction yields, loan purchaser names, among other data elements.

Data Warehouse 500 may transmit data to appropriate parties, including, for instance, landlords 104 party to tenant improvement financings 100, investment bankers that underwrite and place tenant improvement loan securitizations, lenders 200, credit rating agencies, and market analysts, among others. Data may be organized in standardized templates by securitization, by issue date, by tenant group, by landlord. Data may also be organized in customized formats according to customer requests.

Loan Exchange 300 and Data Warehouse 400 may implement security policies to protect its assets and those of its participants from both internal and external threats. Security measures may include maintaining the confidentiality, integrity, accuracy, availability and privacy of information. Security measures may also include mechanisms to authenticate and authorize users, such as passwords, and a mechanism to prevent fraud. For instance, Data Warehouse 400 may limit disclosures pertaining to tenants to loan number identification, withholding the tenant name from third party review.

Data Warehouse 500 may store the foregoing data in its electronic repository and provide data query and analytic tools to investors, analysts and tenant improvement financing participants. Data Warehouse 500 may share electronic interfaces with loan origination software 300, Loan Exchange 400, and lenders 200.

VII.D. Loan Analysis Software

Software 510 for analyzing an individual loan 120 or for analyzing a basket of loans 120 may be provided, for instance as a web-based application accessible through an Internet browser on a thin client basis. Analysis software 510 may provide tools to tenants, landlords and/or investors that will enable these users to analyze asset and liability profiles with respect to tenant improvement financings 120 on a portfolio basis, with respect to existing and prospective exposures. The base information element of analysis software 510 will provide various parties to a tenant improvements lease transaction 100 with the ability to query a specific loan 120, or portfolio of tenant improvement loans 120, and receive current loan performance data and key tenant financial information during the term of the loan. Loan analysis software 510 may take in information from Data Warehouse 500. In addition, analysis software 510 may produce a series of files for updating loan infomuation on separate customer information systems as may be contractually requested.

Each primary party will have tailored screen perspectives according to his or her respective business perspective. A multi-location tenant may analyze portfolio exposure from a liability perspective; a multi-office landlord may analyze portfolio exposure from a risk-asset perspective; a securitization investor may analyze portfolio exposure from a fixed income perspective. Each party may make use of an identical database 500 of tenant improvement financing information, but may obtain varying capital investment, liability or operating objectives.

Referring to FIG. 4a, loan analysis software 510 may act as an information reporting service that monitors loan performance for completed tenant improvements financings during the life of the loan. Therefore, the application requires minimal user input, since it will automatically only present loan information for transactions that the user has an interest. Upon a user signing onto the system (with appropriate password and security routines), the system may automatically present the user with a report of the user's loan, or loan portfolio. By simply double clicking on an individual loan, the user can retrieve additional background and performance data on a specific loan. In the case where a user may have an interest in several loans, the user may sort the portfolio according to criteria relevant to their perspective using pre-set pop-up menus containing the sort keys. The following sections briefly describe features according to individual landlord, investor, and tenant perspectives.

Referring to FIGS. 4b and 4c, a landlord may monitor and analyze portfolios of office properties on single property, regional and portfolio bases. Analysis software 510 may enable landlords to analyze, budget for and disburse capital for tenant improvements on a centralized and consolidated basis.

Referring to FIG. 4d, analysis software's analytic capabilities may apply to the refinance of existing capital investments and new financing of prospective investments.

In addition to the generic loan information described above, Landlords will be provided enhanced portfolio sort functions that present loans organized by tenants, property, maturity date, principal outstanding, originating leasing agent, region, etc. The landlord may view reports to determine whether loans are current and view payment histories. The landlord may be able to view online the financial statements of the special purpose entity and automate routine accounting, record keeping, and consolidation entries.

The landlord component of analysis software 510 may be constructed by making minor modifications to conventional software for real estate portfolio analysis software, for instance, that available from The Realm.

Referring to FIG. 4e, lenders 200 may review, project and measure the effect of the performance of portfolio loans upon the cash flows and credit ratings of securitization investments. Analysis software 510 may enable lenders to project hypothetical loan default experience onto a securitization loan portfolio and to derive likely principle receipts for a tenant improvement loan securitization. Such analyses will correlate with asset valuation and risk management disciplines.

Generic lenders, e.g., banks, insurance companies or finance companies, may be able to sort their loan portfolio by landlord, tenants, geographic region, maturity date, principal outstanding, originating banker, SIC code, credit rating, etc. The lender may view reports related to payment delinquencies, investor take-outs, and the status of new loan applications by parties already on file with loans outstanding. The lender component of Loan Analysis software 510 may be constructed from conventional bond analysis software, with minor modifications.

Analysis software 510 may enable multi-location tenants to measure the interest costs affiliated with tenant improvement loans to which they are party and to allocate costs and exposures between office locations, markets, landlords, etc. At an initial decision-making level, analysis software 510 may enable a tenant will to measure and compare costs and benefits between the lease financing method for tenant improvements and current capital alternatives.

Once a loan 120 has been repaid in full, the entire loan history and record may be closed out in the analysis software 510 system and archived to Data Warehouse 500, from where it can be accessed under a separate service agreement for trend and analytical review purposes.

### VIII. Sale Leaseback to Improve Landlord's Operating Income

In some cases, a transaction may be structured as a sale-leaseback of existing tenant improvements. Existing tenant improvements that are owned by the tenant in a leased premises may be sold to the landlord, or to an entity controlled by the landlord, and then leased back to the tenant. The term of the tenant improvement lease may be set as the parties desire, to achieve various financial objectives, and will typically be no longer than the remaining term of the space lease. The monthly lease cash flow is set to amortize the cost of the purchase over the term of the tenant improvement lease. The tenant receives a payment for the sale price, which is typically either the net book value (NBV, typically under GAAP accounting rules, remaining asset value purchase price net of accumulated deprecation), an appraised or negotiated fair market value, the replacement value, tax basis, or some other justifiable price for the tenant improvements. The payment may be in cash or some other consideration. The landlord may increase the tenant's rent, which may be reflected in an increased net operating income for the landlord. This may result in reduction in the tenant's net occupancy cost.

This transaction may be particularly beneficial in cases where the current rent is below market, for example, where current rents have substantially increased. In some cases, the transaction may be profitable where the escalated space lease rent (gross or net lease) is at least 15% below market. Generally, a higher rent rate differential will enable the transaction to be profitable for smaller installations, and a lower rent rate differential will be sufficient for larger installations. The tenant may be willing to pay increased rent—for example to some amount between the rent rate at which the lease was entered into and current lease rates—in return for the immediate cash payment and the corresponding tax and accounting benefits. The landlord may be able to report higher rent income.

The tenant may realize several benefits. First, the tenant may obtain immediate capital or other relief, such as regulatory or statutory. The tenant may realize improved earnings, by liquidating an asset that produces little or no cash flow, and by removing an asset from the tenant's books that negatively affects earnings. Third, there may be some tax benefit. Typically tenant improvements have an actual economically-useful life less than the 39-year life assumed by the tax code's depreciation schedule. Thus, for tenant improvements that are a few years old, the sale price for the sale-leaseback transaction may be well below the depreciated value for tax purposes. When the tenant improvements are sold from the tenant to the landlord, the price at which the improvements are sold to the landlord may be well below the depreciated tax basis. The difference between the sale price and the remaining tax basis may be realized as accelerated depreciation on the sale, and the resultant tax loss for the tenant may be used to offset other income. The tenant may benefit from an opportunity to derive cash today from a balance sheet asset, and the reduction in asset base may improve financial ratios and reduce future depreciation charges. The transaction may result in a cash take-out of $5-10 per square foot, which may be distributed between the landlord and tenant as they see fit. Typically, the rent payments for the tenant improvements lease are tax deductible to the tenant, which may be more desirable than the tax position of paying financing costs for the improvements with a typical 10-year term, while the assets themselves can only be depreciated on a 39-year schedule. This tax advantage may provide additional benefits that may be divided among the parties as they see fit.

In accordance with GAAP, the tenant improvements may be depreciated on a ten-year straight line basis. Thus, for a total $10 million tent improvements investment for a 10 year deal, at the end of year 1, the book value is $9 million. At the end of year 2, the book value is $8 million. At the end of year 3, the book value is $7 million. At the end of year 4, the book value is $6 million. At the end of year 5, the book value is $5 million. At the end of year 6, the book value is $4 million. At the end of year 7, the book value is $3 million. At the end of year 8, the book value is $2 million. At the end of year 9, the book value is $1 million. And at the end of year 10, the book value is $0.

In contrast, the tax basis differs substantially from the book value. Depreciation is in accordance with the present tax code permitted for 39 years with 1/39^{th} per year. This fraction may change by a change of law. Thus, at the end of year 5, the tax basis is $10 million−($10 million× 1/39×5 yrs.)=$8.717949 million. The tax loss is the difference between the tax basis and the book value. The tax loss in this example at the end of year 5 is 8.717949−5=$3.717949 million.

For the landlord, the asset that was undesirable for the tenant's accounting and tax treatment may be converted, when held by the landlord, to an asset that generates net operating income or rent revenue for the landlord. This rent increase may be 100% accretive to net operating income from a lender and/or new buyer's perspective. This may permit the landlord to increase the rent before the lease expires. This increase in rent may be used to increase valuation of the building for refinancing or sale, to raise debt coverage ratios, and/or to improve the lender's risk profile by lowering loan-to-value ratios or its investment risk profile.

In some cases, the tenant improvements may be sold to a special purpose vehicle, typically controlled by the landlord. The capitalization into and distribution of cash flows from this special purpose vehicle may be structured in any convenient way, for example as described above. The tenant improvements may be financed in large percentage, for example 90%, by a third party lender. This may be a loan based upon the credit of the tenant, with no recourse to the landlord should the tenant default on its payments for the tenant improvements financing. The remainder of the financing, for example 10%, may be contributed by the landlord. In this method, the tenant improvements may be sold by the tenant to the landlord at “time zero” or well into the term of the lease, and the tenant improvements may be leased back to the tenant for some or all of the remaining term of the space lease.

In other cases, the tenant improvements may be sold to the special purpose vehicle or other entity that already exists for ownership of the building. This structure may be desirable in a distressed debt situation where the owner of the building in default, technical default, or near default, or may also be desirable in a non-distressed situation.

The price of the sale may be set at a value that benefits all the parties, typically no less than the depreciated book value of the tenant improvements, and no more than the original cost. The purchase price may be adjusted between the parties as desired, generally to reflect the landlord's, tenant's, and a financier's balance sheet cash position, future monthly cash flow position, requirements for regulatory capital, or tax needs.

The sale-leaseback transaction can be financed in many cases entirely by the landlord and tenant, with no outside financing or capital contribution, simply by payment of the asset sale price and a renegotiation of the lease. This may simplify the transaction. In other cases, capital may enter the transaction from a third party. The landlord's existing lender may be a desirable party for such a transaction, because this lender typically has interests aligned with the landlord.

Financing for purchase of the tenant improvements may be secured in the manner of any other secondary financing, typically by a pledge of the partnership equity interests in the entity that owns the building, or as a pledge of the rents from the tenant improvements, or by a junior assignment of tenant improvements, or through a REIT's (real estate investment trust's) existing credit line or equity, or equity or debt of an investment company or fund such as a pension fund. A commercial lender may choose to value the combination of the pre-transaction escalated space lease rent and the new lease amendment rent reflecting the fully amortizing financing of the tenant improvements sale-sale-lease back for the benefit of the existing owner refinancing or sale.

The transaction may be embodied in a lease amendment document that provides that that (a) the tenant transfers the tenant improvements to the landlord (or an entity controlled by the landlord), (b) the landlord grants possessory use of the tenant improvements to the tenant, for the term of the space lease, (c) the landlord makes a cash payment to the tenant for the sale price, and (d) the base rent for the property increases. The increase in rent is typically related to the amount that will amortize the sale price of the tenant improvements, or to the present value of the benefit to the tenant, which includes the amount of the sale price realized by the tenant, the value of the accelerated depreciation, and any improvement in the tenant's balance sheet realized by removing a non-income producing asset. In some cases, the lease of the tenant improvements may be embodied in a separate lease.

Various fees may be payable, for example for legal fees, to bankers or lenders that advise on structuring the transaction. The fee may be in the range of 500 basis points, for example. The lender may also charge interest on the loan. The landlord may charge interest on the remainder of the financing, 10% in this example, of the amount that was needed for the TI. The lender may sell the loan to a bond broker. Otherwise, the lender may continue to function as the actual lender.

One or more computers and/or computer programs may be used at any of several stages. A computer may be used to create financial models, for example to determine whether the sale-leaseback transaction is desirable, how the various tax and accounting benefits should be allocated among the parties, to determine an appropriate relationship between the sale price and the increase in rent. A computer may be used to create transaction documents. A computer may be used to solicit parties for a sale-leaseback transaction. Electronic signatures may be used to enter the various contracts. A computer may be used to generate periodic invoices, to receive periodic payments, and/or to generate periodic tax and accounting reports and statements. A computer may be used to store records relating to the transaction. A computer may be used to indicate retirement of the structure.

In another aspect, a method may comprise the steps of in the memory of a computer, recording data reflecting sale of tenant improvements that are owned by a tenant of a space from the tenant to a landlord of the space, and data reflective of an amendment to a lease agreement between the landlord and the tenant to provide for an increase in the rent paid by the tenant for the space to which the tenant improvements are appurtenant. At least some portion of the selling of the tenant improvements, modeling the selling or amending of the lease, amending the lease, or servicing the amended lease, or retaining records relating to the amended lease is performed with assistance of a computer.

In another aspect, one or more tangible computer-readable memories, have embedded thereon programs to support one or more steps in a transaction with the following steps: selling tenant improvements that are owned by a tenant from the tenant to a landlord, a space owned by the landlord being leased from the landlord to the tenant, the sale being for cash or cash equivalent, at a price of the tenant's net book value, market rents having risen between the time the space lease was entered and the sale of the tenant improvements, the sale being made at a price that realizes a tax loss relative to the depreciated tax basis at which the tenant carries the tenant improvements; and amending a lease agreement between the landlord and the tenant to provide for an increase in the rent paid by the tenant for the space to which the tenant improvements are appurtenant, the increase in rent being an amount determined to amortize the selling price with possible adjustments for transaction costs and costs of capital.

The following are incorporated by reference. U.S. application Ser. No. 09/611,548, filed Jul. 7, 2000. SFAS 13 (Statement of Financial Accounting Standard No. 13), “Accounting for Leases.” SFAS 28, “Accounting for Sales with Leasebacks.” SFAS 94, “Consolidation of All Majority-Owned Subsidiaries.” SFAS 98, “Accounting for Leases.” EITF 90-15 (Emerging Issues Task Force Consensus No. 90-15), “Impact of Nonsubstantive Lessors, Residual Value Guarantees, and other Provisions of Leasing Transactions.” EITF 96-21, “Implementation Issues in Accounting for Lease Transactions involving Special Purpose Entities.” SEC Comments to Topic D-14 in EITF Abstracts.

This disclosure includes an appendix of 231 frames recorded on five microfiche in the file of U.S. application Ser. No. 09/611,548. The entire '548 application, including the microfiche, are incorporated herein by reference.

A portion of the disclosure of this patent document contains material that is protected by copyright. The copyright owner has no objection to the facsimile reproduction of the patent document or the patent disclosure as it appears in the Patent and Trademark Office file or records, but otherwise reserves all copyright rights whatsoever.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Further undescribed alternative embodiments are possible. It will be appreciated that many of those undescribed embodiments are within the literal scope of the following claims, and others are equivalent.

We claim:

1. A method, comprising the steps of:
in a non-transitory memory of a computer, recording data reflecting sale of tenant improvements that are owned by a tenant of a space from the tenant to a landlord of the space, and data reflective of an amendment to a lease agreement between the landlord and the tenant to provide for an increase in the rent paid by the tenant for the space to which the tenant improvements are appurtenant;
wherein at least some portion of the selling of the tenant improvements, modeling the selling or amending of the lease, amending the lease, or servicing the amended lease, or retaining records relating to the amended lease is performed with assistance of a computer.

2. One or more non-transitory computer-readable memories, having embedded thereon programs to support one or more steps in a transaction with the following steps:
selling tenant improvements that are owned by a tenant from the tenant to a landlord, a space owned by the landlord being leased from the landlord to the tenant, the sale being for cash or cash equivalent, at a justifiable price, market rents having risen between the time the space lease was entered and the sale of the tenant improvements, the sale being made at a price that realizes a tax loss relative to the depreciated tax basis at which the tenant carries the tenant improvements; and
leasing the tenant improvements from the landlord to the tenant at an increased rent paid by the tenant.

3. The computer-readable memories of claim 2, wherein the property the space is located in has a distressed debt situation.

4. The computer-readable memories of claim 2, wherein purchase money for sale of said tenant improvements is financed in large part by a third party lender.

5. The computer-readable memories of claim 4, wherein a loan for said purchase money by a third party lender is non recourse against the landlord.

6. The computer-readable memories of claim 4, wherein a loan for said purchase money by a third party lender has recourse against the landlord's equity interest in the property the space is located in.

7. The computer-readable memories of claim 4, wherein
the purchase money is borrowed as debt issued by a special purpose entity, being a legal entity controlled by the landlord.

8. The computer-readable memories of claim 7, wherein
at least about 80% of the capitalization of the special purpose entity is a loan to the special purpose entity secured by an absolute obligation of the tenant.

9. The computer-readable memories of claim 2, wherein rent payments are fully tax deductible to the tenant.

10. The computer-readable memories of claim 2, wherein the improvements are leased back to the tenant under an improvements lease that is distinct from the space lease.

11. The computer-readable memories of claim 10, wherein said improvements lease is structured together with the space lease to support an accounting conclusion that the space lease and improvements lease are to be considered together as a single lease and classified as an operating lease under financial accounting rules or a true lease under tax accounting rules.

12. The computer-readable memories of claim 2, wherein
the leasing of the tenant improvements is effected by amendment of a lease agreement between the landlord and the tenant of the space to which the tenant improvements are appurtenant, the amendment providing for an increase in rent paid by the tenant, the increase in rent being an amount determined to amortize the selling price with possible adjustments for transaction costs and costs of capital.

13. The computer-readable memories of claim 2, wherein the increase in rent is an amount determined to amortize the selling price with possible adjustments for transaction costs and costs of capital.

14. A method, comprising the steps of:
processing data in a non-transitory computer-readable memory of a computer, said memory having embedded thereon programs to support one or more steps in a transaction,
said processing reflecting buying tenant improvements that are owned by a tenant, the sale taking place from the tenant to a landlord, a space owned by the landlord being leased from the landlord to the tenant, the sale being for cash or cash equivalent, at a justifiable price, market rents having risen between the time the space lease was entered and the sale of the tenant improvements, the sale being made at a price that realizes a tax loss relative to the depreciated tax basis at which the tenant carries the tenant improvements; and
said processing reflecting leasing the tenant improvements from the landlord to the tenant at an increased rent paid by the tenant;
wherein at least some portion of the buying of the tenant improvements, modeling the selling or leasing, the leasing, or servicing the lease, or retaining records relating to the lease is performed with assistance of a computer.

15. The method of claim 14, wherein the property the space is located in has a distressed debt situation.

16. The method of claim 14, wherein purchase money for buying said tenant improvements is financed in large part by a third party lender.

17. The method of claim 16, wherein a loan for said purchase money by a third party lender is non recourse against the landlord.

18. The method of claim 16, wherein a loan for said purchase money by a third party lender has recourse against the landlord's equity interest in the property the space is located in.

19. The method of claim 14, wherein
the purchase money is borrowed as debt issued by a special purpose entity, being a legal entity controlled by the landlord.

20. The method of claim 14, wherein
at least about 80% of the capitalization of the special purpose entity is a loan to the special purpose entity secured by an absolute obligation of the tenant.

21. The method of claim 14, further comprising leasing the improvements back to the tenant under an improvements lease that is distinct from the space lease.

22. The method of claim 21, further comprising said improvements lease being structured together with the space lease to support an accounting conclusion that the space lease and improvements lease are to be considered together as a single lease and classified as an operating lease under financial accounting rules or a true lease under tax accounting rules.

23. The method of claim 14, wherein
the leasing of the tenant improvements is effected by amendment of a lease agreement between the landlord and the tenant of the space to which the tenant improvements are appurtenant, the amendment providing for an increase in rent paid by the tenant, the increase in rent being an amount determined to amortize the selling price with possible adjustments for transaction costs and costs of capital.

24. The method of claim 14, wherein the increase in rent is an amount determined to amortize the selling price with possible adjustments for transaction costs and costs of capital.

25. A method, comprising the steps of:
processing data in a non-transitory computer-readable memory of a computer, said memory having embedded thereon programs to support one or more steps in a transaction,
said processing reflecting selling tenant improvements that are owned by a tenant, the sale taking place from the tenant to a landlord, a space owned by the landlord being leased from the landlord to the tenant, the sale being for cash or cash equivalent, at a justifiable price, market rents having risen between the time the space lease was entered and the sale of the tenant improvements, the sale being made at a price that realizes a tax loss relative to the depreciated tax basis at which the tenant carries the tenant improvements; and
said processing reflecting leasing the tenant improvements from the landlord to the tenant at an increased rent paid by the tenant;
wherein at least some portion of the selling of the tenant improvements, modeling the selling or leasing, leasing, or servicing the lease, or retaining records relating to the lease is performed with assistance of a computer.

26. The method of claim 25, wherein rent payments are fully tax deductible to the tenant.

27. The method of claim 25, wherein the improvements are leased back to the tenant under an improvements lease that is distinct from the space lease.

28. The method of claim 25, wherein said improvements lease is structured together with the space lease to support an accounting conclusion that the space lease and improvements lease are to be considered together as a single lease and classified as an operating lease under financial accounting rules or a true lease under tax accounting rules.

29. The method of claim 25, wherein
the leasing of the tenant improvements is effected by amendment of a lease agreement between the landlord and the tenant of the space to which the tenant improvements are appurtenant, the amendment providing for an increase in rent paid by the tenant, the increase in rent being an amount determined to amortize the selling price with possible adjustments for transaction costs and costs of capital.

30. The method of claim 25, wherein the increase in rent is an amount determined to amortize the selling price with possible adjustments for transaction costs and costs of capital.

31. A method, comprising the steps of:
processing data in a non-transitory computer-readable memory of a computer, said memory having embedded thereon programs to support one or more steps in a transaction,
said processing reflecting arranging the sale of tenant improvements that are owned by a tenant, the sale taking place from the tenant to a landlord, a space owned by the landlord being leased from the landlord to the tenant, the sale being for cash or cash equivalent, at a justifiable price, market rents having risen between the time the space lease was entered and the sale of the tenant improvements, the sale being made at a price that realizes a tax loss relative to the depreciated tax basis at which the tenant carries the tenant improvements; and
said processing reflecting arranging the leasing of the tenant improvements from the landlord to the tenant at an increased rent paid by the tenant;
wherein at least some portion of the arranging of the sale of the tenant improvements, the selling, modeling the selling or leasing, the leasing, or servicing the lease, or retaining records relating to the lease is performed with assistance of a computer.

32. A computer program product stored on a non-transitory computer usable readable medium comprising:
computer readable program code embodied therein configured to perform the following steps:
selling tenant improvements that are owned by a tenant from the tenant to a landlord, a space owned by the landlord being leased from the landlord to the tenant, the sale being for cash or cash equivalent, at a justifiable price, market rents having risen between the time the space lease was entered and the sale of the tenant improvements, the sale being made at a price that realizes a tax loss relative to the depreciated tax basis at which the tenant carries the tenant improvements; and
leasing the tenant improvements from the landlord to the tenant at an increased rent paid by the tenant.

33. A computer program product for supporting one or more steps in a transaction,
the computer program product comprising:
a non-transitory readable recorded medium;
computer readable program code recorded on the medium for performing the following steps:
selling tenant improvements that are owned by a tenant from the tenant to a landlord, a space owned by the landlord being leased from the landlord to the tenant, the sale being for cash or cash equivalent, at a justifiable price, market rents having risen between the time the space lease was entered and the sale of the tenant improvements, the sale being made at a price that realizes a tax loss relative to the depreciated tax basis at which the tenant carries the tenant improvements; and
leasing the tenant improvements from the landlord to the tenant at an increased rent paid by the tenant.

34. The method of claim 1, further comprising said sale being for cash or cash equivalent, at a justifiable price, market rents having risen between the time the space lease was entered and the sale of the tenant improvements, the sale being made at a price that realizes a tax loss relative to the depreciated tax basis at which the tenant carries the tenant improvements.

35. The method of claim 1, further comprising said increase in rent being an amount determined to amortize the selling price with possible adjustments for transaction costs and costs of capital.

36. The method of claim 1, wherein the sale price is less than the depreciated tax basis and the difference between the sale price and the depreciated basis is realized as accelerated depreciation.
